(19) United States
(12) Patent Application Publication
(10) Pub. No.: US 2026/0309264 A1
(43) Pub. Date: Oct. 8, 2026

(54) FILTRATION MANIFOLD WITH MULTIPLE PORTS

(71) Applicant: Midea Group Co., Ltd., Foshan (CN)

(72) Inventors: Gregory Sergeevich Chernov, Louisville, KY (US); Ryan John Prince, Louisville, KY (US)

(73) Assignee: Midea Group Co., Ltd., Foshan, GD (CN)

(21) Appl. No.: 19/636,809

(22) Filed: Apr. 1, 2026

Related U.S. Application Data
(60) Provisional application No. 63/782,443, filed on Apr. 2, 2025.

(51) Int. Cl. F16L 41/03; B01D 29/52

(52) U.S. Cl. CPC F16L 41/03; B01D 29/52

(57) ABSTRACT

A fluid manifold to maintain a plurality of configurations includes a backplate and a holder, a plurality of first ports and a plurality of second ports, where the plurality of first ports are in fluid communication with the plurality of second ports. The fluid manifold also includes a plurality of holder ports, wherein the plurality of holder ports are in fluid communication with the plurality of first ports and the plurality of second ports, where the plurality of first ports are aligned in a first direction, where the plurality of second ports are aligned in a second direction, and where the first direction is substantially the same as the second direction.

### PRIORITY

This application is a non-provisional of and claims priority to U.S. Provisional Application No. 63/782,443, filed Apr. 2, 2025, which is incorporated herein by reference for all purposes.

### BACKGROUND

This disclosure relates, in general, to fluid treatment systems and, not by way of limitation, to modular manifold systems for enabling customizable filtration trains, among other things. Such systems often employ multiple filtration units arranged in either a series configuration for multi-stage treatment or a parallel configuration to increase flow rate. However, conventional systems are typically manufactured with a fixed flow configuration. This lack of flexibility makes it difficult for a user to customize the filtration path to meet specific needs without engaging in complex and often costly re-plumbing.

These challenges are amplified in more advanced filtration technologies, such as Reverse Osmosis (RO). RO systems, by their nature, separate an incoming fluid into at least two distinct output streams: a purified stream and a waste stream. When multiple RO filters are used together to achieve higher flow rates, managing the individual waste streams from each filter requires cumbersome external plumbing. This approach increases the physical footprint of the system, complicates installation, and introduces numerous potential points for leaks.

Furthermore, the increasing complexity of multi-stage filtration systems introduces a significant risk of incorrect assembly. The improper sequencing of different filter types can lead to ineffective water treatment or, in some cases, cause damage to sensitive downstream components. Therefore, a need exists for an improved filtration system architecture that overcomes these limitations of inflexibility, complexity, and risk of improper assembly.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### SUMMARY

The present disclosure is directed to an improved modular water filtration system. In particular, the disclosure provides a system comprising filtration manifolds and interchangeable connectors that enable user-configurable fluid pathways, overcoming the inflexibility and installation challenges of conventional filtration systems.

In one aspect, a water filtration manifold is provided. The manifold comprises a backplate and a holder, wherein the backplate features a first collection of ports adjacent to a first edge and a second collection of ports adjacent to an opposite second edge. The holder comprises a plurality of holder ports that are in fluid communication with the first and second collections of ports. The manifold further includes a plurality of bypass paths integrated into the backplate, which enable the assembly and interconnection of a large number of manifolds into a filtration train. Furthermore, the ports within the collections may be aligned in different directions or extend to different protrusion depths from the backplate to define a mechanical keying feature for interfacing with compatible connectors.

In another aspect, a connector for providing fluid communication between adjacent manifolds is provided. The connector comprises a body with a plurality of ports designed to interface with the ports of the manifolds and includes one or more internal fluid pathways. Each connector is inserted into an interface between adjacent manifolds to establish fluid communication between one or more ports on a first manifold and one or more ports on an adjacent manifold. While the manifold assemblies remain fixed in a linear sequence, the specific combination of the manifold's bypass paths and the connector's internal fluid pathways determines the operational logic, enabling the filters to be coupled in series or parallel configurations.

In another aspect, the connector further includes a cam-actuated mechanism. This mechanism comprises a lever, an axle coupled to the lever, and at least one cam attached to the axle. The rotation of the lever imparts a corresponding rotation to the cam, which is configured to engage with a feature on an adjacent manifold. This engagement provides significant mechanical advantage for both installing and removing the connector, allowing a user to easily overcome the resistive forces of sealing elements and to securely lock the connector in place, thereby maintaining a leak-proof seal during operation.

In yet another aspect, the filtration system incorporates mechanical keying features on the manifolds to ensure proper assembly and prevent misconfiguration. These keying features are implemented on the lateral side edges of the manifold backplates, which are designed with a patterned or “keyed” interface instead of a simple straight edge. This interface may comprise a series of one or more protrusions and/or indentations. When two such manifolds are placed side-by-side in a filtration train, their keyed edges are designed to be complementary, allowing the adjacent manifolds to physically interlock. This interlocking enhances the structural integrity of the assembled train and ensures precise alignment between the components.

### BRIEF DESCRIPTION OF THE DRAWINGS

The present disclosure is described in conjunction with the appended Figures:

FIG. 1 is a schematic diagram of a manifold with integrated fluid paths, in accordance with at least one embodiment;

FIG. 2 is a front view of a physical embodiment of the manifold shown in FIG. 1, in accordance with at least one embodiment;

FIG. 3 is an isometric view of a manifold backplate illustrating merged port housings, in accordance with at least one embodiment;

FIG. 4 is a cutout isometric view of the manifold backplate of FIG. 3, showing internal fluid paths, in accordance with at least one embodiment;

FIG. 5 is a plan view of the manifold backplate, illustrating the layout of internal fluid paths, in accordance with at least one embodiment;

FIG. 6 is an isometric view of a manifold assembly including the backplate and a filter holder, in accordance with at least one embodiment;

FIG. 7 is a schematic diagram illustrating a manifold with a two-bypass line configuration, in accordance with at least one embodiment;

FIG. 8 is a schematic diagram illustrating a manifold with a three-bypass line configuration for Reverse Osmosis applications, in accordance with at least one embodiment;

FIG. 9A is a front view of a manifold backplate implementing the two-bypass line configuration, in accordance with at least one embodiment;

FIG. 9B is an isometric view of an illustration of the backplate illustrated in FIG. 9A, in accordance with at least one embodiment;

FIG. 10 is a front view of the manifold backplate of FIG. 9A with internal fluid paths highlighted, in accordance with at least one embodiment;

FIG. 11 is an isometric view of a manifold assembly based on two bypass lines, including a filter holder, in accordance with at least one embodiment;

FIG. 12A is a front view of a manifold backplate implementing the three-bypass line configuration, in accordance with at least one embodiment;

FIG. 12B is an isometric illustration of the backplate illustrated in FIG. 12A, in accordance with at least one embodiment;

FIG. 13 is a front view of the manifold backplate of FIG. 12A with internal fluid paths highlighted, in accordance with at least one embodiment;

FIG. 14 is an isometric view of a manifold assembly based on a three-bypass line configuration, including a filter holder, in accordance with at least one embodiment;

FIG. 15A is a top-down view of a manifold illustrating a co-planar port housing configuration, in accordance with at least one embodiment;

FIG. 15B is a top-down view of a manifold port housing illustrating a staggered-plane port housing configuration for mechanical keying, in accordance with at least one embodiment;

FIG. 16A is an isometric view of a manifold port housing illustrating a staggered-plane port housing configuration for mechanical keying, in accordance with at least one embodiment;

FIG. 16B is an isometric view of an alternative port housing illustrating a protruding central portion profile for mechanical keying, in accordance with at least one embodiment;

FIG. 17 is a side view of the manifold port housing illustrated in FIG. 16A, where a frontal surface of the manifold port housing is staggered, in accordance with at least one embodiment;

FIG. 18A is a top-down view of a manifold illustrating an inwardly-angled port axis configuration for mechanical keying, in accordance with at least one embodiment;

FIG. 18B is a top-down view of a manifold illustrating an outwardly-angled port axis configuration for mechanical keying, in accordance with at least one embodiment;

FIG. 19A is an isometric illustration of a linear filtration train comprising multiple adjacent manifold assemblies, in accordance with at least one embodiment;

FIG. 19B is a frontal view of the filtration train of FIG. 19A, in accordance with at least one embodiment;

FIG. 20A is an isometric illustration of a mixed filtration train combining different types of manifold assemblies, in accordance with at least one embodiment;

FIG. 20B is a front view of the filtration train of FIG. 20A, in accordance with at least one embodiment;

FIGS. 21A-21D are schematic diagrams illustrating various exemplary flow configurations, including series, parallel, and mixed-mode, achievable within a filtration train, in accordance with at least one embodiment;

FIG. 22A is an isometric illustration of an inter-manifold connector, in accordance with at least one embodiment;

FIG. 22B is a schematic plan view illustrating a connector aligned with a co-planar manifold port interface, in accordance with at least one embodiment;

FIG. 22C is a schematic plan view illustrating a connector aligned with a staggered-plane manifold port interface, in accordance with at least one embodiment;

FIG. 23A is a front cross-sectional view of an internal structure of a series connector, in accordance with at least one embodiment;

FIG. 23B is a front cross-sectional view of the internal structure of a parallel connector, in accordance with at least one embodiment;

FIG. 24 is a schematic diagram illustrating the application of a series connector between two manifolds, in accordance with at least one embodiment;

FIG. 25 is a schematic diagram illustrating the application of a parallel connector between two manifolds, in accordance with at least one embodiment;

FIG. 26A is a schematic diagram of a complete filtration train configured for series flow, in accordance with at least one embodiment;

FIG. 26B is a schematic diagram of a complete filtration train configured for parallel flow, in accordance with at least one embodiment;

FIG. 27A is a cross-sectional illustration of a tap connector, in accordance with at least one embodiment;

FIG. 27B is a back view of the tap connector of FIG. 27A, in accordance with at least one embodiment;

FIG. 27C is an isometric view of the tap connector of FIG. 27A, in accordance with at least one embodiment;

FIGS. 28A-28B illustrate the internal fluid path and resulting flow for a tap connector configured as an outlet, in accordance with at least one embodiment;

FIGS. 29A-29B illustrate the internal fluid path and resulting flow for a tap connector configured as an intake, in accordance with at least one embodiment;

FIG. 30 is a back view of a four-port connector body, in accordance with at least one embodiment;

FIGS. 31A-31B illustrate the internal structure and resulting parallel flow paths for the connector body of FIG. 30 configured as a parallel connector, in accordance with at least one embodiment;

FIG. 32 is a cross-sectional view of the internal structure for the connector body of FIG. 30 configured as a series connector, in accordance with at least one embodiment;

FIG. 33 is a schematic representation of the series flow path within the connector of FIG. 32, in accordance with at least one embodiment;

FIG. 34 is a schematic representation of a series tap connector, in accordance with at least one embodiment;

FIG. 35A illustrates a back view of a six-port parallel connector for RO manifolds, in accordance with at least one embodiment;

FIG. 35B illustrates a cross-sectional view, respectively, of a six-port parallel connector for RO manifolds, in accordance with at least one embodiment;

FIG. 36 is a schematic representation of the three independent parallel flow paths within the connector of FIGS. 35A-35B, in accordance with at least one embodiment;

FIG. 37 illustrates a back view of an RO PRE inlet connector, in accordance with at least one embodiment;

FIGS. 38A-38B are schematic diagrams illustrating the fluid logic for two different embodiments of the RO PRE connector, respectively, in accordance with at least one embodiment;

FIG. 39A is the back view of an RO POST connector, in accordance with at least one embodiment;

FIG. 39B is the front view of an RO POST connector, in accordance with at least one embodiment;

FIG. 40 is a cross-sectional view illustrating the internal fluid paths of the RO POST connector, in accordance with at least one embodiment;

FIG. 41 is a schematic representation of the fluid logic within the RO POST connector, in accordance with at least one embodiment;

FIG. 42A is a schematic diagram of a two-stage series filtration train with an inlet and an outlet connector, in accordance with at least one embodiment;

FIG. 42B is a schematic diagram of a two-stage parallel-mode filtration train, in accordance with at least one embodiment;

FIG. 43 is an isometric illustration of a filtration train, in accordance with at least one embodiment;

FIG. 44 is a schematic diagram of a complex, five-stage, mixed-mode filtration train, in accordance with at least one embodiment;

FIG. 45 is a schematic diagram of a combined Non-RO and RO filtration train, in accordance with at least one embodiment;

FIG. 46 is an isometric illustration of a filtration train, in accordance with at least one embodiment;

FIG. 47A is an isometric view of a terminal connector featuring a single-cam actuation mechanism, in accordance with at least one embodiment;

FIG. 47B is an isometric view of a terminal connector featuring a single-cam actuation mechanism, in accordance with at least one embodiment;

FIG. 48 is an isometric view of an inter-manifold connector featuring a symmetric, dual-cam actuation mechanism, in accordance with at least one embodiment;

FIG. 49A is an isometric view of a dual-cam connector featuring compound cams designed to engage and disengage the dual-cam connector from a manifold, in accordance with at least one embodiment;

FIG. 49B illustrates a cross-sectional view of the connector in FIG. 49A, in accordance with at least one embodiment;

FIG. 49C illustrates a cross-sectional view of a lever including a protrusion coupled with an axle of a connector in FIG. 49A, in accordance with at least one embodiment;

FIG. 50 is an enhanced isometric view of the interface region between two adjacent manifolds, detailing the mounting frames for a connector, in accordance with at least one embodiment;

FIG. 51 is a cross-sectional view illustrating the initial alignment phase of a connector with a manifold mounting frame, in accordance with at least one embodiment;

FIG. 52A is a cross-sectional view illustrating a second phase of the installation sequence where the connector is seated within the mounting frame, in accordance with at least one embodiment;

FIG. 52B is an isometric illustration of the structure in FIG. 52A, in accordance with at least one embodiment;

FIG. 53 is a cross-sectional view illustrating the partial actuation of the connector's cam mechanism during installation, in accordance with at least one embodiment;

FIG. 54A is a cross-sectional view illustrating the fully engaged and locked state of the connector after complete actuation of the cam mechanism, in accordance with at least one embodiment;

FIG. 54B is an isometric illustration of a portion of the structure in FIG. 54A, in accordance with at least one embodiment;

FIG. 55 is an isometric view of a connector featuring a dual-cam mechanism comprising different shapes for installation and removal, in accordance with at least one embodiment;

FIG. 56A is a side view illustrating the installation sequence of the dual-cam connector of FIG. 55, in accordance with at least one embodiment;

FIG. 56B is a side view illustrating the removal sequence of the dual-cam connector of FIG. 55, in accordance with at least one embodiment;

FIG. 57 is a schematic diagram illustrating the operational sequence and relative movement of the dissimilar cams during the installation and removal process, in accordance with at least one embodiment;

FIG. 58 is a front view of a manifold backplate embodiment illustrating complementary patterned side edges for interlocking, in accordance with at least one embodiment;

FIG. 59A is a front view illustrating the alignment of two adjacent manifold backplates with complementary patterned edges prior to assembly, in accordance with at least one embodiment;

FIG. 59B is a front view of the two manifold backplates illustrated in FIG. 59A in a fully interlocked and assembled state, in accordance with at least one embodiment;

FIG. 60 is an isometric view of an interface between two different types of manifold backplates, illustrating a mixed-system assembly with an additional keying feature, in accordance with at least one embodiment;

FIG. 61A is a top-down plan view illustrating a mechanical keying protrusion on a manifold backplate that extends beyond a port housing surface, in accordance with at least one embodiment;

FIG. 61B is a top-down plan view showing a specialized connector with a recess designed to engage with the keying protrusion of FIG. 61A, in accordance with at least one embodiment;

FIG. 62A is a top-down plan view of a manifold backplate embodiment having a tapered profile, in accordance with at least one embodiment;

FIG. 62B is a top-down plan view of an alternative manifold backplate embodiment having a diverging profile, in accordance with at least one embodiment;

FIG. 62C is a top-down plan view of an interface between two adjacent manifolds, illustrating a tapered or converging keying gap, in accordance with at least one embodiment;

FIG. 62D is a top-down plan view of an interface between two adjacent manifolds, illustrating a diverging keying gap, in accordance with at least one embodiment;

FIG. 63 is an isometric view of an alternative manifold embodiment featuring recessed ports and a patterned side edge, in accordance with at least one embodiment;

FIG. 64 is a front view illustrating the alignment of two adjacent manifolds of the embodiment shown in FIG. 63, in accordance with at least one embodiment; and

FIG. 65 is a front view of two interlocked manifolds shown in FIG. 64 illustrating an additional keying mechanism comprising protrusions on the front face, in accordance with at least one embodiment.

In the appended Figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims, in accordance with at least one embodiment.

In order to illustrate the technical solutions in the embodiments of the present application or in the related art more clearly, the following briefly introduces the accompanying drawings required for the description of the embodiments or the related art. Obviously, the drawings in the following description are only part of the embodiments of the present application. For those skilled in the art, other drawings can also be obtained according to the structures shown in these drawings without any creative effort.

The technical solutions of the embodiments of the present application will be described in more detail below with reference to the accompanying drawings. It is obvious that the embodiments to be described are only some rather than all of the embodiments of the present application. All other embodiments obtained by persons skilled in the art based on the embodiments of the present application without creative efforts shall fall within the scope of the present application.

It should be noted that all directional indications (such as up, down, left, right, front, back, etc.) in the embodiments of the present application are only used to explain the relative positional relationship, the movement situation, etc. among various assemblies under a certain posture as shown in the drawings. If the specific posture changes, the directional indication also changes accordingly.

In addition, the descriptions of “first,” “second,” etc. are only for the purpose of description, and should not be construed as indicating or implying relative importance or implicitly indicating the number of technical features indicated. Thus, a feature delimited with “first,” “second,” etc. may expressly or implicitly include at least one of that feature. Besides, the meaning of “and/or” appearing in the application includes three parallel scenarios. For example, “A and/or B” includes only A, or only B, or both A and B. In addition, the technical solutions between the various embodiments can be combined with each other, but must be based on the realization by those skilled in the art. When the combination of technical solutions is contradictory or cannot be realized, it should be considered that the combination of such technical solutions does not exist or falls within the scope of protection claimed in the present application.

Conventional water filtration systems, particularly those intended for residential use, are often constrained by significant limitations in flexibility and modularity. Most residential filter manifolds currently on the market are manufactured with a fixed flow configuration, forcing users into either a series arrangement for multi-stage treatment or a parallel arrangement for increased flow rate, but generally not allowing for both. While some commercial systems, such as those for food service applications, may offer a degree of reconfigurability, they typically achieve this through oversized and complex manifold designs that are not suitable for compact, residential under-the-sink applications. Furthermore, these commercial systems often lack true, integrated bypass lines, instead relying on internal flow channels that limit their ability to incorporate additional functionalities, such as a dedicated drain line for advanced filtration processes.

Furthermore, the physical architecture of existing modular systems presents considerable challenges for installation and reconfiguration. In typical modular systems, changing the fluidic path between adjacent filtration units requires the manifolds to be physically separated from their fixed positions in order to swap out the inter-manifold connector. This process is cumbersome and time-consuming for the end-user. While some simple systems, such as refrigerator filter manifolds, may feature co-planar and co-directional inlet and outlet ports that simplify external connections, they are limited to a single inlet and outlet. In more complex systems with multiple ports, the inlets and outlets typically face opposite directions, resembling a straight-through flow path. This opposing-port configuration necessitates the difficult disassembly process described above and prevents the manifolds from remaining fixed in place during reconfiguration.

These challenges are amplified as filtration trains become more advanced—especially with the integration of Reverse Osmosis (RO) technology. The management of multiple distinct fluid streams, including feed, purified water (filtrate), and waste concentrate (reject), becomes a primary challenge, traditionally solved with a cumbersome and leak-prone web of external tubes, T-fittings, and bypass lines. This approach not only increases the risk of leaks but also makes ensuring a secure, leak-proof seal at each connection point essential, as these systems must withstand high operating pressures and sudden pressure spikes from events like water hammering. Over time, the constant force required for sealing causes the seals to adhere tightly to the manifold ports. Consequently, the force required to remove a connector can become prohibitively high for an average consumer to overcome by hand, creating significant maintenance difficulties without a mechanism to provide mechanical advantage.

Finally, a further limitation of the prior art lies in the area of assembly safety and error-proofing. While the use of keyed surfaces to ensure proper component mating is known in the water filtration industry, such keying is typically restricted to the interface between a filter cartridge and its corresponding manifold. This ensures that only the correct filter type is inserted into a given manifold. However, these systems do not address the critical issue of preventing the incorrect connection of incompatible manifolds to each other or the use of improper inter-manifold connectors within a larger filtration train. This lack of system-level keying creates a significant risk of incorrect assembly, which can lead to ineffective water treatment, damage to sensitive downstream components like an RO membrane, or system failure.

The disclosure presented here first addresses these issues through the innovative design of its manifold backplates. In at least one embodiment, the water manifold comprises a backplate and a holder, wherein the holder is mechanically coupled with the backplate. The manifold includes a plurality of first ports on one side and a plurality of second ports on an opposite side, allowing for fluid communication between adjacent manifolds. The water manifold further comprises a plurality of holder ports for interfacing with a filter. The manifold design is predicated on two distinct architectural approaches for integrating bypass lines. In one embodiment, an integrated bypass line functions as a common fluidic line, establishing a continuous internal path between corresponding ports on opposite sides of the manifold while also featuring a T-junction that simultaneously directs fluid to the internal filter. In another embodiment, a bypass line acts as a true pass-through, creating a direct fluidic connection between an input and output port that is completely isolated from the manifold's internal filter.

Building upon the bypass line-based architecture, the disclosure provides for both a two-bypass line manifold for standard filtration and a bypass line manifold for RO systems. The usefulness of an integrated reject bypass line is most apparent in advanced water filtration systems using multiple RO filters in parallel. By its nature, RO filtration separates an incoming fluid into a purified stream (filtrate) and a waste stream (reject). In high-flow systems with multiple side-by-side RO cartridges connected in parallel, managing these individual waste streams requires complex external plumbing. The integrated reject bypass line solves this by providing a common header or rail within the manifold itself, eliminating the need for external components, reducing potential leak points, and dramatically simplifying the installation and design of high-performance parallel RO systems.

The second key pillar of the disclosure directly solves the problem of inflexible flow configurations through an innovative and highly modular connector-centric architecture. This design fundamentally redefines the relationship between the filtration manifolds and the components that link them, decoupling the physical layout of the filtration train from its fluidic logic. This is achieved by utilizing passive, standardized manifold assemblies that remain fixed in place, while embedding the operational logic—such as series or parallel flow—within specific but interchangeable connectors. Each connector is inserted into the interface between adjacent manifolds to establish fluid communication between one or more ports on one manifold and one or more ports on an adjacent manifold. A filtration train is assembled from a linear sequence of these manifold assemblies, and while the physical order of the units remains fixed, the fluidic pathway is determined entirely by the type of connector coupling them. The ability to create sophisticated, custom filtration paths is therefore achieved not by reconfiguring the manifolds themselves, but by simply selecting and installing the appropriate connector to establish fluid communication between the ports of adjacent units.

A series flow configuration is implemented by selecting and installing a dedicated series connector between two adjacent manifold assemblies. This type of connector features a specific internal fluid path that is configured to route the treated filtrate from an outlet port of the upstream manifold to an inlet port of the downstream manifold. This implementation enables a multi-step filtration process where the output from one filter becomes the input for the next, which is particularly advantageous when sequential filtration is desired to enhance contaminant reduction. For example, a series configuration can utilize an inexpensive first filter, such as one comprising melt-blown polypropylene, to reduce sediment. This initial stage serves to prolong the lifetime of more sensitive, high-efficiency filters located downstream, such as a second filter including a carbon block that reduces oxidizers like chlorine, which is critical for protecting a delicate downstream RO membrane.

Conversely, a parallel flow configuration is achieved by utilizing a parallel connector. Unlike a series connector, a parallel connector comprises at least two separate, fluidly isolated internal channels. A first channel connects the feed bypass lines of the adjacent manifolds, while a second channel connects the filtrate bypass lines. This internal structure ensures that all filters connected in parallel share a common fluid inlet and a common fluid outlet, allowing them to operate simultaneously. The primary effect of this configuration is reduced pressure loss and, consequently, an increased total system flow rate while maintaining the same level of contaminant reduction from each filter. This ability to easily scale system capacity by implementing a parallel configuration simply by changing a connector represents a significant advantage over conventional fixed-plumbing systems.

This connector-centric architecture provides an unprecedented level of modularity and user-driven customization. The advantage lies in the interplay between distinct manifold embodiments and a family of function-specific connectors. This allows for the easy creation of sophisticated, custom filtration solutions—such as a train that begins with a parallel block of sediment filters for high flow, followed by a series-connected block of carbon and RO filters for sequential contaminant removal. The ability to alter the entire fluidic logic of the filtration train without physically moving or re-plumbing the manifold units is a transformative feature. A significant advantage is that such flexibility is provided within a simple, compact, and physically linear system footprint, making it ideal for residential and commercial applications.

While the connector itself provides customizable logic for interconnecting manifolds, the disclosure also provides a sophisticated cam-actuated mechanism, on the connector, designed to facilitate installation and removal of the connector. The mechanism fundamentally comprises a user-operated lever rotatably coupled to the connector body via an axle, with one or more cams affixed to the axle. Rotation of the lever imparts torque to the cams, which then engage with corresponding surfaces on a mounting frame of the adjacent manifolds. This engagement provides significant mechanical advantage by converting the rotational motion of the lever into a linear force, allowing a user to overcome the resistive forces of sealing elements and securely install or remove the connector with minimal effort.

The design of the cam system can be implemented in several distinct embodiments to achieve this mechanical advantage. In some embodiments, a single, multi-functional compound cam is utilized, which is designed with distinct actuation surfaces along its profile; a first surface engages the manifold frame to push the connector into place, while a second surface engages the frame to pull the connector out. In alternative embodiments, the actuation mechanism may feature a dual-cam design, wherein two distinct cams with different geometric profiles—a dedicated installation cam and a separate removal cam—are affixed to the same axle. This separation of functions allows each cam to be optimized for its specific task. These cam systems can be arranged symmetrically for a balanced application of force and may incorporate additional structural features, such as flexible, hook-shaped protrusions, which can act as a detent to provide tactile feedback and securely lock the lever in its final, actuated position.

A further advantage of this architecture is its inherent scalability. Unlike conventional systems that are sold with a fixed number of filtration stages, the present disclosure allows a user to assemble a custom filtration train with any desired number of manifold units, simply by linking them with the appropriate connectors. This provides unprecedented flexibility to expand or modify the system over time to meet changing water treatment needs.

To solve the important issue of incorrect installation and sequencing of filter types, the filtration train employs a sophisticated mechanical keying system based on the physical geometry of the ports on both the manifolds and connectors. This error-proofing is achieved through several distinct design variations. In one embodiment, the port interfaces on opposite sides of a manifold protrude to different, staggered depths, requiring a connector with a correspondingly staggered mating profile. In another, more advanced embodiment, the individual ports within a single port collection feature unique protrusion depth, creating a complex, three-dimensional “stair-step” profile. Furthermore, another keying strategy involves orienting the port axes at non-parallel angles relative to the manifold backplate. Other keying approaches can include using ports with different diameters and varying the distance between the ports. Each of these unique geometric configurations necessitates a connector with a precisely matched “lock-and-key” profile, making it physically impossible to connect incompatible manifold types or to use the wrong connector for a given interface. This robust, physical error-proofing guarantees that specialized components, such as a sensitive RO membrane, are always installed in the correct sequence, thereby enhancing the safety and reliability of the entire modular system.

In different embodiments, the filtration system may incorporate mechanical keying features on manifolds to ensure proper assembly and prevent the misconfiguration of components. These keying features can be implemented in multiple ways to enhance the modularity and safety of the system. In one implementation, the lateral side edges of the manifold backplates are designed with a patterned or “keyed” interface instead of a simple straight edge. This interface can comprise a series of one or more protrusions and/or indentations. When two such manifolds are placed side-by-side in a filtration train, these keyed edges can be designed to be complementary, allowing the adjacent manifolds to physically interlock, which enhances the structural integrity and alignment of the assembled train. In at least one embodiment, while two different manifold backplates can include two different complementary designs, in other embodiments, two side edges of a manifold backplate can include complementary designs for enhanced flexibility.

In other embodiments, an additional level of mechanical keying can be implemented on the front face of the manifold to ensure functional compatibility with specific inter-manifold connectors. This is particularly advantageous for preventing the use of an incorrect connector type, such as in systems requiring a specialized outlet for a Reverse Osmosis (RO) drain port, or for enforcing the correct sequencing of filters (e.g., ensuring a pre-treatment filter is always installed upstream of a sensitive component). This may be achieved by adding one or more protrusions that extend from the front surface of the backplate, parallel to the axis of the ports. A connector intended for this interface would require a corresponding recess to accommodate the protrusion, while a standard or incompatible connector would be physically blocked, preventing incorrect installation.

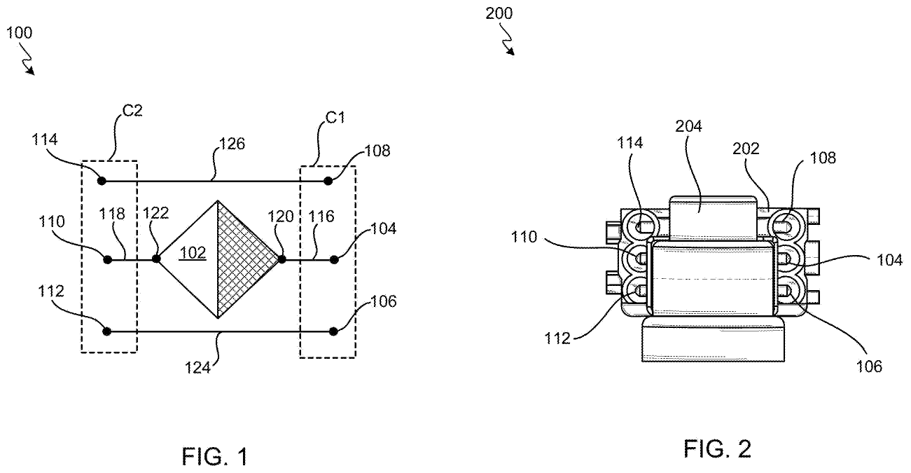

FIG. 1 is a schematic of a manifold 100 that may be implemented to maintain a plurality of filtration configurations. In at least one embodiment, manifold 100 may be an example of a water manifold. In the illustrative embodiment, a filter 102 is included within manifold 100. In at least one embodiment, manifold 100 comprises a collection of ports, such as collection C1 and collection C2. In at least one embodiment, each collection C1 and C2 comprises at least 2 ports. In at least one embodiment, each port in collection C1 is in fluid communication with at least one port in collection C2. In at least one embodiment, collection C1 may comprise input ports, and collection C2 may comprise output ports. In at least one embodiment, the ports may be mixed and the direction of fluid flow can depend on the arrangement of a plurality of manifolds, as will be discussed below. In the illustrative embodiment, collection C1 comprises three ports, such as port 104, port 106, and port 108, and collection C2 comprises three ports, such as port 110, port 112, and port 114.

In at least one embodiment, ports 104 and 110 are coupled with a filter 102 through a path 116, and path 118, respectively. In at least one embodiment, path 116 connects port 104 to a port 120. In at least one embodiment, port 120 is an inlet port for filter 102. In at least one embodiment, path 118 connects port 110 to a port 122. In at least one embodiment, port 122 is an outlet port for filter 102. In at least one embodiment, the orientation of filter 102 can be changed such that port 122 is an input port and port 120 is an outlet port, where the direction of fluid flow is governed by the input and output of filter 102. In the absence of filter 102, paths 116 and 118 are not fluidically connected.

In at least one embodiment, port 106 is in fluid communication with port 112 through path 124. Path 124 continuously extends between ports 106 and 112 and is an example of a bypass fluid path. In at least one embodiment, a bypass fluid path can be used to allow fluid to pass through manifold 100, but bypass filter 102. In the illustrative embodiment, manifold 100 further comprises a second bypass fluid path coupled between two ports. In at least one embodiment, port 108 is in fluid communication with port 114 through path 126. Path 126 continuously extends between ports 108 and 114 and is an example of a bypass fluid path.

FIG. 2 is a front view illustration of a manifold 200. In at least one embodiment, manifold 200 is a physical implementation of the schematic of manifold 100 shown in FIG. 1. In at least one embodiment, manifold 200 comprises a backplate 202 and a holder 204. In at least one embodiment, holder 204 is coupled with backplate 202 and comprises a physical structure or a housing to which a filtration unit is attached.

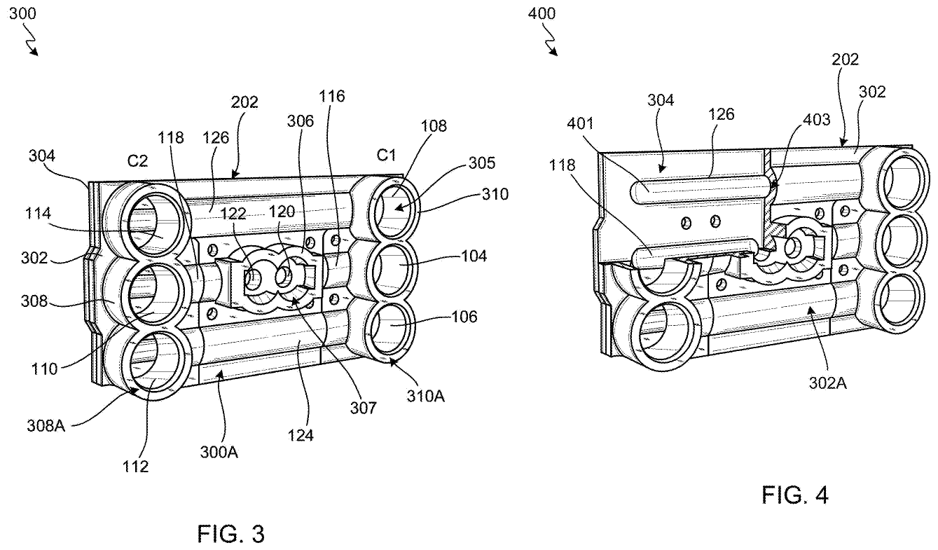

In at least one embodiment, backplate 202 comprises features such as ports and fluid paths described in the schematic in FIG. 1. In at least one embodiment, backplate 202 comprises collections of ports, such as C1 and collection C2. In the illustrative embodiment, collection C1 and C2 include a vertical arrangement of ports. As shown, ports 104, 106, and 108 are arranged vertically within collection C1 and ports 110, 112, and 114 are arranged vertically within collection C2. In at least one embodiment, in addition to collections C1 and C2, ports 120 and 122 are included within a body of backplate 202. Other features such as fluid paths and ports 120 and 122 are not visible in FIG. 2 and are described in detail in FIGS. 3-5.

FIG. 3 is an isometric illustration of a backplate 300, in accordance with at least one embodiment. In at least one embodiment, backplate 300 can comprise a front section 302, and a rear section 304. In at least one embodiment, front section 302 may comprise non-uniform surface features such as fluid paths and ports. In at least one embodiment, rear section 304 may be planar or substantially planar. A planar or substantially planar rear section 304 can facilitate mounting backplate 202 to a wall, for example. In other embodiments, rear section 304 may include holes for mounting to a wall or a panel. The holes may extend to front section 302.

In at least one embodiment, backplate 202 comprises features such as ports and fluid paths described in the schematic in FIG. 1. In at least one embodiment, backplate 202 comprises collections of ports, such as C1 and collection C2. In the illustrative embodiment, collection C1 and C2 include a vertical arrangement of ports. As shown, ports 104, 106, and 108 are arranged vertically within collection C1 and ports 110, 112, and 114 are arranged vertically within collection C2. In at least one embodiment, in addition to collections C1 and C2, ports 120 and 122 are included within a body of backplate 202.

In at least one embodiment, ports 104, 106, 108, 110, 112, and 114 each comprise individual circular openings that are designed to interface with connectors that include fluid paths (to be described below). In at least one embodiment, the size of each opening of ports 104, 106, 108, 110, 112, and 114 can be the same or different. In the illustrative embodiment, each port 104, 106, 108, 110, 112, and 114 comprises an inner surface, such as surface 305. In at least one embodiment, inner surface 305 may be smooth, or include a groove for mounting an O-ring.

In at least one embodiment, in contrast to ports 104, 106, 108, 110, 112, and 114, ports 120 and 122 do not comprise individual isolated housings. In the illustrative embodiment, ports 120 and 122 comprise a merged housing but provide a pathway for fluid to enter (described in FIG. 4).

Ports 104, 106, 108 are in fluid communication with ports 110, 112, and 114, respectively. In at least one embodiment, path 116 connects port 104 to port 120, and path 118 connects port 110 to port 122. In at least one embodiment, port 120 can be an inlet port and port 122 can be a filter outlet port to a common filter. As shown, paths 116 and 118 are fluidically disconnected within backplate 202, where end segments are separated by a geometrical distance between port 120 and port 122.

In at least one embodiment, backplate 300 further comprises a housing 306 surrounding ports 120 and 122. In at least one embodiment, housing 306 surrounds both ports 120 and 122 and protrudes away from surface 300A of backplate 300. Similar to surface 305, housing 306 comprises an inner surface, such as surface 307. In at least one embodiment, inner surface 307 may be smooth, or include a groove for mounting an O-ring.

In at least one embodiment, while openings that define each port 104, 106, 108 are distinct, each port 104, 106, 108 shares a common housing. In the illustrative embodiment, backplate 202 further includes a housing 308 that merges a frame of each port 110, 112, and 114. In at least one embodiment, a front surface 308A of housing 308 may be flat or substantially flat. Similarly, in at least one such embodiment, while openings that define each port 110, 112, and 114 are distinct, each port 110, 112, and 114 shares a common housing. In the illustrative embodiment, backplate 202 further includes a housing 310 that merges a frame of each port 104, 106, and 108. In at least one embodiment, a front surface 310A of housing 310 may be flat or substantially flat. In at least one embodiment, housing 308 and housing 310, which comprise merged frames, can provide a robust support for a connector (to be discussed below), as well as reduce spacing between a respective collection of ports they house.

In at least one embodiment, port 106 is in fluid communication with port 112 through path 124. Path 124 continuously extends between ports 106 and 112 and is an example of a bypass fluid path. In at least one embodiment, a bypass fluid path can be used to allow fluid to pass through manifold 100, but bypass filter 102. In at least one embodiment, port 108 is in fluid communication with port 114 through path 126. Path 126 continuously extends between ports 108 and 114.

In at least one embodiment, front section 302 can also be flat or substantially flat, where paths 116, 118, 124, and 126 may be included within a body of front section 302.

FIG. 4 is a cutout isometric illustration 400 of backplate 202, showing features of select fluid paths, in accordance with at least one embodiment. In at least one embodiment, cutouts in front section 302 expose portions of rear section 304, path 118, and a portion of path 126. As shown, a portion of paths 118 and 126 are forged from depressions 401 in rear section 304, and from depressions 403 in front section 302. In at least one embodiment, depressions 403 in front section 302 that define fluid paths are indicated by raised surfaces 302A. In at least one embodiment, fluid paths forged through the combination of depressions 401 and 403 may be cylindrically shaped with rounded end caps.

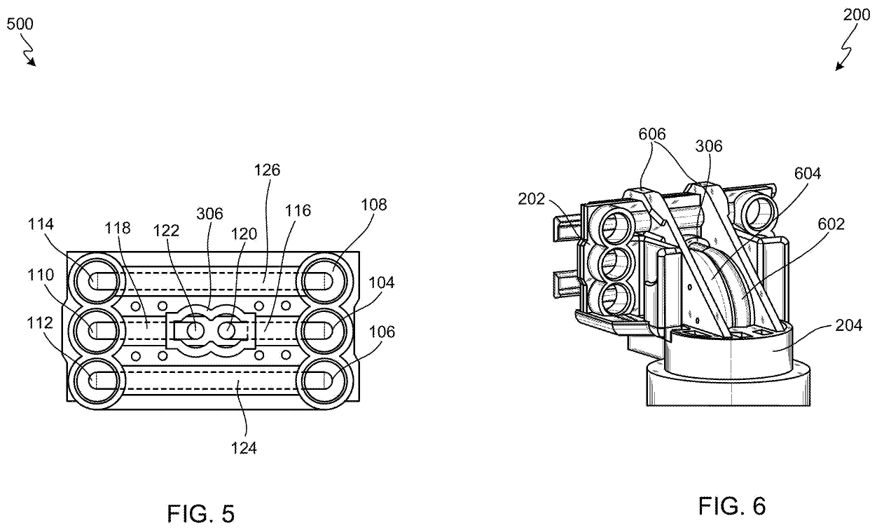

FIG. 5 is a front view 500 of backplate 202, in accordance with at least one embodiment. In the illustrative embodiment, outlines of paths 116, 118, 124, and 126 are shown. In at least one embodiment, paths 116, 118, 124, and 126 comprise straight lines or substantially straight lines. In at least one embodiment, paths 116, 118, 124, and 126 are parallel or substantially parallel. Ports 104, 106, 108, 110, 112, and 114 are overlaid for reference. In at least one embodiment, while ports 120 and 122 comprise a housing 306 that is merged, ports 120 and 122 themselves are distinct openings within front section 302 and housing 306. In another embodiment, ports 120 and 122 may comprise a size that is equal to or substantially equal to a width of path 116 and path 118. In at least one embodiment, housing 306 can be coupled with a fluid path extender, which may extend from holder 204 (FIG. 2).

FIG. 6 is an isometric illustration of manifold 200 that comprises backplate 202 and a holder 204, in accordance with at least one embodiment. Outer surfaces of holder 204 are not illustrated for clarity. In at least one embodiment, holder 204 provides several functionalities. In at least one embodiment, holder 204 comprises a physical structure or a housing to which a filtration unit is attached. In the illustrative embodiment, holder 204 comprises fluid extenders 602 and 604 that mechanically attach to housing 306, surrounding. In at least one embodiment, fluid extenders 602 and 604 are designed to fluidically couple with ports 120 and 122 (that are hidden in FIG. 6), respectively. In at least one embodiment, fluid extenders 602 and 604 may include hollowed tubes with ports at a base portion of holder 204. In at least one embodiment, these ports may be coupled with an external filtration unit for operation. In at least one embodiment, holder 204 is attached to backplate 202 using locking arms 606. In at least one embodiment, locking arms 606 may comprise depressions to match physical protrusions defining path 126.

Referring again to FIG. 1, while bypass lines such as paths 124 and 126 are not coupled directly with ports 104 and 110, respectively, in some embodiments these bypass lines can be changed so that there is additional coupling between a first bypass line and port 104, and a second bypass line and port 110.

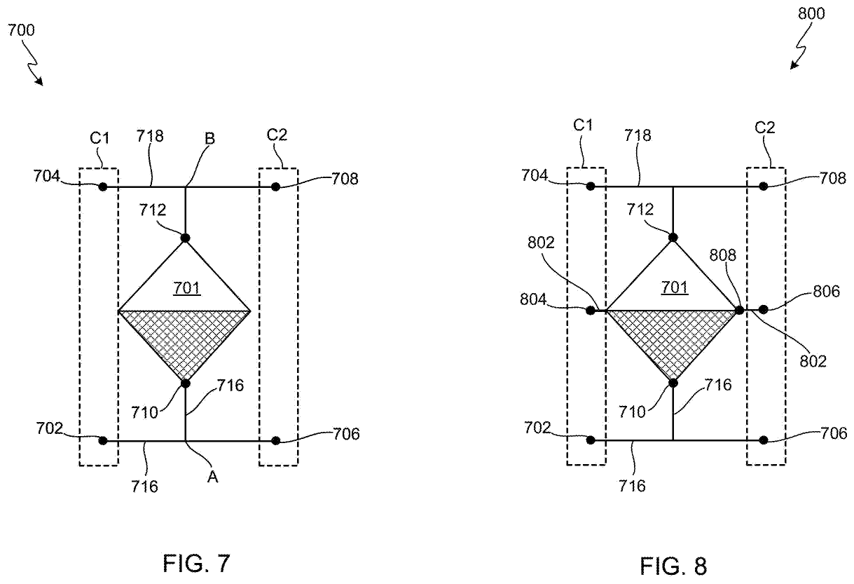

In at least one embodiment, an input or an output port within manifold 100 can share a common fluid path with a second manifold. In at least one such embodiment, where multiple manifolds are connected, a single input fluid line may be implemented to send fluids to the multiple fluid paths within the multiple manifolds. As such, it may be useful to connect one input port of each manifold simultaneously to a first fluid path and simultaneously connect a second input port of each manifold to a second fluid path. These configurations are described with reference to FIGS. 7-14.

FIG. 7 is a schematic of a manifold 700 that may be implemented to maintain a plurality of filtration configurations. In at least one embodiment, manifold 700 may be an example of a water manifold. In at least one embodiment, manifold 700 is configured to interface with a filter 701 to remove impurities from a fluid. In at least one embodiment, manifold 700 comprises a collection of ports, such as a collection C1 and a collection C2. In at least one embodiment, collection C1 and collection C2 each comprise at least two ports. In the illustrative embodiment, collection C1 comprises port 702 and port 704, and collection C2 comprises port 706 and port 708. In at least one embodiment, each port in collection C1 is in fluid communication with at least one port in collection C2. In at least one embodiment, collection C1 may comprise input ports, and collection C2 may comprise output ports, or vice versa.

Manifold 700 further comprises holder ports. In at least one embodiment, holder ports may be an inlet port and an outlet port. In at least one embodiment, a fluid path between the inlet port and the outlet port is discontinuous within the manifold body and is configured to be completed by filter 701. In the illustrative embodiment, port 710 may be an example of an inlet port, and port 712 may be an example of an outlet port designed to interface with filter 701.

In at least one embodiment, a fluid path or path 716 establishes a continuous connection between a first port in C1, such as port 702, and a first port in C2, such as port 706. Path 716 is also fluidly coupled to port 710, through junction “A”. This arrangement forms an inverted T-shaped fluid path, where path 716 allows fluid to flow between ports 702 and 706 while also feeding inlet port 710. In at least one such embodiment, the filter 701 is spatially positioned between path 716 and a second fluid path 718.

In at least one embodiment, the second fluid path or path 718 establishes a continuous fluid connection between port 704 and port 708. Path 718 is also fluidly coupled to port 712. This arrangement forms a T-shaped fluid path, where path 718 enables fluid to flow between ports 704 and 708 while collecting treated fluid from port 712 and distributing it to port 708 through junction “B”.

In at least one embodiment, path 716 may be an example of a fluid feed bypass line. A fluid feed bypass line may flow fluid, such as water, which is to be treated by adjacent manifolds that may be coupled to manifold 700 at port 706 (downstream). In at least one embodiment, path 718 may be an example of a fluid filtrate bypass line. A fluid filtrate bypass line may flow fluid, such as water, which has been treated by adjacent manifolds that may be coupled to manifold 700 at port 704 (upstream).

While two bypass lines are illustrated, in some embodiments, manifold 700 can also include an additional bypass line, where the bypass line can be used to collect fluid from one or more additional elements from filter 701, as described below.

FIG. 8 is a schematic of another embodiment of a manifold 800. Manifold 800 is an example of a Reverse Osmosis (RO) manifold that not only includes the features of manifold 700 but further comprises an additional fluid path 802. In at least one embodiment, fluid path 802 may be an example of a reject bypass line. In at least one embodiment, fluid path 802 establishes a continuous fluid connection between a third port in collection C1, such as port 804, and a third port in collection C2, such as port 806. In this embodiment, fluid path 802 is also fluidly coupled to a reject fluid from outlet or reject port 808 of filter 701. In at least one embodiment, fluid path 802 is confined to manifold 800.

As shown in FIG. 8, fluid path 802 is spatially positioned between path 716 (feed line) and path 718 (filtrate line). This three-bypass-line configuration allows manifold 800 to manage three separate fluid streams simultaneously: a feed stream (via path 716), a product or filtrate stream (via path 718), and a concentrate or reject stream (via fluid path 802). This configuration may be characteristic of filtration systems, such as reverse osmosis, which separates an incoming fluid into two or more distinct output streams.

A reject bypass line integrated into manifold 800 is particularly useful for high-flow Reverse Osmosis (RO) systems that use multiple filters in parallel. Conventionally, managing the separate waste streams from each RO cartridge requires complex external plumbing. In at least one embodiment, this problem can be solved by integrating a common reject bypass line into manifold 800. This design combines the reject streams, which eliminates the need for extra components, reduces potential leak points, and dramatically simplifies the installation of high-performance RO systems.

In the illustrative embodiment, manifold 800 utilizes this concept by incorporating a dedicated reject bypass line or fluid path 802. This internal path establishes a continuous fluid connection between port 804 on one side of the manifold and port 806 on the other. The reject fluid produced by the filter 701, which exits through its dedicated reject port 808, is fluidly coupled to this common fluid path 802. When multiple manifolds, such as manifold 800, are connected in a filtration train, this allows the reject streams from all parallel units to be collected into a single, shared path within the manifold system, flowing from one unit to the next before exiting at the end of the train. This internal management of the waste stream is a key feature that enables the construction of sophisticated, modular RO systems with minimal external plumbing.

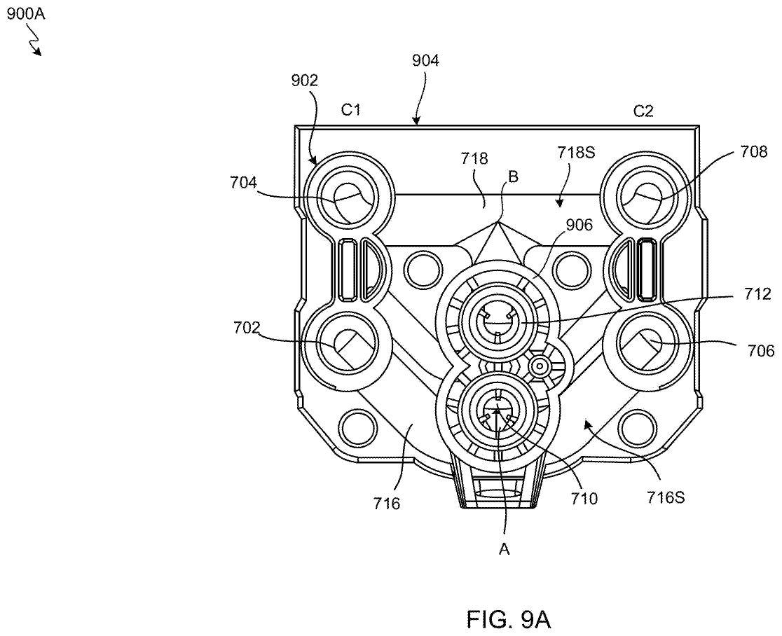

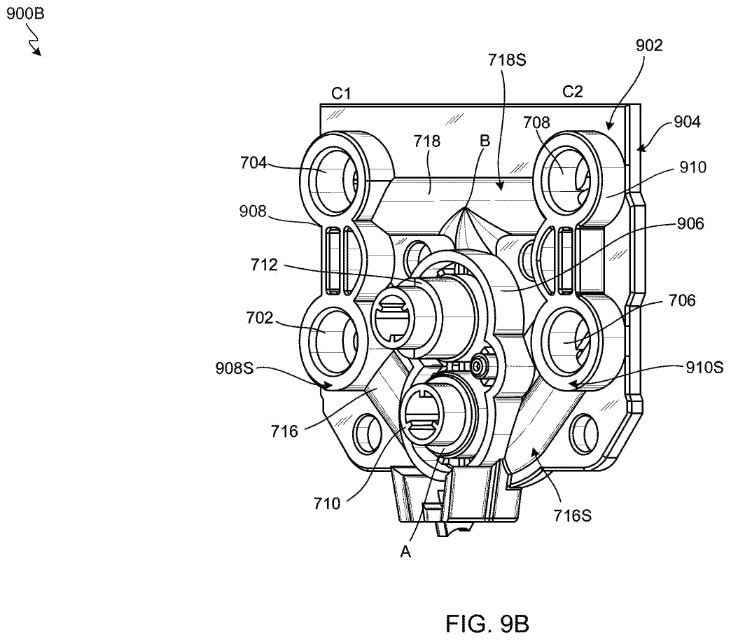

FIG. 9A is a front view illustration of a backplate 900, in accordance with at least one embodiment. In at least one embodiment, backplate 900 can comprise a front section 902, and a rear section 904. In at least one embodiment, front section 902 may comprise non-uniform surface features such as fluid paths and ports. In at least one embodiment, rear section 904 may be planar or substantially planar. A planar or substantially planar rear section 904 can facilitate mounting backplate 900 to a wall, for example. In other embodiments, rear section 904 may include holes for mounting to a wall or a panel. The holes may extend to front section 902. In other embodiments, rear section 904 may also include surface irregularities but have features (holes, fasteners, etc.) that enable mounting to a wall or a mounting bracket. In at least one embodiment, backplate 900 includes a first collection of ports or collection C1 and a second collection of ports or collection C2, which are arranged as vertical columns on opposite sides of backplate 900.

In at least one embodiment, backplate 900 comprises features such as ports and fluid paths described in the schematic in FIG. 7. In the illustrative embodiment, collection C1 includes a port 704 and a port 702 below port 704. Collection C2 includes a top port 708 and a bottom port 706. These ports are shown as individual circular openings designed to interface with external connectors. In at least one embodiment, centrally located on backplate 900 are port 710 and port 712. A main fluid path between port 710 and port 712 is discontinuous within backplate 900, as it is intended to be completed by fluid passing through an external filter. As shown in the illustrative embodiment, port 710 is arranged vertically below port 712. In other embodiments, port 710 and port 712 may be arranged side by side, as in backplate 202 (FIG. 3), or have a different orientation.

Backplate 900 includes a path 716, which serves as a feed line. In at least one embodiment, path 716 establishes a continuous fluid connection between port 702 in collection C1 and port 706 in collection C2. Furthermore, path 716 is fluidly coupled to port 710 at a junction “A”. In at least one embodiment, this T-shaped connection allows an incoming fluid stream to be simultaneously distributed to both the filter and an adjacent manifold.

Similarly, path 718 serves as a filtrate line and establishes a continuous fluid connection between port 704 in collection C1 and port 708 in collection C2. In at least one embodiment, path 718 is also fluidly coupled to port 712 at a junction “B”. This allows path 718 to collect treated fluid from the filter and distribute it to port 704 and port 708. In at least one embodiment, the filtration path is spatially positioned between first path 716 and second path 718, creating a compact, multi-layered fluidic architecture within single backplate 900.

In at least one embodiment, openings in ports 702 and 706, and ports 704 and 708, expose portions of paths 716 and 718, respectively. In at least one embodiment, a portion of paths 716 and 718 are forged from depressions in rear section 904, and through depressions in front section 902, such as depressions discussed in FIG. 4.

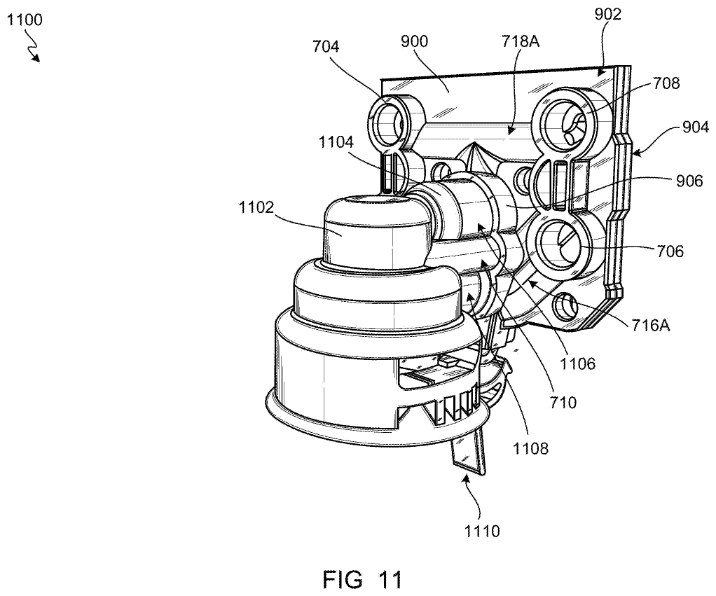

FIG. 9B is an isometric view of an illustration of backplate 900 illustrated in FIG. 9A. In at least one embodiment, port 710 and port 712 are designed to couple with attachment features in a holder structure via housing 906 (that is mechanically attached to backplate 900). These features support fluid pathways to the external filter. The structure of housing 906 is described further in FIG. 11. In at least one embodiment, the holder structure is configured to couple with an external filter, such as filter 701 (shown schematically in FIG. 7).

In at least one embodiment, openings that define each port 702, 704, 706, and 708 are distinct; housing 908 extends between and merges a frame of ports 702 and 704, and housing 910 extends between and merges a frame of ports 706 and 708. In other embodiments, a respective housing of each port may not be shared or physically connected, other than at a base of backplate 900.

In at least one embodiment, depressions in front section 902 that define fluid paths are indicated by raised surfaces 716S and 718S, respectively. In at least one embodiment, housing 908 and housing 910 that comprise merged frames can provide robust support for a connector (to be discussed below). In at least one embodiment, respective front surfaces 908S and 910S of housing 908 and housing 910, and raised surfaces 716S and 718S, are out of the plane of the figure.

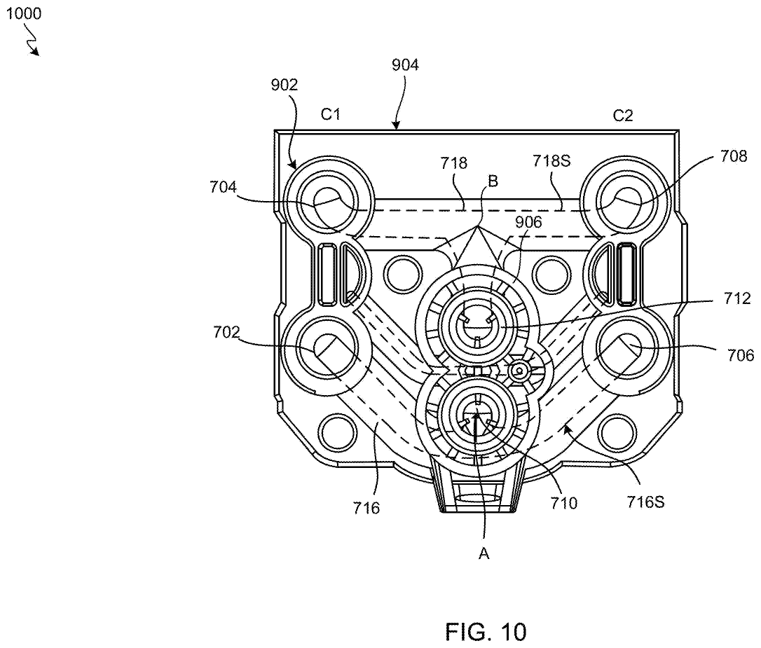

FIG. 10 provides an alternative illustration 1000 of backplate 900 in FIG. 9A, with fluid paths highlighted to show their routing within backplate 900. This view clarifies the structure described in FIG. 9A. In at least one embodiment, path 716, serving as a feed line, is visually represented as connecting port 702 of collection C1 and port 706 of collection C2. In at least one embodiment, path 716 is also shown to be fluidly coupled with port 710 at junction A. Separately, path 718, serving as a filtrate line, is visually represented as connecting top port 704 of collection C1 and top port 708 of collection C2. In at least one embodiment, path 718 is coupled with port 712 at junction B. This visualization emphasizes how two distinct fluidic lines are integrally formed within a single backplate 900.

FIG. 11 is an isometric illustration of a manifold 1100 that comprises a backplate 900 and a holder 1102. In at least one embodiment, holder 1102 is attached to the housing central ports of backplate 900, specifically filter inlet or port 710 and filter outlet or port 712 (not visible in the figure). In at least one embodiment, holder 1102 is positioned horizontally between the first collection of ports C1 and the second collection of ports C2. In at least one embodiment, holder 1102 comprises a main body, which may have a multi-tiered cylindrical profile, designed to function as a physical housing to receive and guide an external filtration unit (not shown). The main body of holder 1102 is connected to housing 906 of backplate 900 via a conduit 1104. In at least one embodiment, conduit 1104 comprises an upper conduit 1106 and a lower conduit 1108, where upper conduit 1106 is coupled to filter outlet or port 712 and lower conduit 1108 is coupled to port 710 (within housing 906).

In at least one embodiment, upper conduit 1106 and lower conduit 1108 are hollowed to extend fluid paths from backplate 900 to a base of holder 1102, where they interface with the external filtration unit. In at least one embodiment, holder 1102 further includes a latch 1110. In some embodiments, holder 1102 may be integrally formed as a single piece with backplate 900 with the features described above.

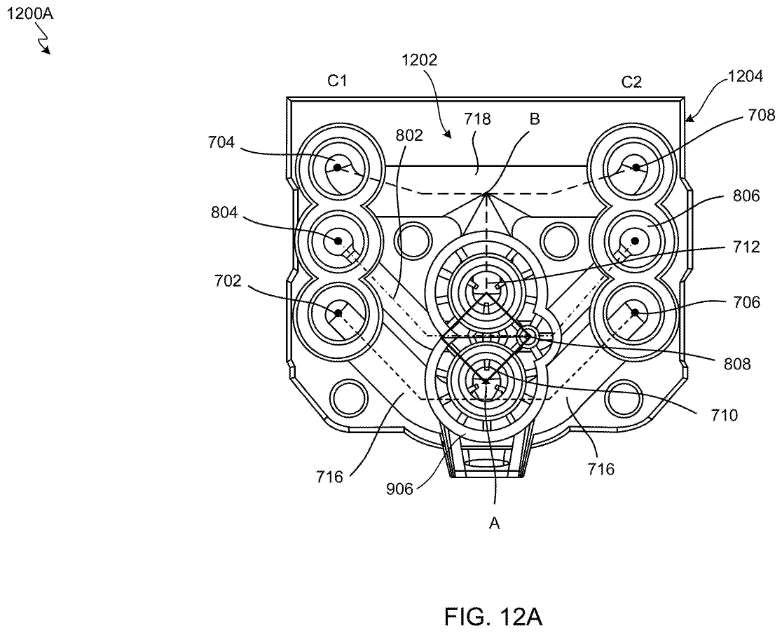

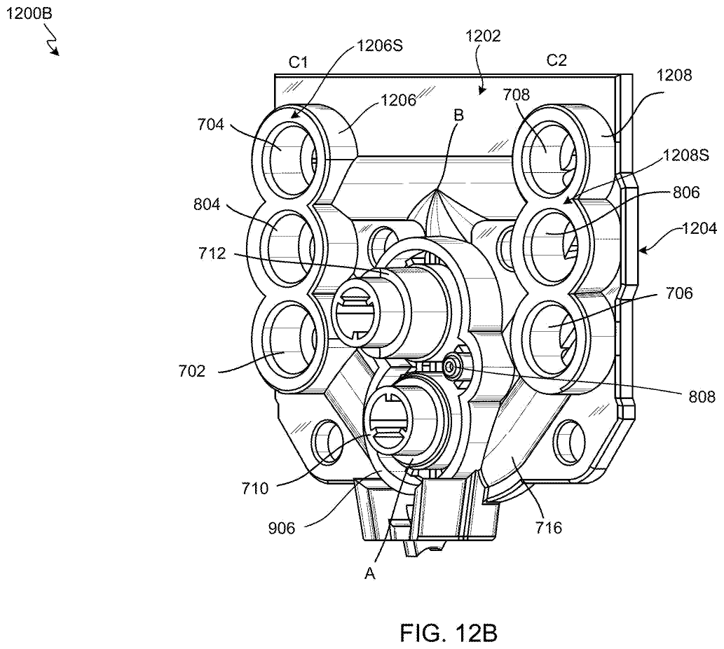

FIG. 12A is a front view illustration of a backplate 1200, which is a physical implementation of schematic 800 shown in FIG. 8. In at least one embodiment, backplate 1200 enables a Reverse Osmosis (RO) manifold that builds upon the features of backplate 900. In at least one embodiment, backplate 1200 can comprise a front section 1202, and a rear section 1204. In at least one embodiment, backplate 1200 comprises features of backplate 900 and further includes a third integrated fluid path, such as fluid path 802, which may function as a reject bypass line. In at least one embodiment, fluid path 802 establishes a continuous fluid connection between a third port in collection C1, such as port 804, and a third port in collection C2, such as port 806. In at least one embodiment, a third fluid path, such as fluid path 802, branches from port 804 to port 806 and includes port 808 between ports 804 and 806, providing a pathway for reject fluid from a filter (when attached) to enter the reject bypass line.

In at least one embodiment, this bypass line configuration within backplate 1200 enables management of three separate fluid streams simultaneously: a feed stream via path 716, a product or filtrate stream via path 718, and a concentrate or reject stream via fluid path 802. In at least one embodiment, this configuration is characteristic of filtration systems, such as reverse osmosis, which separates an incoming fluid into two or more distinct output streams.

In at least one embodiment, an integrated reject bypass line or fluid path 802 is particularly useful for high-flow RO systems that use multiple filters in parallel, as it solves the problem of managing separate waste streams from each RO cartridge and lessens the need for complex external plumbing. In at least one embodiment, this design combines reject streams by integrating a common line into backplate 1200, which eliminates the need for extra components, reduces potential leak points, and simplifies installation of high-performance RO systems.

In at least one embodiment, backplate 1200 utilizes this concept by incorporating a dedicated reject bypass line or fluid path 802. In at least one embodiment, this internal path establishes a continuous fluid connection between port 804 on one side of the manifold and port 806 on the other. In at least one embodiment, reject water produced by a filter cartridge (when attached) is fluidly coupled to this common fluid path 802 via reject port 808. In at least one embodiment, when multiple manifolds, such as backplate 1200, are connected in a filtration train, this allows reject streams from all parallel units to be collected into a single, shared path within the manifold system, enabling internal management of the waste stream and facilitating construction of sophisticated, modular RO systems with minimal external plumbing.

In at least one embodiment, port 710, port 712, and reject port 808 are designed to couple with attachment features in a holder structure via housing 906 (that is mechanically attached to backplate 900). In the illustrative embodiment, housing 906 also encloses reject port 808.

FIG. 12B is an isometric illustration of backplate 1200 illustrated in FIG. 12A. In at least one embodiment, while openings that define each port 702, 704, and 804 are distinct, each port 702, 704, and 804 shares a common housing. In the illustrative embodiment, backplate 1200 further includes a housing 1206 that merges a frame of each port 702, 704, and 804. Similarly, in at least one such embodiment, while openings that define each port 706, 708, and 806 are distinct, each port 706, 708, or 806 shares a common housing. In the illustrative embodiment, backplate 1200 further includes a housing 1208 that merges a frame of each port 706, 708, and 806. In at least one embodiment, housing 1206 and housing 1208 that comprise merged frames can provide a robust support for a connector (to be discussed below), as well as reduce spacing between a respective collection of ports they house. In at least one embodiment, front surface 1206S of housing 1206 and front surface 1208S of housing 1208 are parallel or substantially parallel. In other embodiments, front surface 1206S and front surface 1208S may be on different planes, as will be discussed below.

In other embodiments, a respective housing of each port may not be shared or physically connected other than at a base of backplate 1200.

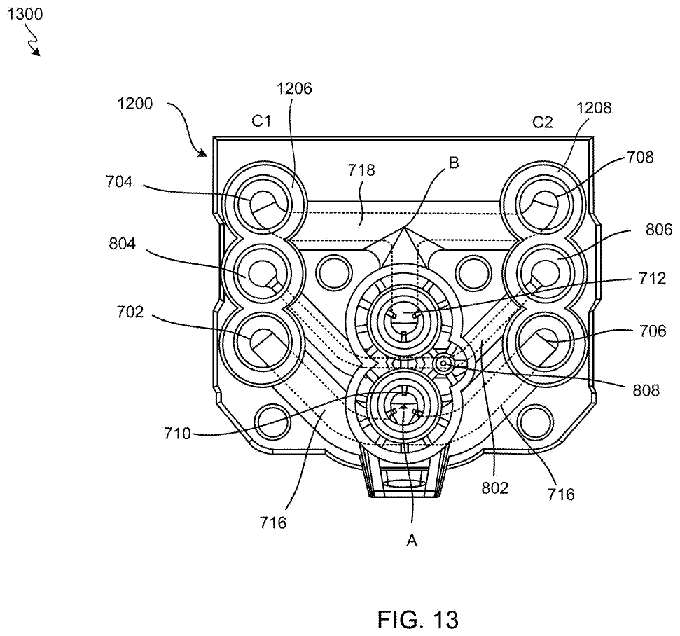

FIG. 13 provides an alternative illustration 1300 of backplate 1200 in FIG. 12A, with fluid paths highlighted to show routing within backplate 1200. This view clarifies the structure described in FIG. 12A. In at least one embodiment, a feed bypass line or path 716, serving as a feed line, is visually represented as connecting port 702 of collection C1 and port 706 of collection C2. This path 716 is also shown to be fluidly coupled with port 710 at junction A. Separately, a filtrate bypass line or path 718, serving as a filtrate line, is visually represented as connecting top port 704 of collection C1 and top port 708 of collection C2. In at least one embodiment, path 718 is coupled with port 712 at junction B. In at least one embodiment, a third reject bypass line or fluid path 802 is visually represented as connecting port 804 of collection C1 and port 806 of collection C2, and is shown to be coupled with a reject port 808 via fluid path 802. This visualization emphasizes how three distinct fluidic lines are integrally formed within single backplate 1200.

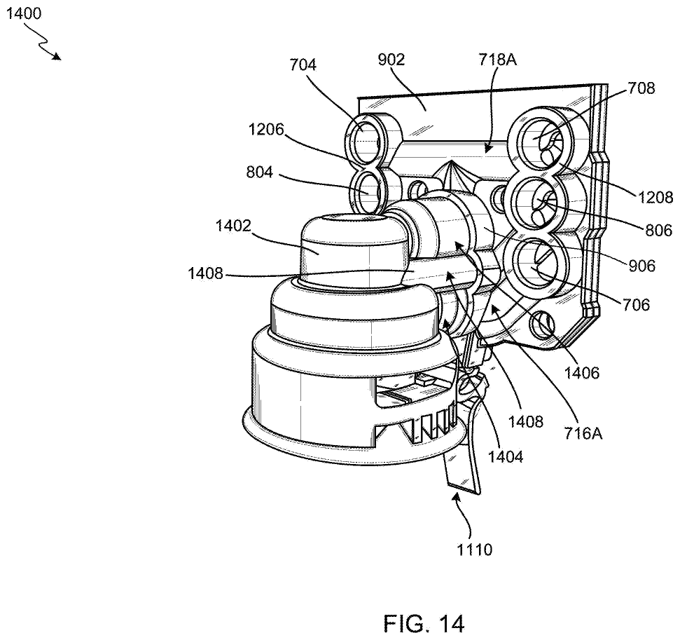

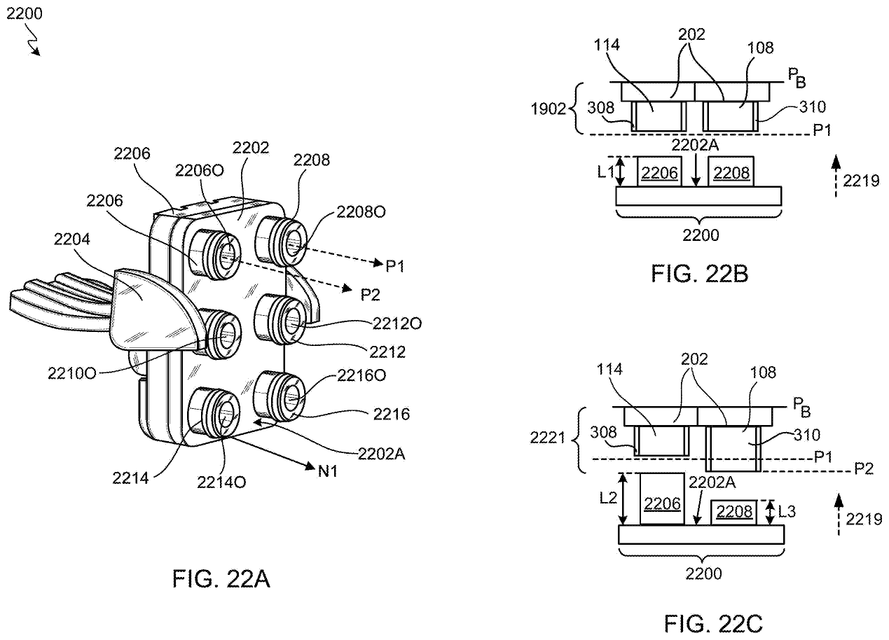

FIG. 14 is an isometric illustration of a manifold 1400 that comprises backplate 1200 and a holder 1402. In at least one embodiment, holder 1402 is attached to central ports of backplate 1200, port 710 (within conduit 1404), port 712 (within conduit 1406), and reject port 808. In at least one embodiment, holder 1402 comprises a main body designed to function as a physical housing to receive and guide an external filtration unit (not shown). In at least one embodiment, the body may be multitiered. In at least one embodiment, the main body of holder 1402 is connected to housing 906 of backplate 1200 via multiple conduits, including a conduit 1406 coupled to port 712, a conduit 1404 coupled to port 710, and a conduit 1408 coupled to reject port 808 (within housing 906). In at least one embodiment, conduits 1404, 1406, and 1408 are hollowed and can comprise tubular pathways for the transfer of fluid from backplate 1200 to a base of holder 1402. The pathways in conduits 1404, 1406, and 1408 interface with an external filtration unit. In some embodiments, holder 1402 may be integrally formed as a single piece with backplate 1200. In at least one embodiment, features of housing 1206 and 1208, such as shape, orientation, and surface characteristics, may be tuned to accommodate connectors (FIG. 22A) that attach to the respective ports in these housings.

Referring again to FIG. 3, in at least one such embodiment, ports 110, 112, and 114 are all aligned in the same or substantially the same direction. In at least one further such embodiment, ports 104, 106, and 108 are all aligned in the same or substantially the same direction. In at least one embodiment, housing 308 and housing 310 both protrude from a surface 300A of backplate 202. The amount of protrusion of front surfaces 308A and 310A can be varied in the vicinity of each port within a collection C1 or collection C2.

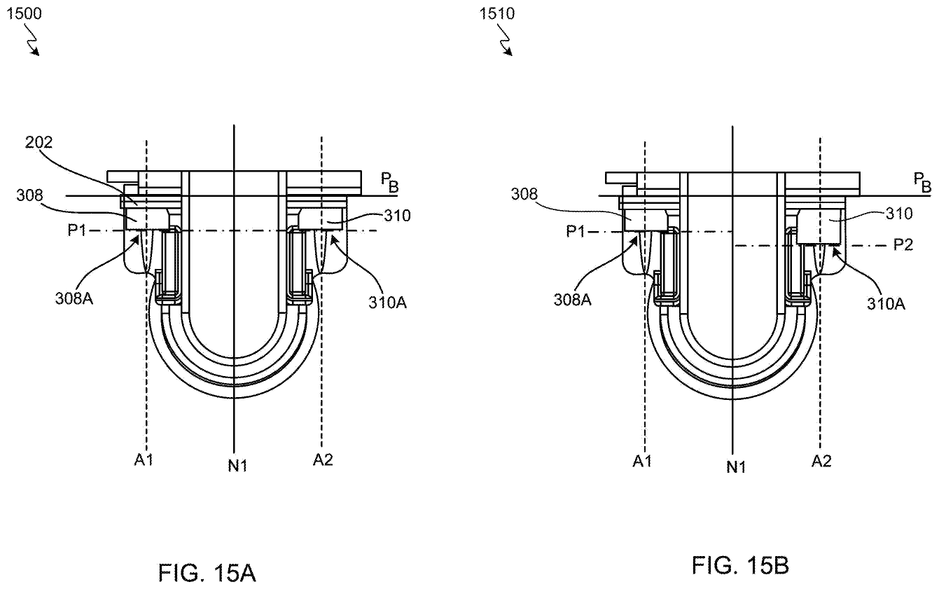

FIG. 15A is a top-down view 1500 of manifold 200 in FIG. 2, in accordance with at least one embodiment. In at least one embodiment, manifold 200 includes backplate 202 with protruding housings 308 and 310 of collections C1 and C2, respectively. In this embodiment, front surfaces 308A and 310A, of housings 308 and 310, are co-planar or substantially co-planar, and lie on a single plane P1. In at least one embodiment, ports within collection C1 and collection C2 are oriented to open in the same direction, or a direction pointing away from backplate 202. This orientation is such that an axis A1 of ports in collection C1 and an axis A2 of ports in collection C2 are parallel or substantially parallel to a normal N1 of a plane P_{B} of backplate 202.

In at least one embodiment, this co-planar and parallel axes configuration of ports in collections C1 and C2 provides a significant advantage for modularity. By ensuring all ports within collection C1 and collection C2 are oriented in the same direction and their front surfaces are aligned, so that a single, rigid connector can fluidly and mechanically bridge two adjacent manifolds with a simple, linear insertion motion.

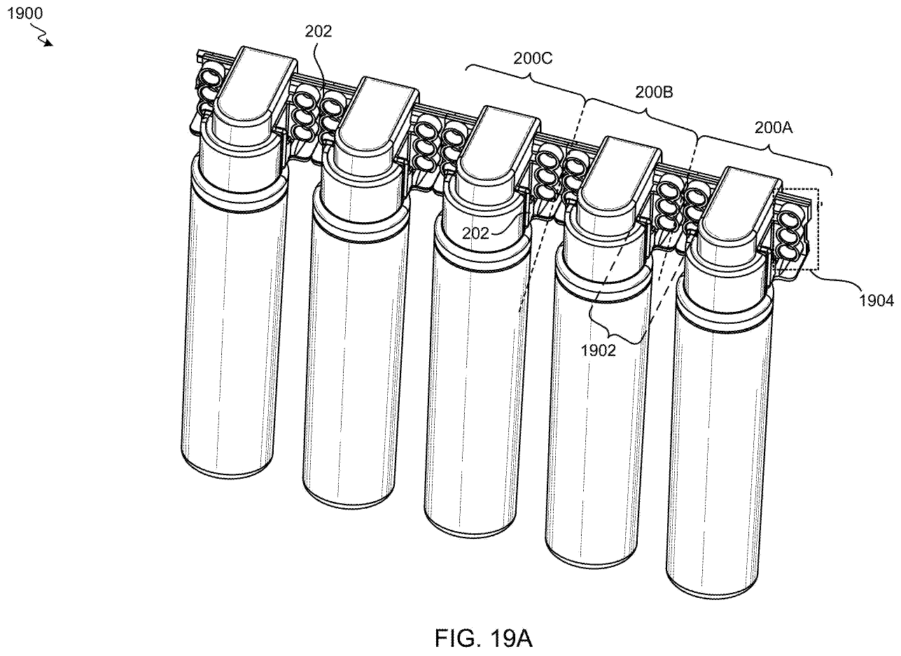

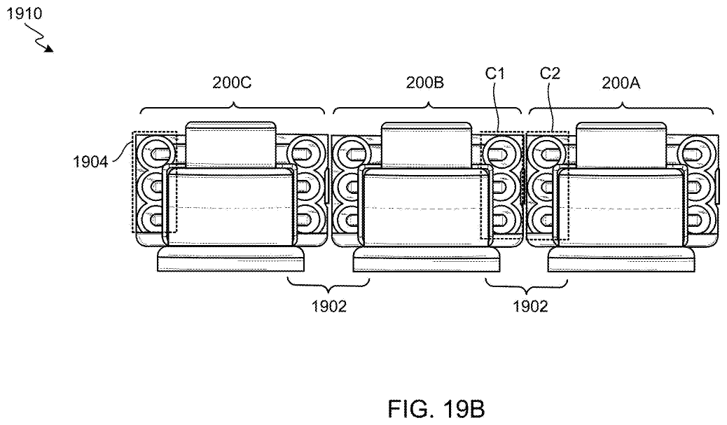

In at least one embodiment, this design lessens the need for complex external plumbing and allows main filtration units to remain fixed in place during assembly or reconfiguration of a filtration train (FIG. 19A), thereby simplifying installation and maintenance for an end-user.

FIG. 15B is a top-down view 1510 of an alternative embodiment of manifold 200, in accordance with at least one embodiment. In at least one embodiment, manifold 200 includes backplate 202 with protruding housings 308 and 310 of collections C1 and C2, respectively. In this embodiment, front surfaces 308A and 310A are not co-planar. As shown, front surface 308A lies on a first plane P1, while front surface 310A lies on a second, distinct plane P2, where planes P1 and P2 are substantially parallel but not collinear. In at least one embodiment, despite the staggered depths of front surfaces 308A and 310A, openings of ports within both collection C1 and collection C2 are oriented in the same direction. In at least one such embodiment, openings of ports within both collection C1 and collection C2 are oriented in a direction away from backplate 202. This orientation is such that an axis A1 of ports in collection C1 and an axis A2 of ports in collection C2 remain parallel or substantially parallel to a normal N1 of a plane P_{B} of backplate 202.

In at least one embodiment, this staggered-plane configuration provides a significant advantage by creating a keyed or error-proof connection system. The difference in protrusion depth between the frontal front surface 308A and front surface 310A creates a unique physical profile that requires a connector (see FIG. 22A) with a correspondingly staggered mating interface.

In at least one embodiment, this mechanical keying prevents an accidental connection of incompatible connectors or the incorrect ordering of filters within a filtration train, for example, ensuring a pre-treatment filter is always installed before a more sensitive filter like a Reverse Osmosis membrane. This enhances the safety and reliability of the modular system while preserving the core benefit of simple, linear connector installation.

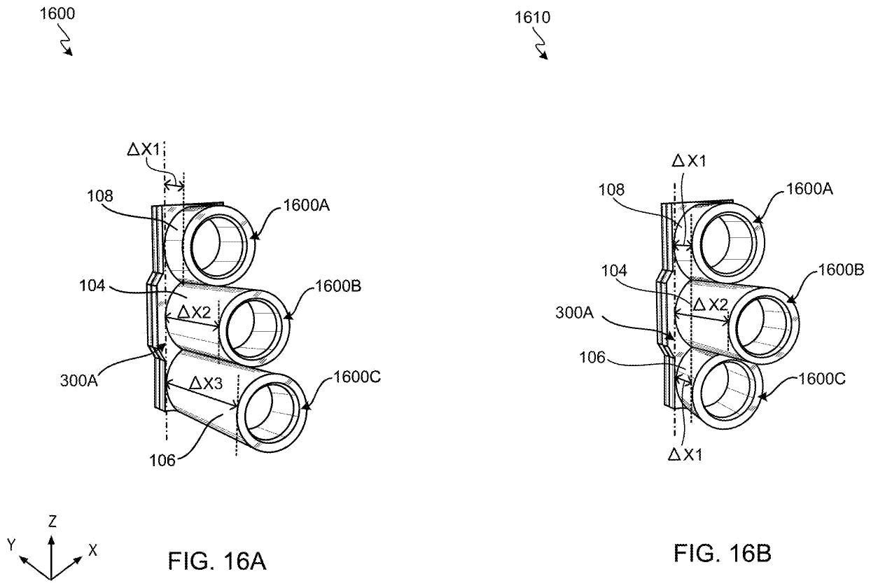

FIG. 16A is a schematic side view of a housing 1600, in accordance with at least one embodiment. Referring collectively to FIGS. 3 and 16A, housing 1600 may be part of a manifold backplate, such as backplate 202. In at least one embodiment, instead of housing 308 or 310 having a uniform protrusion depth, housing 308 or 310 is segmented into portions. Each portion, corresponding to an individual port, can be designed to have a specific and unique depth. In at least one embodiment, this configuration forms a “stair-step” or multi-plane profile where the mating surfaces of the ports may not lie on a single co-planar surface.

In at least one embodiment, housing 1600 is segmented into a portion 1600A, a portion 1600B, and a portion 1600C, corresponding to ports 108, 104, and 106, respectively.

In at least one embodiment, each portion has a different depth or a thickness measured relative to surface 300A of backplate 202 (along the x-axis direction), where portion 1600A has a thickness X1, portion 1600B has a thickness X2, and portion 1600C has a thickness X3, such that X1<X2<X3. A defining characteristic of this embodiment is that each housing portion has a unique protrusion depth. As illustrated, the front surface of portion 1600A lies on a first plane P1, the front surface of portion 1600B lies on a second plane P2, and the front surface of portion 1600C lies on a third plane P3. In at least one embodiment, planes P1, P2, and P3 are distinct and substantially parallel, creating a staggered, stair-step profile where each front surface is located at a unique distance from the backplate.

In at least one embodiment, this multi-plane, staggered configuration creates a highly specific three-dimensional mechanical key. This requires a mating connector to have a precisely matched three-dimensional profile, with corresponding surfaces at three different depths to achieve a proper seal. In at least one embodiment, a connector with a substantially matched, and complementary 3D profile can engage with housing 1600. A standard connector with a flat mating face, or a connector designed for a different keying profile, would be physically obstructed by the staggered port surfaces and unable to form a proper seal.

In at least one embodiment, this design provides an advanced level of error-proofing, ensuring that only a specific connector can engage with this specific manifold configuration. This is particularly advantageous in complex filtration systems to prevent the incorrect installation or sequencing of different filter types, each associated with a specific port.

FIG. 16B is a schematic side view of an alternative housing 1610, in accordance with at least one embodiment. Referring collectively to FIGS. 3 and 16B, housing 1610 may be part of a manifold backplate, such as backplate 202. In at least one embodiment, housing 1610 is segmented into three portions, such as portion 1600A, a portion 1600B, and a portion 1600C, corresponding to ports 108, 104, and 106, respectively. In this embodiment, the front surface of portion 1600B protrudes outward further than the front surfaces of portion 1600A and portion 1600C relative to a surface 300A of backplate 202. In at least one embodiment, portion 1600A and portion 1600C have a first thickness X1 (measured along the x-axis direction) relative to surface 300A, while portion 1600B has a second, different thickness X2, such that X1<X2. As illustrated, the front surfaces of portions 1600A and 1600C are co-planar, lying on a first plane P1, while the front surface of portion 1600B lies on a second, more protruded plane P2.

In at least one embodiment, this specific profile with a protruding central portion serves as another example of a unique mechanical key. This configuration requires a mating connector with a corresponding recessed center to accommodate the protrusion of portion 1600B.

In at least one embodiment, by varying the protrusion patterns across different housing portions, as demonstrated by the contrast between FIG. 16A and FIG. 16B, a large library of mutually exclusive, mechanically keyed manifold and connector pairs can be created. This allows for a highly flexible and error-proof system architecture, preventing the misconnection of various specialized components within a modular filtration train.

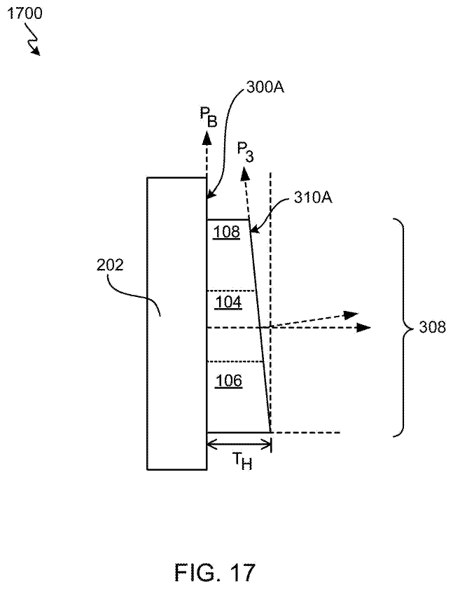

FIG. 17 illustrates a side view 1700 of an alternative embodiment of a manifold port housing, demonstrating a different mechanical keying strategy. In this embodiment, a single, continuous port housing 308 (or 310) includes multiple port regions, such as for ports 108, 104, and 106. In at least one embodiment, a frontal surface 308A of housing 308 is sloped at an angle relative to a plane PB of backplate 202.

In at least one embodiment, frontal surface 308A lies on a single plane P3, which is neither parallel nor perpendicular to backplate plane PB. This continuous, angled surface creates a unique keying profile that is structurally distinct from both a standard flat-faced manifold and the staggered-plane embodiment shown in FIGS. 16A and 16B. A connector designed to interface with this manifold must have a correspondingly sloped mating face to achieve a flush, parallel fit and ensure a proper fluidic seal across all ports. This requirement makes the design mutually exclusive with other keying systems, providing another robust method for preventing incorrect component assembly within the modular filtration system.

FIGS. 15A, 15B, 16A, 16B, and 17 have described features of housing with respect to housing 308 and housing 310. The features and properties described can be applicable to housing 908 and housing 910 described in FIG. 9B, and to housing 1206 and housing 1208 described in FIG. 12B.

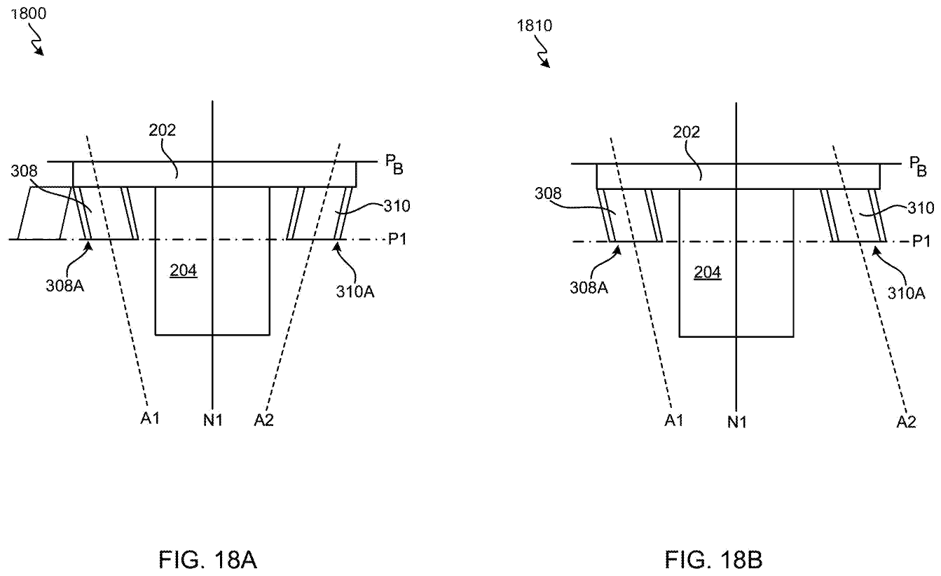

FIG. 18A is a top view of another embodiment of manifold 1800, in accordance with at least one embodiment. In at least one embodiment, manifold 1800 includes features of manifold 200 in FIG. 2, such as backplate 202, ports, collections C1 and C2, and holder 204. In this alternative embodiment, manifold 1800 includes backplate 202 with protruding housings 308 and 310 that are angled or tilted relative to backplate 202, in contrast to housings 308 and 310 in FIGS. 15A and 15B. In the illustrative embodiment, front surfaces 308A and 310A are co-planar, lying on a single plane P1. A defining characteristic of this embodiment is that the port axes are not parallel to the normal N1 of backplate 202. In at least one embodiment, an axis A1 of ports in collection C1 and an axis A2 of ports in collection C2 are angled relative to normal N1 of a plane P_{B} of backplate 202. In at least one embodiment, axis A1 of ports in collection C1 and an axis A2 of ports can be angled inwardly toward each other, as shown.

In at least one embodiment, this angled-axis configuration provides a distinct form of mechanical keying. The non-parallel orientation of port axes A1 and A2 ensures that only a connector with a correspondingly angled mating interface can be used. In at least one embodiment, connectors with matching ports may be inserted into openings of ports within housing 308 and housing 310.

In at least one embodiment, angled ports can prevent the use of standard, straight-insertion connectors and serve as a robust error-proofing mechanism. This is advantageous for ensuring that a specialized manifold is paired exclusively with its intended connector, for instance, in systems requiring specific flow paths or pressure ratings. In at least one embodiment, connectors with matching ports may connect with a front portion of housing 308 and 310 using quick clamps and O-ring seals.

FIG. 18B is a front view of another embodiment of manifold 1810, in accordance with at least one embodiment. In at least one embodiment, manifold 1810 includes features of manifold 200 in FIG. 2, such as backplate 202, ports, collections C1 and C2, and holder 204. In this alternative embodiment, manifold 1810 includes backplate 202 with protruding housings 308 and 310 that are angled or tilted relative to backplate 202.

In this configuration, front surfaces 308A and 310A are co-planar, lying on a single plane P1. Similar to the embodiment of FIG. 18A, the port axes are angled relative to the backplate normal N₁. In the illustrative embodiment, axis A1 of ports in collection C1 and an axis A3 of ports in collection C2 are angled towards and away from holder 204, respectively, relative to a normal N1 of a plane P_{B} of backplate 202. In at least one embodiment, A1 and A3 are parallel or substantially parallel to each other, but not parallel to N1.

In at least one embodiment, this outward-angled axis configuration provides another distinct form of mechanical keying, which is mutually exclusive from the inwardly-angled profile shown in FIG. 18A. This configuration needs a mating connector to have correspondingly outward-angled ports to achieve a proper connection.

In at least one embodiment, this design prevents the use of connectors designed for straight-insertion (FIG. 15A) or for inwardly angled ports (FIG. 18A). By creating a family of mutually exclusive keyed profiles based on the direction of the port angle, the system architecture ensures a high degree of error-proofing, guaranteeing that specialized manifolds are only paired with their intended connectors.

Further alternative keying approaches can be implemented by varying the diameters of individual ports within a collection, varying the vertical distance or pitch between adjacent ports, or varying the horizontal alignment of ports relative to a central axis of the manifold. In each case, a compatible system requires a connector with correspondingly sized or spaced port interfaces. Each of these unique geometric configurations necessitates a connector with a precisely matched “lock-and-key” profile, making it physically impossible to connect incompatible manifold types or to use the wrong connector for a given interface. This robust, physical error-proofing guarantees that specialized components, such as a sensitive RO membrane, are always installed in the correct sequence, thereby enhancing the safety and reliability of the entire modular system.

FIG. 19A is an isometric illustration of a filtration train 1900, in accordance with at least one embodiment. In at least one embodiment, filtration train 1900 is designed to enable assembly of any number of filtration units into a custom filtration train where, regardless of the flow configuration, the physical order of the filtration units can remain linear. In at least one embodiment, filtration train 1900 includes a plurality of manifolds, such as manifold 200A, 200B, and 200C, positioned adjacent to one another. In the illustrative embodiment, each manifold comprises a backplate 202 and may be structurally indistinguishable from its neighbors, allowing for a uniform, modular system. While collections C1 and C2 are located on physically opposite sides of a backplate 202, the linear arrangement of filtration train 1900 brings collection C2 of one manifold (e.g., 200B) into a side-by-side, facing relationship with collection C1 of an adjacent manifold (e.g., 200A). In at least one embodiment, this side-by-side alignment of collections between adjacent units can enable the assembly of the entire filtration train 1900 into a straight, linear configuration as shown. This arrangement creates a bridge region 1902 formed by two connected adjacent units which is designed to receive a connector.

In the illustrative embodiment, a distinction is made between the interface within bridge region 1902 formed by connecting two adjacent ports and a terminal collection 1904. While bridge region 1902 between adjacent manifolds includes two collections (C1 and C2), a terminal collection 1904 at each end of filtration train 1900 presents only a single collection of ports. This structural difference requires the use of functionally distinct connectors. Specifically, inter-manifold connectors are utilized within bridge region 1902 to establish the desired fluidic configuration (e.g., series or parallel) between adjacent manifolds, while specialized terminal connectors are utilized at each terminal collection 1904 to interface with external plumbing for system-level input and output.

FIG. 19B provides a frontal view 1910 of filtration train 1900, in accordance with at least one embodiment. This view illustrates the repeating, linear arrangement of manifolds 200A, 200B, and 200C. In at least one embodiment, while each manifold may be identically configured, the fluidic coupling between the aligned ports in collections of adjacent ports (for example, C1 and C2) is enabled by a connector (not shown). This integration of multiple bypass lines within the manifolds allows for custom configurations of the filtration paths when used in combination with custom connectors. For instance, a connector may be implemented to couple with ports within bridge region 1902, for example, collection C2 of manifold 200B and collection C1 of manifold 200A, for example. Specific internal pathways of a connector to be implemented will determine the flow configuration (e.g., series or parallel) between the adjacent filtration units, without altering their fixed, linear physical placement. In at least one embodiment, a series flow configuration is typically needed to take different contaminants out of the water at each stage (or to enhance the reduction of the same contaminant), whereas a parallel flow configuration is generally used to reduce flow restrictions and increase flow rates. In at least one embodiment, each unit can be configured for series or parallel flow relative to the previous unit.

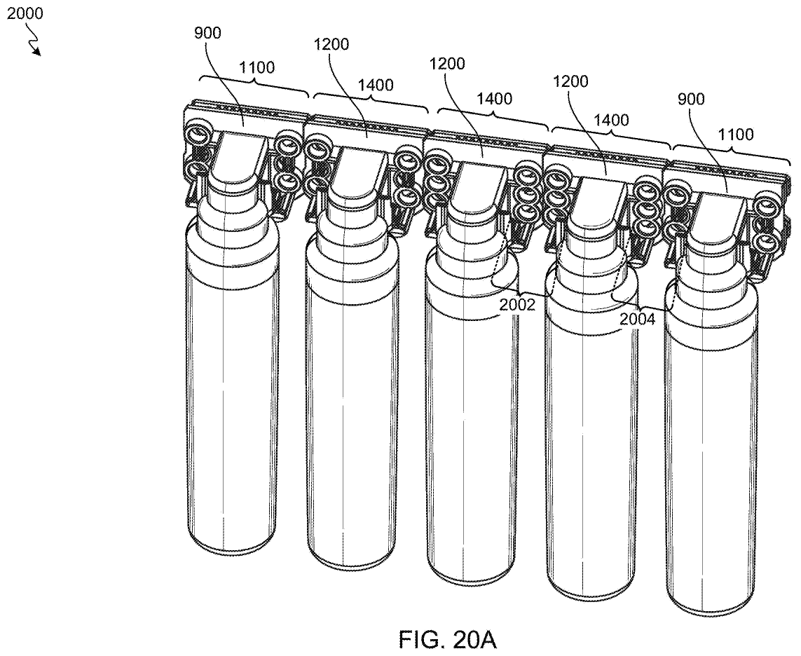

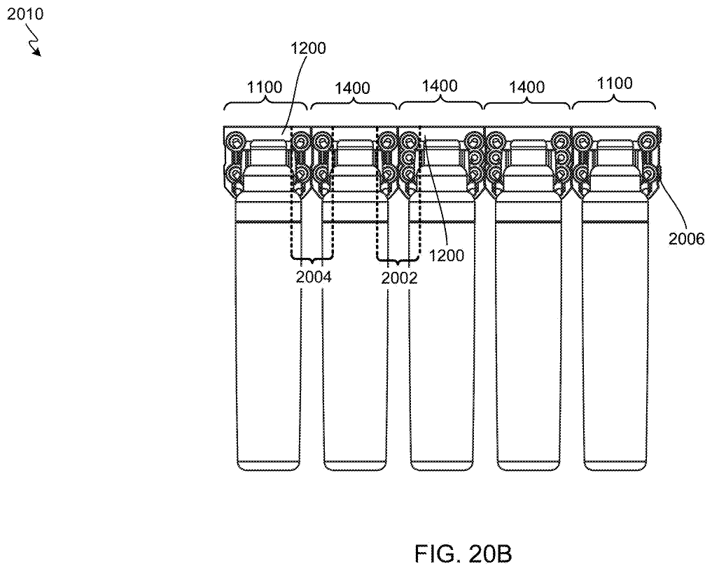

FIG. 20A is an isometric illustration of a filtration train 2000, in accordance with at least one embodiment. In at least one embodiment, filtration train 2000 includes a plurality of manifolds, such as manifold 1100 and RO-capable manifold 1400, positioned adjacent to one another in a linear sequence. In at least one embodiment, manifold 1100 is derived from backplate 900, while manifold 1400 is derived from (RO) backplate 1200. As shown, the train includes a bridge region 2002 where two RO-capable manifolds 1400 are linked by a six-port connector. Additionally, a bridge region 2004 illustrates the connection between a manifold 1100 and an RO-capable manifold 1400. In at least one embodiment, this mixed-system interface utilizes a specialized five-port connector to bridge the different manifold types. These manifolds are fluidly and mechanically linked by their respective connectors, which are inserted into the interface gaps between adjacent units.

In the illustrative embodiment, filtration train 2000 is shown as a mixed system, comprising a combination of manifolds 1100 and RO-capable manifolds 1400. This demonstrates the advanced modularity of the system, where different types of filtration units with different port requirements (e.g., four-port vs. six-port RO) can be seamlessly integrated into a single, physically linear train using function-specific connectors. In other embodiments, a filtration train may be composed entirely of manifolds 1100, entirely of manifolds 1400, or any other combination required for a specific water treatment application.

FIG. 20B provides a front view 2010 of filtration train 2000 from FIG. 20A, in accordance with at least one embodiment. This view highlights the uniform, linear arrangement and further details the different interface requirements. In at least one embodiment, bridge region 2002 illustrates two RO-capable manifolds 1400 linked by a six-port bridge connector. In at least one embodiment, bridge region 2004 illustrates the interface between a manifold 1100 and an RO-capable manifold 1400, which is linked by a specialized five-port connector. In at least one embodiment, a terminal region 2006 is shown having a two-port interface designed for an end connector. In at least one embodiment, while each manifold is a physically distinct unit, the specific internal pathways of the chosen connectors or terminal connectors determine the fluidic coupling and flow configuration between the adjacent filtration units, without altering their fixed, linear physical placement.

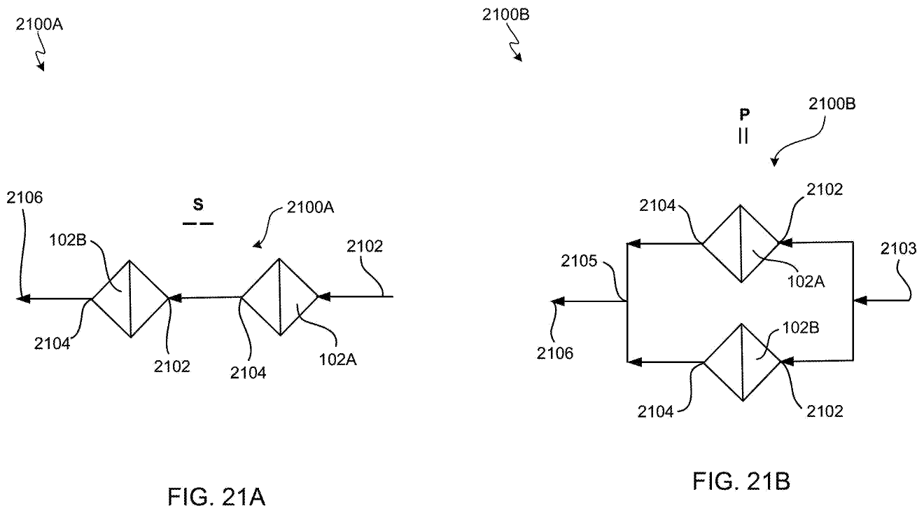

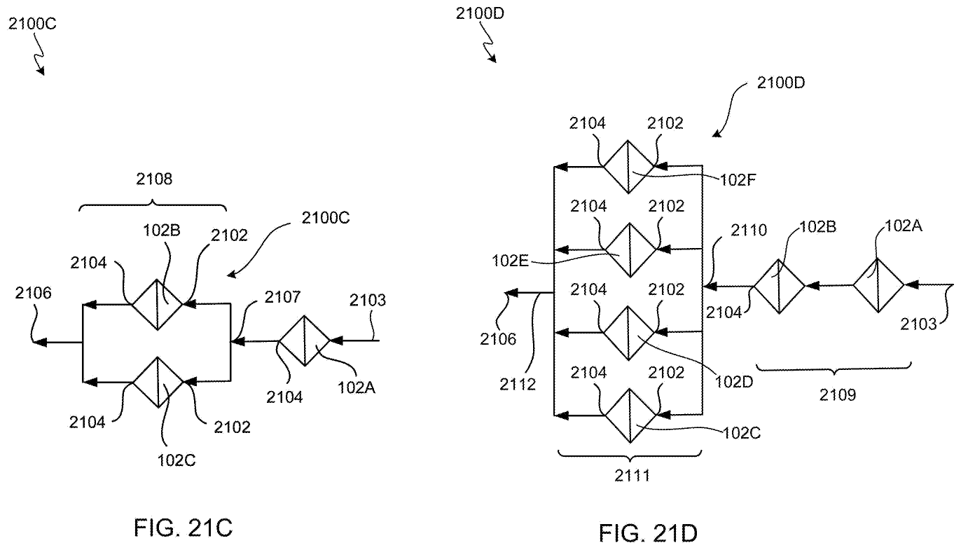

FIGS. 21A-D provide schematic illustrations of selected exemplary embodiments of custom flow configurations that can be achieved within a filtration train. These configurations demonstrate the modular functionality enabled by the system's filter manifolds and corresponding connectors. In at least one embodiment, different logical flow paths can be created by selecting the appropriate connector between physically linear filtration units, without needing to alter the plumbing or the fixed order of the units.

FIG. 21A illustrates a series configuration 2100A, in accordance with at least one embodiment. In this configuration, fluid (denoted by arrows) enters and exits through input 2102 and output 2104, respectively, of a filter 102A. In at least one embodiment, filter 102A is fluidly connected to inlet 2102 of an adjacent filter 102B. In at least one embodiment, fluid output from output 2104 of filter 102B is routed to a system outlet 2106. In at least one embodiment, this series flow path is typically used for sequential water treatment, where each stage removes different types of contaminants, leading to enhanced overall contaminant reduction.

FIG. 21B illustrates a parallel configuration 2100B, in accordance with at least one embodiment. In this configuration, a system inlet 2103 provides fluid to a parallel block comprising a filter 102A and a filter 102B. In at least one embodiment, the individual outputs from output 2104 of respective filters 102A and 102B are gathered at an intermediate collective outlet 2105. The combined fluid from intermediate collective outlet 2105 is then directed to a system outlet 2106. In at least one embodiment, this parallel arrangement allows for a greater total flow rate through the system and extends the operational life of the filtration media by distributing the fluid load across multiple filters.

FIG. 21C illustrates a first mixed configuration 2100C, in accordance with at least one embodiment. In this arrangement, a system inlet 2103 provides fluid to a single filter 102A. The output 2104 from filter 102A then serves as an intermediate collective input 2107 for a subsequent parallel block of filters 2108. In at least one embodiment, this parallel block comprises a filter 102B and a filter 102C. At intermediate collective input 2107, the fluid stream is split into individual inputs 2102 of respective filters 102B and 102C in the parallel block of filters 2108. The individual outputs 2104 from filters 102B and 102C are then gathered and directed to a system outlet 2106. In at least one embodiment, this configuration is advantageous for applications requiring a single stage of pre-treatment. In at least one embodiment, the system may include a low-restriction filter followed by a secondary treatment with two high-restriction filters connected in parallel to reduce their overall restriction.

In at least one embodiment, the flow rate through 102A has the same or substantially the same magnitude as the flow rate through the parallel block of filters 2108 and can be equal to the sum of the flow rates through filters 102B and 102C. In at least one embodiment, if filters 102B and 102C have identical flow resistance, then the flow through each filter 102B and 102C will be half of the flow through filter 102A.

FIG. 21D illustrates a second, more complex mixed configuration 2100D, in accordance with at least one embodiment. In this arrangement, a system inlet 2103 provides fluid to a sequential block of filters 2109, which is configured similarly to the series arrangement of FIG. 21A. The fluid passes first through filter 102A, and its output is then directed in series to the input of filter 102B. The output from this initial series block then serves as an intermediate collective input 2110 for a subsequent, parallel block, such as a parallel block of filters 2111. In at least one embodiment, this parallel block comprises four filters: filter 102C, filter 102D, filter 102E, and filter 102F. At intermediate collective input 2110, the fluid stream is split into individual inputs 2102 of the respective filters in the parallel block of filters 2111. The individual outputs 2104 from each of the four filters in the parallel block are then gathered at collective output 2112 and directed to a system outlet 2106. In at least one embodiment, this configuration is suitable for demanding applications that require multi-stage sequential pre-treatment followed by a final polishing or treatment stage.

In at least one embodiment, the different custom flow configurations in FIGS. 21A-D can be realized within filtration trains, such as filtration train 1900 illustrated in FIG. 19A and filtration train 2000 illustrated in FIG. 20A. In at least one embodiment, implementation is realized through customized coupling connectors that couple collections C1 and C2 between two filter manifolds and through end connectors that begin and terminate at the beginning and end of the trains.

FIG. 22A is an isometric illustration of a connector 2200, in accordance with at least one embodiment. In at least one embodiment, connector 2200 is designed to provide a flow path to fluidly and mechanically bridge two adjacent manifolds in a filtration train, for example, two adjacent manifolds such as manifold 200 in filtration train 1900 (FIG. 19A). Connector 2200 comprises a backplate 2202, which includes a surface 2202A of the backplate plane. In at least one embodiment, a biasing agent 2204, such as a lever or handle, is coupled to a rear section of backplate 2202, opposite to surface 2202A. This biasing agent 2204 may be part of a cam-actuated mechanism to provide a mechanical advantage for the installation and removal of connector 2200 (as discussed below). In other embodiments, biasing agent 2204 can be a connector pin or a screw.

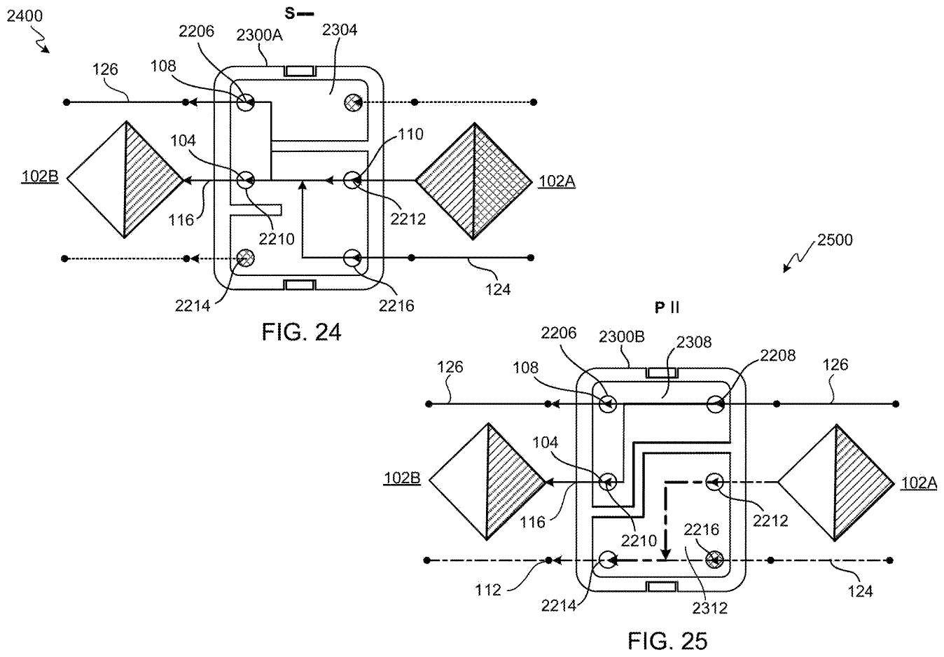

In at least one embodiment, backplate 2202 includes a plurality of ports. In the illustrative embodiment, backplate 2202 includes a total of six connector ports, such as a port 2206, a port 2208, a port 2210, a port 2212, a port 2214, and a port 2216. In at least one embodiment, while each port can comprise a port opening, one or more connectors have some of the ports blocked at the base of the port opening. In the illustrative embodiment, opening 2206O, opening 2208O, opening 2210O, opening 2212O, opening 2214O, and opening 2216O refer to the openings of their respective connector ports within connector 2200. While connector 2200 is illustrated with six ports, in other embodiments, the number of ports can be at least 2. Different embodiments of connectors are described in association with their functionalities with respect to a manifold train in FIGS. 24A-32B.

A key feature of this embodiment is the orientation of connector ports 2206, 2208, 2210, 2212, 2214, and 2216. As illustrated, port 2206 comprises a first orientation defined by vector P1, and port 2208 comprises a second orientation defined by vector P2. In at least one embodiment, these orientations are measured relative to a vector N1, normal to surface 2202A. While vectors P1, P2, and N1 are shown as parallel in FIG. 22A, in alternative embodiments, angular orientations of the ports relative to vector N1 may vary individually, as can the respective length or diameter of the ports. This adaptability allows connector 2200 to interface with different manifold housing geometries, providing a robust mechanical keying feature that prevents incorrect installation.

FIG. 22B is a schematic plan view illustrating the pre-coupling stage between connector 2200 and a co-planar port interface within a bridge region 1902, such as is shown in FIG. 19A. In this configuration, the manifold housings 308 and 310 on adjacent manifolds present their respective ports (e.g., 114 and 108) on a single, co-planar plane P1 relative to the manifold's backplate plane PB. In at least one embodiment, to interface with this uniform geometry, the corresponding connector ports 2206 and 2208 of connector 2200 are designed with the same or substantially the same protrusion length L1 as measured from surface 2202A. In at least one embodiment, when connector 2200 is directed towards bridge 2221 as indicated by arrow 2219, matching lengths or diameters can enable error-free coupling.

FIG. 22C is a schematic plan view illustrating a pre-coupling stage between connector 2200 and a staggered-plane port interface within a bridge 2221, in accordance with another embodiment. In at least one such embodiment, bridge 2221 includes ports within collection C1 and collection C2. In this configuration, designed for mechanical keying, the manifold housings 308 and 310 are on two different, parallel planes. As shown, the port interface of housing 308 lies on a first plane P1, while the port interface of housing 310 for port 114 lies on a second, more protruded plane P2. To accommodate this specific profile, the ports on connector 2200 are designed with different lengths. As shown, port 2208 has a first length L2 to mate with the port on plane P1, while port 2206 has a second, shorter length L3 to mate with the port on plane P2. This ensures that only a connector with this specific, non-uniform length profile can be used with this particular manifold interface. This design is advantageous for creating an error-proof system, especially when specialized flow paths are required.

Referring again to FIG. 19A, a key advantage of the disclosed filtration train architecture is the decoupling of the system's physical layout from its fluidic logic. In at least one embodiment, filtration train 1900 is designed to enable a simple, linear assembly of any number of manifolds (200A, 200B, 200C), providing a uniform and scalable physical framework.

However, this fixed linear arrangement does not impose a fixed fluidic pathway. Instead, the flow path between any two or more adjacent manifolds can be precisely tuned to create series, parallel, or even complex mixed-mode configurations. This functional versatility is achieved not by reconfiguring the manifolds themselves, but by selecting and implementing a specific connector, such as connector 2200, within the interface gap between the units.

In at least one embodiment, the internal fluid pathways and features of the chosen connector are specifically customized to dictate the desired flow logic. By manufacturing a family of connectors with different internal structures, a wide array of filtration schemes can be realized using the same set of standardized manifolds. For example, a “series connector” would be designed to route treated fluid from the outlet of a first manifold to the inlet of the following manifold. Conversely, a “parallel connector” would feature separate internal channels to link the corresponding bypass lines (e.g., feed-to-feed and filtrate-to-filtrate) across the manifolds.

Furthermore, this connector-based architecture allows for the integration of other advanced capabilities. In at least one embodiment, specialized connectors can be designed to incorporate additional functionalities, such as providing tap ports for accessing product water at intermittent filtration levels, monitoring pressure, sampling fluid, integrating a dedicated drain and tank lines for a Reverse Osmosis (RO) system, and/or including an automatic shutoff valve for RO systems, all without altering the primary linear assembly of the filtration train.

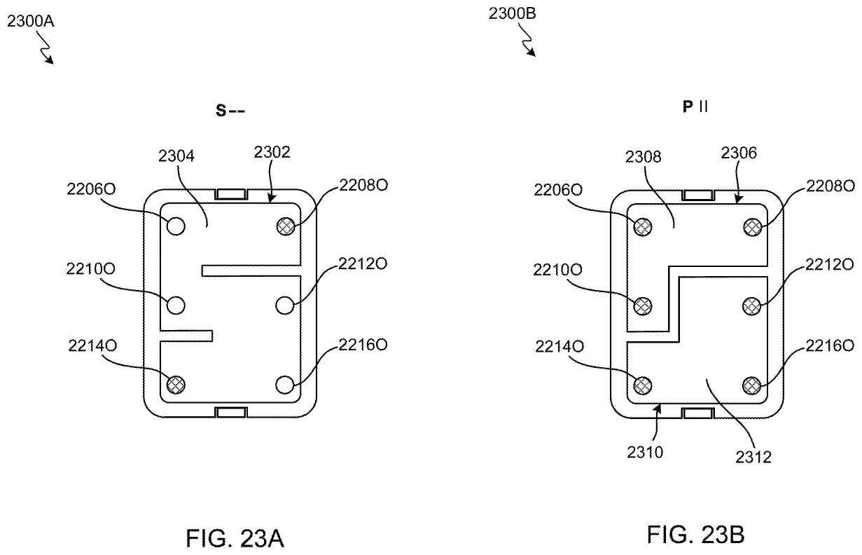

FIG. 23A is an illustration of an internal structure of a series connector 2300A, in accordance with at least one embodiment. In at least one embodiment, series connector 2300A is an embodiment of connector 2200 (FIG. 22A) that is specifically designed to enable a “series” fluid path connectivity between adjacent manifolds. In at least one embodiment, a single or several separate components may be welded together or otherwise mechanically fastened to create the internal flow path of series connector 2300A. In at least one embodiment, connector 2300A is designed to be installed between two adjacent manifolds to configure their respective filtration units for series flow. Its openings 2206O, 2208O, 2210O, 2212O, 2214O, and 2216O are arranged to align with the ports within collections of adjacent manifolds, such as collections C1 and C2 (FIG. 19A).

In at least one embodiment, series connector 2300A includes a single internal fluid boundary 2302 that defines a continuous region 2304. In at least one embodiment, region 2304 establishes fluid communication between a specific subset of openings, namely openings 2206O, 2210O, 2212O, and 2216O. In contrast, openings 2208O and 2214O are isolated by fluid boundary 2302 and are effectively capped or blocked within this particular connector configuration.

By implementing series connector 2300A, a series flow path between two physically adjacent filtration units can be established without altering their linear placement. The specific path created by region 2304 ensures that the primary fluid stream is routed sequentially from one filtration unit to the next, for instance, by directing fluid from the outlet of a first manifold to the inlet of a second manifold. The implementation of series connector 2300A is described in FIG. 24.

FIG. 23B is an illustration of an internal structure of a parallel connector 2300B, in accordance with at least one embodiment. In at least one embodiment, parallel connector 2300B is an embodiment of connector 2200 (FIG. 22A) that is specifically designed to enable “parallel” fluid path connectivity between adjacent manifolds. In at least one embodiment, a single or several separate components may be welded together or otherwise mechanically fastened to create the internal flow paths. In at least one embodiment, parallel connector 2300B is designed to be installed between two adjacent manifolds to configure their respective filtration units for parallel flow. Its openings 2206O, 2208O, 2210O, 2212O, 2214O, and 2216O are arranged to align with the ports within collections (for example, C1 and C2) of adjacent manifolds.

In at least one embodiment, parallel connector 2300B contains two separate internal fluid boundaries. A first fluid boundary, such as fluid boundary 2306, defines a continuous region 2308, which establishes fluid communication exclusively between a first set of openings, namely openings 2206O, 2208O, and 2210O. Separately, a second fluid boundary, such as fluid boundary 2310, defines a continuous region 2312, which establishes fluid communication exclusively between a second set of openings, namely openings 2212O, 2214O, and 2216O. In this configuration, no openings are isolated or blocked; all are active within one of the two distinct fluid regions.

By selecting this parallel connector 2300B, a parallel flow path between two or more physically adjacent filtration units can be established without altering their linear placement. In at least one embodiment, region 2308 can function as a common filtrate line, and region 2312 can function as a common feed line. This internal structure ensures that when installed, multiple adjacent filtration units can share a common fluid input and a common fluid output, thereby operating in parallel. The implementation of parallel connector 2300B is described in FIG. 25.

FIG. 24 is a schematic 2400 illustrating the use of a series connector 2300A to establish a sequential fluidic connection between two adjacent manifolds, in accordance with at least one embodiment. In this configuration, the series connector 2300A fluidly couples filter 102A, associated with a first manifold, and filter 102B, associated with a second manifold, effectively placing them in a series treatment path. For clarity, labels for the manifold ports are used to show their precise interface with the corresponding ports of the series connector.

In at least one embodiment, the primary series fluid path is established by directing the filtered output from filter 102A to the input of filter 102B. Specifically, fluid exits filter 102A via port 110 and enters series connector 2300A at its port 2212. The fluid then traverses a path within region 2304 and exits the connector at port 2210. In at least one embodiment, port 2210 is coupled to port 104, which directs the fluid to the input of filter 102B, thereby completing the sequential treatment path.

In at least one embodiment, in addition to creating the series treatment path, series connector 2300A simultaneously facilitates a separate bypass path within region 2304. In at least one embodiment, fluid from an upstream fluid path or path 124, may be a fluid at the same level of treatment flowing from a parallel filter located upstream (not shown). In at least one embodiment, fluid from the bottom bypass line or path 124 of filter 102A enters connector 2300A at port 2216. This fluid traverses a path within region 2304 and exits at port 2206 to continue downstream along path 126. This design demonstrates how a single connector can manage both a series treatment path and a bypass line simultaneously, enabling complex mixed-mode configurations within a larger filtration train.

FIG. 25 is a schematic 2500 illustrating the use of a parallel connector 2300B to establish a parallel fluidic connection between two adjacent manifolds. This configuration fluidly couples filter 102A, associated with a first manifold, and filter 102B, associated with a second manifold, enabling them to operate in parallel. For clarity, labels for the manifold ports are used to show their precise interface with the corresponding ports of the parallel connector.

In at least one embodiment, the connector establishes a common feed line using fluid region 2308. Fluid to be treated enters fluid region 2308 via port 2208. In at least one embodiment, in fluid region 2308, the feed stream is split to supply multiple parallel paths. A first portion of the stream exits through port 2210 to supply the input of filter 102B via its corresponding port 104. Simultaneously, a second portion of the feed stream continues through fluid region 2308 and exits via port 2206, supplying a downstream feed bypass path or path 126 via port 108.

In at least one embodiment, the connector establishes a common filtrate line using its second, isolated fluid region, such as fluid region 2312. This region is designed to collect and combine treated fluid from multiple sources. In at least one embodiment, treated fluid from the output of filter 102A enters fluid region 2312 via port 2212. In at least one such embodiment, treated fluid from an upstream source (e.g., the output of another filter) traveling along bypass path 124 enters fluid region 2312 through port 2216. The combined, filtered fluid from these sources is then directed downstream into path 116 by exiting through port 2214 and its corresponding port 112.

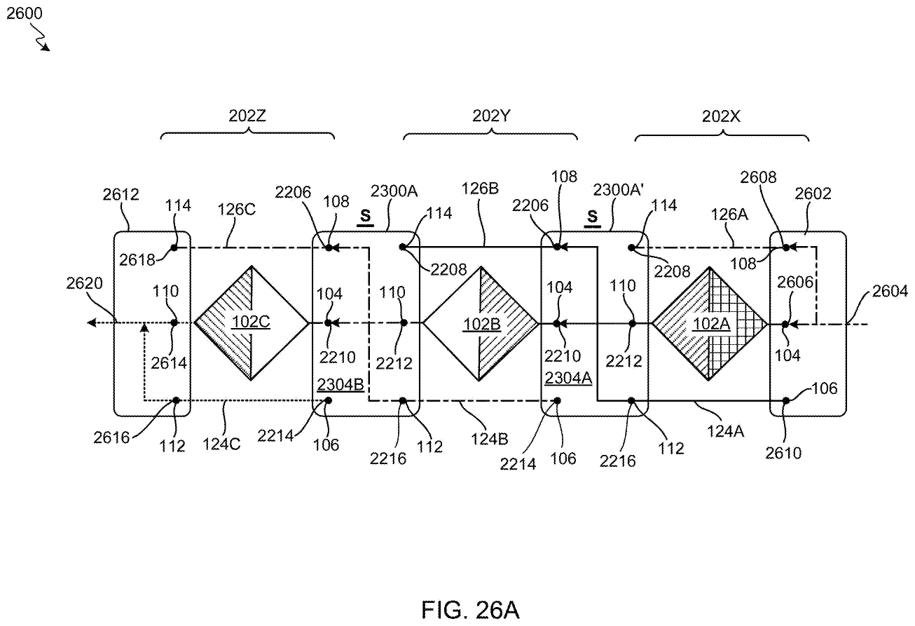

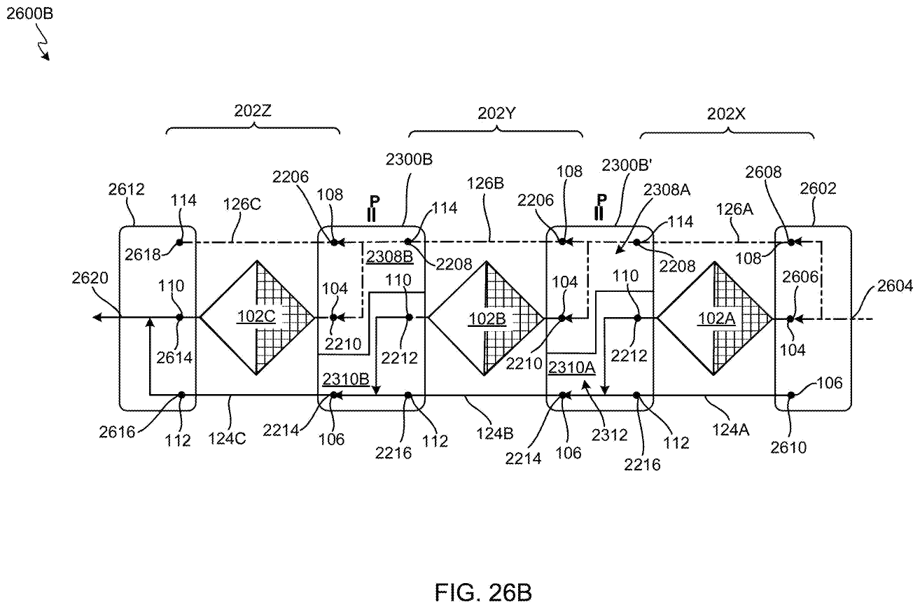

FIG. 26A is a schematic 2600 of a filtration train configured for series flow, which builds upon the series connection concept shown in FIG. 24. The train comprises multiple manifolds 202X, 202Y, and 202Z, linked by series connectors 2300A and 2300A′, and is terminated by specialized input/output connectors, such as terminal connector 2602 and terminal connector 2612.

In at least one embodiment, a port labeling convention is implemented that indicates the interface between a connector port and a manifold port. For example, where port 2210 connects to port 104, both labels are shown to indicate the fluidic junction, as there is no physical separation at this interface when a connector is inserted into the ports.

In at least one embodiment, the fluid path for the first stage begins at terminal connector 2602. A main fluid stream to be treated is introduced through a system input port 2604 (far right). In at least one embodiment, within terminal connector 2602, the fluid is directed from system input port 2604 to port 2606 (port 104). This directs the fluid into the input of filter 102A. Simultaneously, terminal connector 2602 may establish an upper bypass path 126A by routing fluid from port 2608 to port 2208, but this terminates at port 2208.

After passing through filter 102A, the now-treated fluid exits manifold 202X via port 110 and enters a series connector 2300A via port 2212. Inside series connector 2300A, the fluid traverses fluid region 2304A and is delivered to the input of filter 102B via port 104 to continue the sequential treatment process.

In at least one embodiment, continuing the sequential treatment, the fluid treated by filter 102B exits manifold 202Y via port 110 and enters series connector 2300A′ at its corresponding port 2212. The fluid then traverses fluid region 2304B of series connector 2300A′ and exits at port 2210. This port is coupled to port 104 of a last manifold or manifold 202Z, delivering the twice-filtered fluid to the input of filter 102C.

After final treatment by filter 102C, the triple-treated fluid exits manifold 202Z via port 110 and enters the last terminal connector or connector 2612 at port 2614. In at least one embodiment, within connector 2612, the fluid stream is split. A first portion of the fluid exits the system as the final product through a main system outlet or outlet 2620. A second portion of the triple-treated fluid is diverted and exits connector 2612 via port 2616, which is coupled to port 112 on manifold 202Z. This re-injects a portion of the final treated water into the lower bypass path 124B, and stays within lower bypass path 124B.

Throughout this process, the series connectors and terminal connectors also manage the continuation of isolated bypass paths. In at least one embodiment, once treated fluid from filter 102A enters both upper bypass path 126B and lower bypass path 124A through series connector 2300A. In the illustrative embodiment, upper bypass path 126B and lower bypass path 124A are fluidically coupled but do not contribute to the filtration process. In at least one embodiment, lower bypass path 124A terminates at port 2610.

Similarly, in at least one embodiment, twice-treated fluid from filter 102B enters both upper bypass path 126C and lower bypass path 124B through series connector 2300A′. In the illustrative embodiment, upper bypass path 126C and lower bypass path 124B are fluidically coupled but do not contribute to the filtration process. In at least one embodiment, upper bypass path 126C terminates at port 2618. In at least one embodiment, lower bypass path 124C is ultimately fed by the diverted final product stream from last terminal connector 2612 via port 2616, demonstrating a complex recirculation or blending capability within the system.

FIG. 26B is a schematic of a filtration train 2600B configured for parallel flow, in accordance with at least one embodiment. In at least one embodiment, filtration train 2600B comprises manifolds 202X, 202Y, and 202Z, linked by parallel connectors 2300B and 2300B′, and is terminated by specialized input and output connectors 2602 and 2612, respectively. In at least one embodiment, parallel connectors 2300B and 2300B′ are implementations of a parallel connector with two isolated fluid regions as shown in FIG. 23B. In the illustrative embodiment, parallel connectors 2300B and 2300B′ are identical or substantially identical.

In at least one embodiment, a common feed line is established in filtration train 2600B by utilizing the upper fluid region (e.g., 2308A and 2308B) of the parallel connectors 2300B and 2300B′, respectively, and upper bypass paths 126A, 126B, and 126C. Fluid to be treated enters terminal connector 2602 at system input port 2604. This feed stream is split: a first portion is directed to the input of filter 102A via port 104, while a second portion is directed into the upper bypass path 126A via port 108. In at least one embodiment, upper bypass path 126A then acts as the feed supply for subsequent filters 102B and 102C.

At manifold 202Y, the feed stream from upper bypass path 126A is tapped to supply the input of filter 102B via port 104 (port 2210). This process repeats for each subsequent filter in the train, ensuring all filters receive the same source water in parallel. In at least one embodiment, the feed stream from upper bypass path 126B is tapped to supply filter 102C via port 2208 (port 114) within parallel connector 2300B′.

In at least one embodiment, a common filtrate line is established by utilizing the lower fluid region (e.g., 2312) of the parallel connectors and the lower bypass fluid path (124A, 124B, and 124C). In at least one embodiment, treated fluid from the output of filter 102A (port 110) enters lower region 2310A of connector 2300B′ and is directed into the lower bypass path 124A via port 2216 and terminates at port 2610. In at least one embodiment, a portion of this treated fluid enters lower bypass path 124B via port 2214. This treated fluid then enters lower region 2310B of parallel connector 2300B through port 2216. As the path continues, the treated water from the output of filter 102B (port 110) flows into lower region 2310B, combining with treated fluid from filter 102A. This combined treated fluid exits port 2214 and flows along lower bypass path 124C.

Finally, the combined, filtrate stream (treated fluid) from the lower bypass path 124C, along with the treated fluid output from the last filter 102C (at port 110), is collected in the last terminal connector 2612. This total combined filtrate stream then exits the system through outlet 2620. This architecture demonstrates how parallel connectors use separate internal lines to distribute a common feed stream and collect a common filtrate stream, enabling multiple filters to operate simultaneously to increase flow capacity. The final treated stream at outlet 2620 is a combination of once-treated fluid from filters 102A, 102B, and 102C.

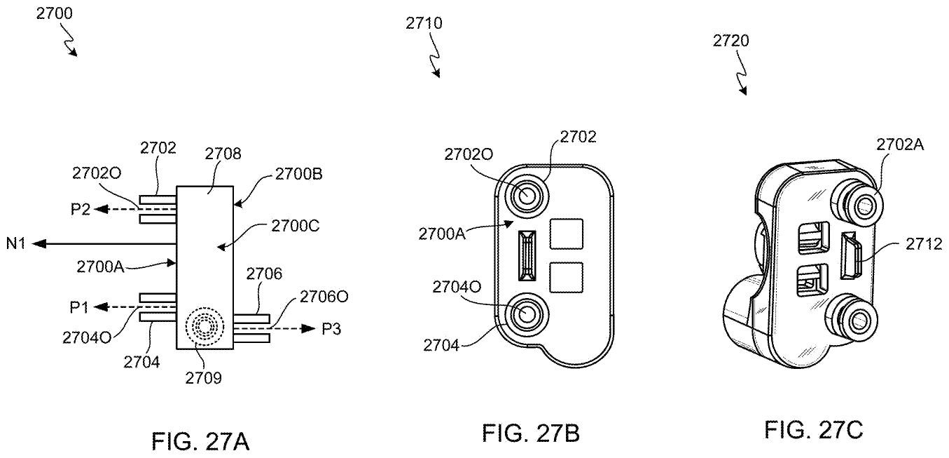

FIG. 27A is a cross-sectional illustration of tap connector 2700, in accordance with at least one embodiment. In at least one embodiment, tap connector 2700 is designed to provide a flow path and a tap point within or at terminal locations of a filtration train. In at least one embodiment, the phrase “tap point” herein refers to a system port configured to connect the system to external plumbing. Tap connector 2700 comprises a main body or backplate 2708.

In at least one embodiment, backplate 2708 includes a plurality of ports. In the illustrative embodiment, a surface 2700A of tap connector 2700 includes a port 2702 and a port 2704. In at least one embodiment, a side 2700B, opposite to surface 2700A, includes a tap port 2706. Each port comprises a respective port opening 2702O, 2704O, and tap opening 2706O. In at least one embodiment, port 2702, port 2704, and tap port 2706 are all in fluid communication with each other through a continuous internal fluid path within backplate 2708. In at least one embodiment, with a two-port configuration, tap connector 2700 is designed to plug into a collection of ports within a manifold that comprises two ports. Typically, a tap connector 2700 comprising two ports may be implemented with backplate 900 (FIG. 9A).

A key feature of a tap connector embodiment is the orientation of the connector ports. In at least one embodiment, orientations are measured relative to a vector N1, which is normal to surface 2700A. In at least one embodiment, port 2702 comprises a first orientation defined by a vector P1, port 2704 comprises a second orientation defined by a vector P2, and tap port 2706 comprises a third orientation defined by a vector P3. In at least one embodiment, vectors P1 and P2 are parallel or substantially parallel to normal N1, while vector P3 is anti-parallel or substantially anti-parallel to normal N1. This creates a “U-turn” or T-junction flow path within the connector, where fluid entering one port can be directed out of both the same side and the opposite side.

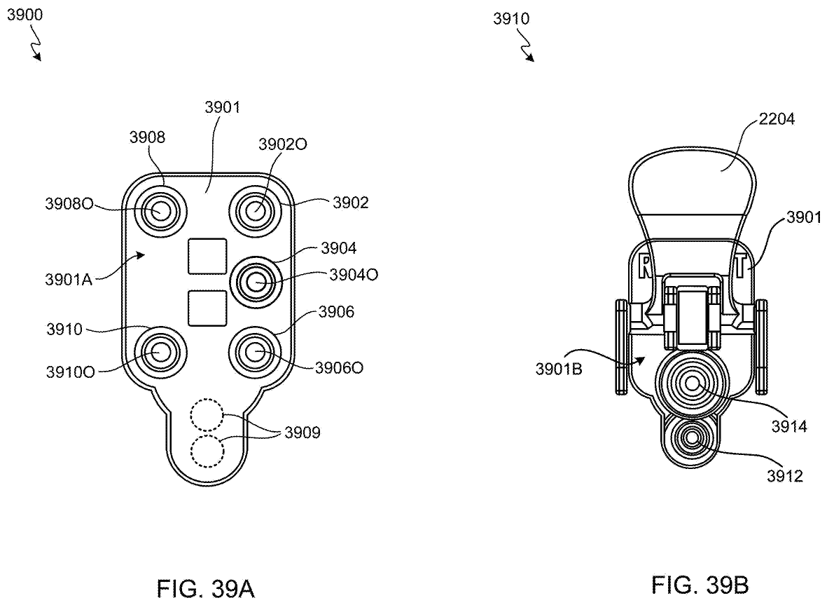

In another embodiment, tap port 2706 can be located on an alternative side, such as side 2700C, while port 2702 and port 2704 remain on surface 2700A. In this orientation, tap port 2706 can be orthogonally oriented (indicated by dashed line 2709) relative to port 2702 and port 2704. Alternatively, tap port 2706 can be located on the top surface, the bottom surface, or the back surface 2700A of connector 2700. In at least one embodiment, while FIG. 27A depicts a tap connector with a single tap port, other embodiments can include multiple tap ports (e.g., FIG. 39A). In at least one embodiment, multiple tap ports may be disposed on a common plane and oriented in the same direction, or they may be disposed on different planes. While a tap connector 2700 with two input/output ports may be implemented at terminals of a filtration train, such a connector can also be implemented for other purposes within a train. This flexibility allows a fluid stream to be tapped or injected at various points in a filtration train, for example, for sampling, pressure monitoring, introducing an additive, draining reject, obtaining intermediate product, or connecting an external RO expansion tank without requiring a specialized manifold. In at least one embodiment, port 2702, port 2704, and tap port 2706 may further comprise an O-ring to seal on an outer surface to facilitate a fluid seal.

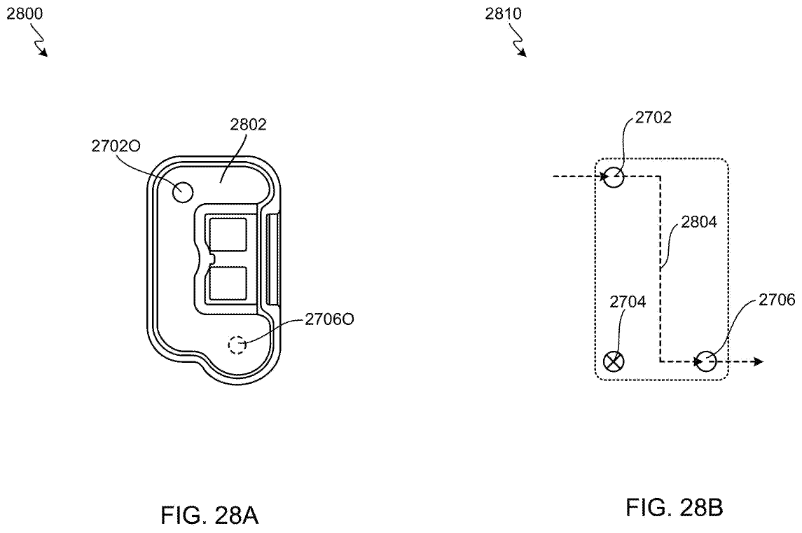

FIG. 27B is a back view 2710 of tap connector 2700, as viewed from its back side or surface 2700A. In this view, port 2702 and port 2704 are shown, each with a respective circular profile and port openings 2702O and 2704O. In at least one embodiment, port openings 2702O and 2704O provide access to the internal fluid pathway within the body of tap connector 2700. In at least one embodiment, while tap connector 2700 is shown with two ports on surface 2700A, it can be configured such that one of the port openings, for example port opening 2704O, may be blocked or capped, as illustrated in the embodiment of FIG. 28A. In at least one embodiment, while tap connector 2700 is shown to include two ports on surface 2700A, additional embodiments may include any number of ports.

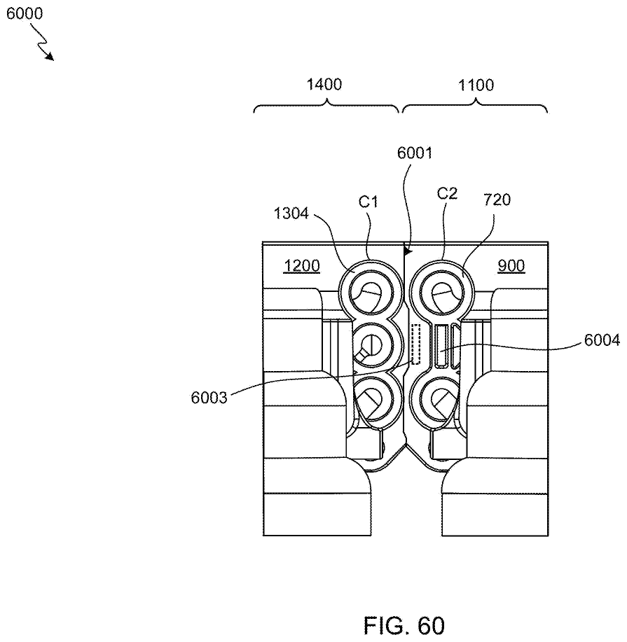

In at least one embodiment, tap connector 2700 can further include a protrusion 2712. In at least one embodiment, the protrusion extends along direction of vector P2 (FIG. 27A). In at least one embodiment, such a protrusion may extend into an opening or recess within a manifold, specifically near port housing (see FIG. 60). An isometric illustration 2720 of tap connector 2700 is illustrated in FIG. 27C, in accordance with at least one embodiment. In at least one such embodiment, protrusion 2712 extends away from surface 2700A. In at least one embodiment, protrusion does not extend beyond surface 2702A of port 2702. In at least one embodiment, protrusion 2712 can extend beyond surface 2702A. In at least one such embodiment, a manifold designed to receive protrusion 2712 can include a receptacle or a depression to accommodate and extend protrusion.

FIG. 28A illustrates a front cross section, through backplate 2708, of an internal fluid path configuration for a tap connector 2800, which is a specific embodiment of tap connector 2700 (FIG. 27A). In this embodiment, an internal fluid boundary defines a region 2802. This region 2802 exclusively encompasses a single port opening 2702O on the main side and tap opening 2706O (shown as a dashed circle) on the opposite side. The boundary of region 2802 effectively isolates and blocks the second port opening on the main side, rendering it inactive in this configuration.

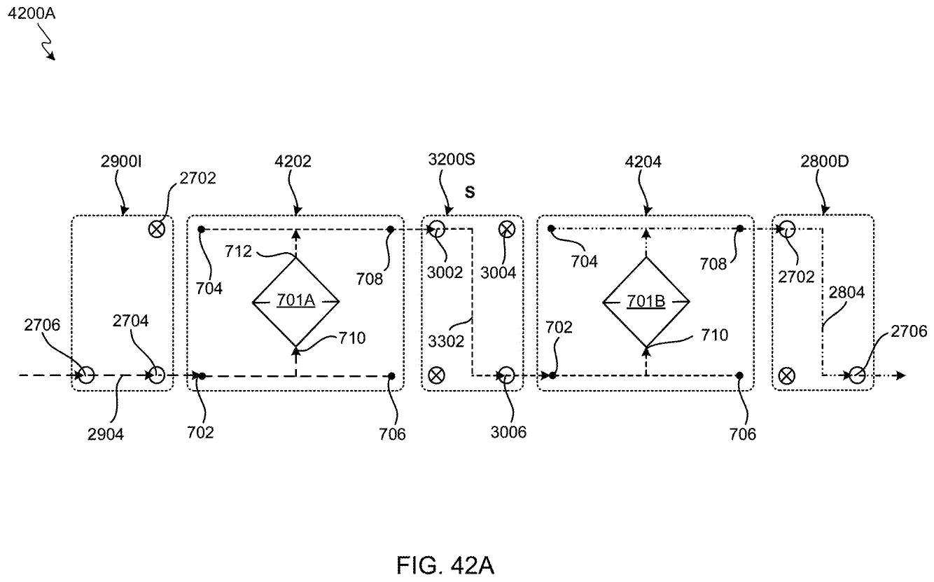

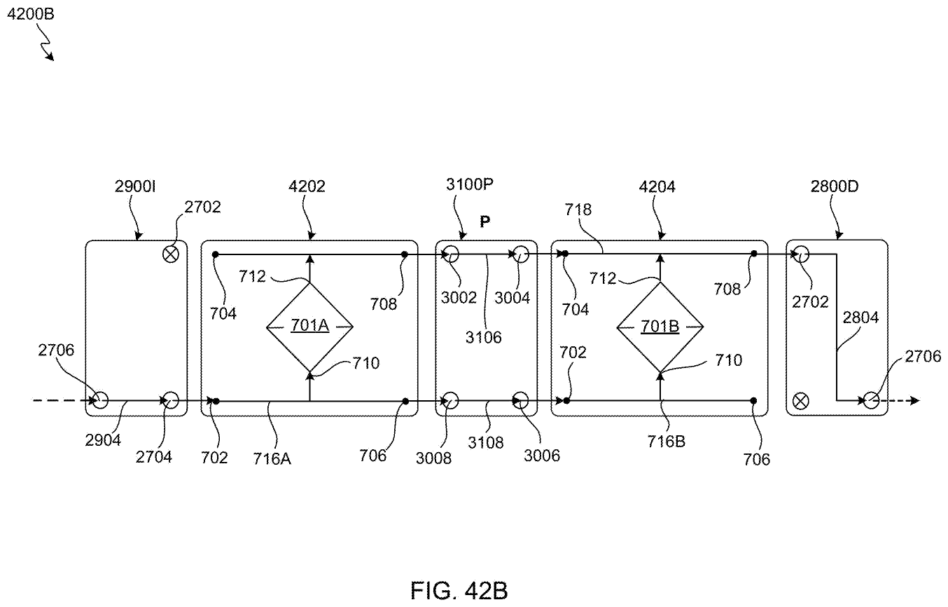

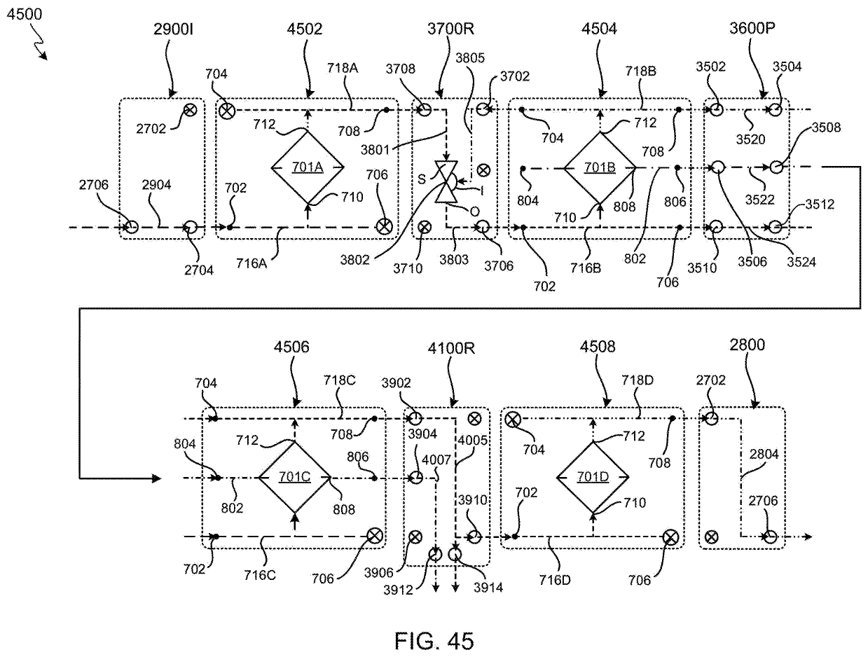

FIG. 28B provides a schematic 2810 of internal fluid pathway or path 2804 within outlet connector 2800, in accordance with at least one embodiment. In the illustrative embodiment, fluid can enter connector 2800 through port 2702, which may be an inlet port. The fluid can then traverse path 2804 and directed to exit through tap port 2706 on the opposite side. Port 2704 is capped or blocked in this configuration. In at least one embodiment, this configuration is advantageous for creating a dedicated terminal outlet connector. For example, product water from last manifold in a filtration train can enter through port 2702 and be directed out of the system through port 2706 to an external plumbing (See connector 2800D of FIGS. 42A, 42B, 43, and 44; and connector 2800 of FIG. 45), while port 2704 remains sealed.

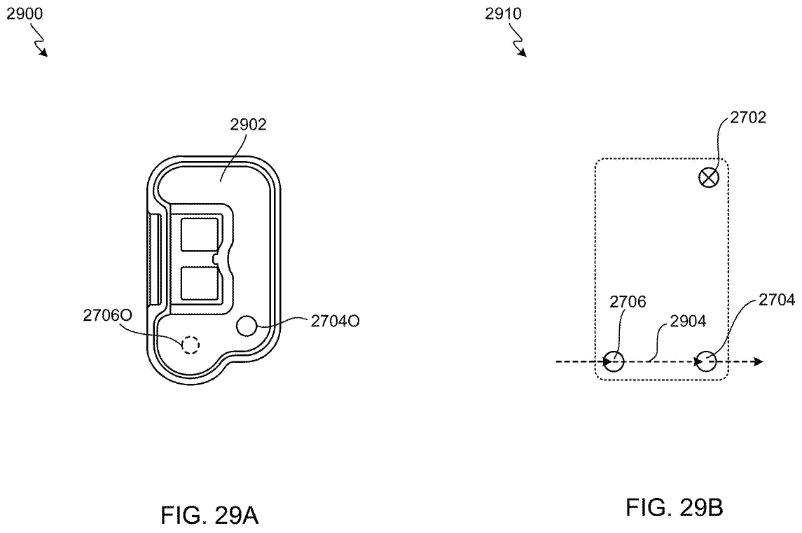

FIG. 29A illustrates a front cross section, through backplate 2708 (FIG. 27A), of an internal fluid path configuration for an intake connector 2900, in accordance with at least one embodiment. In at least one embodiment, intake connector 2900 shares the external properties of tap connector 2700 (FIG. 27A), including the arrangement of ports 2702 and 2704, and tap port 2706. This embodiment illustrates a configuration where the fluid region 2902 is arranged differently from region 2802 (FIG. 28A). In this configuration, fluid region 2902 exclusively encompasses port opening 2704O on the back side and tap opening 2706O on an alternative side. The boundary of fluid region 2902 effectively isolates and blocks port opening 2702O (not shown), rendering it inactive.

FIG. 29B provides a schematic 2910 of the resulting fluid flow through the specific path 2904 of intake connector 2900 in FIG. 29A. In the illustrative embodiment, fluid from an external source enters intake connector 2900 through the tap port 2706. The fluid then traverses the path 2904 and is directed to a connected manifold through port 2704. Port 2702 is unused in path 2904. In at least one embodiment, this configuration is advantageous for creating a dedicated system inlet. It allows a main fluid supply to be connected to tap port 2706, which then feeds the fluid into a manifold via port 2704 to begin a filtration process.

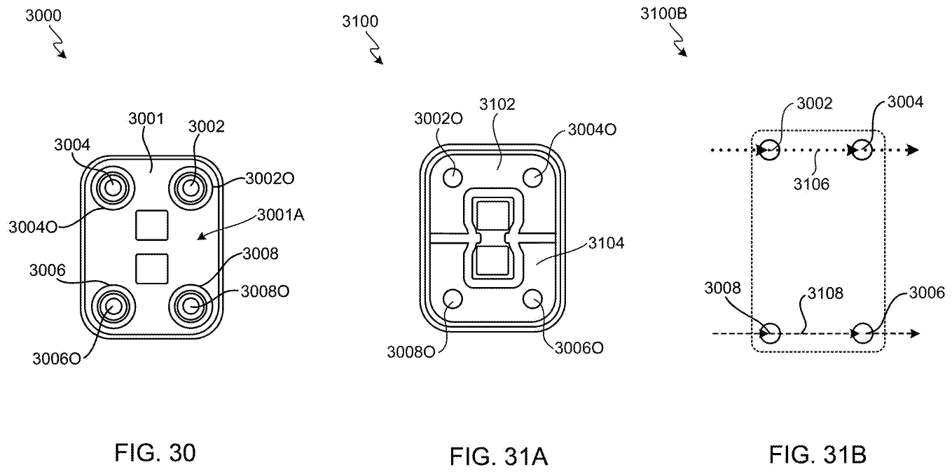

FIG. 30 is a back view of a connector 3000, in accordance with at least one embodiment. In at least one embodiment, connector 3000 comprises a main body or backplate 3001, which includes a surface 3001A. In at least one embodiment, four ports protrude from surface 3001A: a port 3002, a port 3004, a port 3006, and a port 3008. Each port includes a respective port opening: 3002′, 3004′, 3006′, and 3008′. In at least one embodiment, these ports share the characteristics of the ports described in FIG. 27A, such as having circular profiles and being configured to interface with corresponding ports on a pair of adjacent manifolds. In at least one embodiment, connector 3000 may be configured to couple with a pair of manifolds arranged side by side, such as manifold 900 (FIG. 9A). Connector 3000 may form a structure for parallel or series connection depending on how fluid pathways are configured inside backplate 3001. In at least one embodiment, while ports 3002, 3004, 3006, and 3008 protrude normal to surface 3001A, in alternative embodiments, they can be oriented in one of the alternate configurations discussed above.

FIG. 31A is a front cross-sectional view of an internal structure 3100 of connector 3000 illustrated in FIG. 30, taken parallel to the plane of surface 3001A. In at least one embodiment, this view reveals two distinct and fluidly isolated internal regions. A fluid region 3102 establishes fluid communication exclusively between port opening 3002O and port opening 3004O. Separately, a region 3104 establishes fluid communication exclusively between port opening 3006O and port opening 3008O. In at least one embodiment, because all ports open into their respective, isolated fluid regions, this internal structure defines connector 3000 as a parallel connector capable of creating two independent lines. In at least one embodiment, a parallel connector configures a downstream manifold, which can be connected to ports 3004 and 3006, in parallel with an upstream manifold, which can be connected to ports 3002 and 3008. In this configuration, both manifolds (upstream and downstream) are exposed to the same inlet fluid and the same outlet fluid.

FIG. 31B is a schematic 3100B of flow paths within an embodiment of connector 3000. Referring collectively to FIGS. 31A and 31B, this schematic illustrates two independent parallel fluid paths designed within internal structure 3100. In at least one embodiment, path 3106 represents fluid communication established by region 3102 between ports 3002 and 3004. In at least one embodiment, a path 3108 represents the separate fluid communication established by region 3104 between ports 3006 and 3008. This schematic illustrates distinct and not interconnected parallel paths, such as path 3106 and path 3108. This can enable connector 3000 to simultaneously manage two separate fluid streams, such as a common feed line and a common filtrate line, which is useful for configuring multiple filtration units in parallel when using a plurality of manifolds, such as manifold 900 (FIG. 9A).

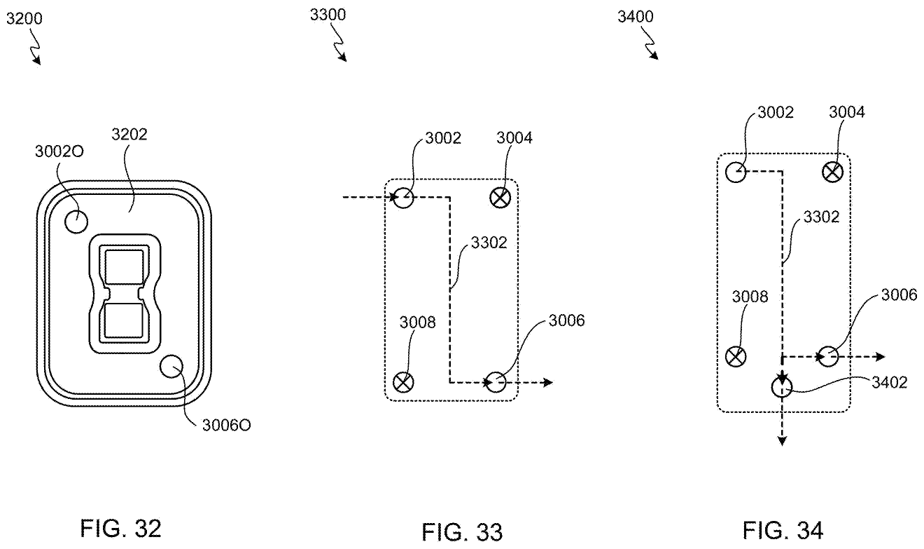

FIG. 32 is a front cross-sectional view of the internal structure of a connector 3200, in accordance with at least one embodiment. Referring collectively to FIGS. 30 and 32, in at least one embodiment, while connector 3200 utilizes the same external four-port physical housing as connector 3000, it contains a distinct internal structure. This internal configuration, specifically designed to establish a series fluid path between adjacent manifolds, is different from the parallel-path in structure 3100 (FIG. 31A). This view is taken parallel to the plane of surface 3001A and illustrates a region 3202. In at least one embodiment, region 3202 represents a single continuous fluid region that establishes fluid communication exclusively between port opening 3002O and port opening 3006O. In at least one such embodiment, port opening 3004O and port opening 3008O are isolated by the internal boundary and are therefore effectively capped or blocked. In at least one embodiment, this internal structure defines connector 3200 as a series connector, designed to route fluid sequentially from a port on one side of an interface to a different port on the other side. In at least one embodiment, a series connector configures a downstream manifold, which can be connected to ports 3004 and 3006, in series with an upstream manifold, which can be connected to ports 3002 and 3008. In at least one such embodiment, a filtrate fluid of the upstream manifold serves as a feed fluid to the downstream manifold.

FIG. 33 is a schematic 3300 of a flow path within connector 3200 in FIG. 32. In at least one embodiment, this schematic illustrates the single, fluid path 3302 created by the internal structure shown in FIG. 32. In at least one embodiment, fluid path 3302 represents the fluid communication established by fluid region 3202, connecting port 3002 to port 3006. In at least one embodiment, schematic 3300 illustrates that ports 3004 and 3008 are not part of this fluid path and are non-functional in this configuration, as indicated by the ‘X’ symbols. In at least one embodiment, this configuration enables connector 3200 to create a specific series connection, for example, by routing the output of a first filter into the input of a second filter, enabling sequential water treatment.

FIG. 34 is a schematic 3400 of a series tap connector, in accordance with at least one embodiment. In at least one embodiment, the series tap connector combines the external four-port configuration of connector 3000 (FIG. 30), the internal series flow logic of connector 3200 (FIG. 32), and further incorporates at least one tap port, similar to the functionality described for connector 2700 (FIG. 27A). In at least one embodiment, ports 3002, 3004, 3006, and 3008 are designed to interface with adjacent manifolds.

In at least one embodiment, schematic 3400 illustrates a single, fluid path 3302. In at least one embodiment, fluid path 3302 represents fluid communication connecting port 3008 to port 3006. In at least one embodiment, schematic 3400 illustrates that ports 3002 and 3004 are not part of the fluid path and are non-functional in this specific configuration, as indicated by the ‘X’ symbols.

In addition to the main series path, the connector includes a tap port, such as tap port 3402. In at least one embodiment, tap port 3402 is fluidly connected to fluid path 3302. In at least one embodiment, this fluid connectivity can enable an intermediate connection to external plumbing for collection, monitoring, draining, or other functional purposes.

In at least one embodiment, schematic 3400 represents a hybrid connector design providing advanced functionality by enabling a specific series connection between two manifolds while simultaneously offering a dedicated point for fluid access. This can be particularly advantageous for applications requiring in-line process monitoring, pressure checks, or the draining of specific stages within a filtration train, without needing a specialized manifold.

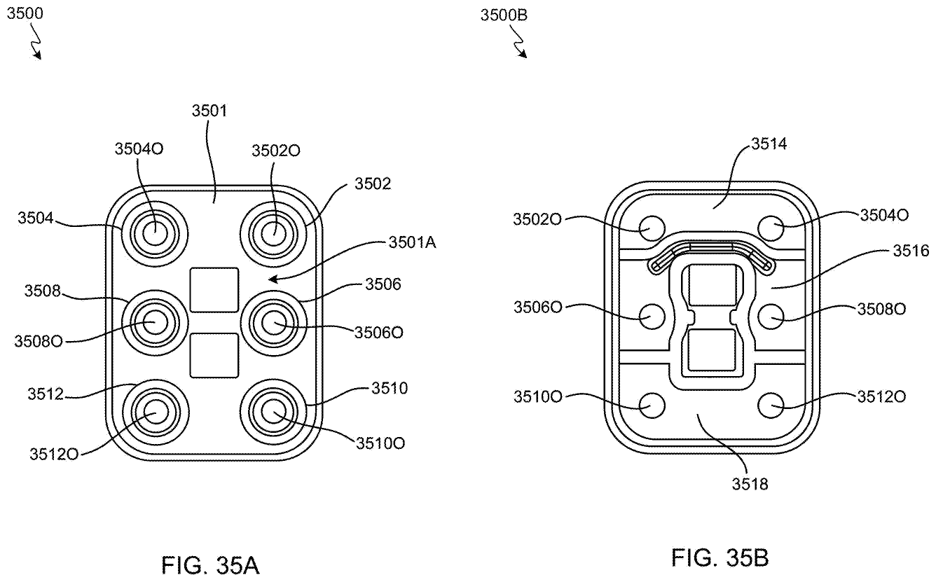

FIG. 35A is a back view of a connector 3500 in accordance with at least one embodiment. In at least one embodiment, connector 3500 comprises a backplate 3501, which includes a surface 3501A and a plurality of ports that protrude from one or more surfaces. In at least one embodiment, six ports protrude from surface 3501A, arranged in two vertical columns of three ports each. The first column and second column are laterally separated to account for lateral separation between collections of ports in adjacent manifolds (FIG. 19A). The first column includes a port 3502, a port 3506, and a port 3510. The second column includes a port 3504, a port 3508, and a port 3512. Each port includes a respective port opening: 3502O, 3504O, 3506O, 3508O, 3510O, and 3512O. In at least one embodiment, this six-port configuration is designed to interface with corresponding six-port manifolds, such as RO manifold 1400 described in FIG. 14. In at least one embodiment, ports 3502, 3504, 3506, 3508, 3510, and 3512 have one or more properties of port 2702 (FIGS. 27A and 27B). In at least one embodiment, ports 3502, 3504, 3506, 3508, 3510, and 3512 may be angled to accommodate angled manifold ports as described in FIGS. 16A and 16B.

FIG. 35B is a front cross-sectional view of internal structure 3500B of connector 3500 in FIG. 35A, taken parallel to the plane of surface 3501A. In at least one embodiment, this view reveals three distinct and fluidly isolated internal regions. A region 3514 establishes fluid communication exclusively between port opening 3502O and port opening 3504O. In at least one embodiment, region 3514 extends along a top-section of internal structure 3500B. In at least one embodiment, connector 3500 further includes a region 3516, which establishes fluid communication exclusively between port opening 3506O and port opening 3508O. In at least one embodiment, region 3516 extends along a mid-section of internal structure 3500B. In at least one embodiment, connector 3500 also includes a region 3518 that establishes fluid communication exclusively between port opening 3510O and port opening 3512O. In at least one embodiment, region 3518 extends along a lower section of internal structure 3500B. In at least one embodiment, because all ports open into one of three respective, isolated regions, this internal structure defines connector 3500 as a parallel connector capable of creating three independent lines.

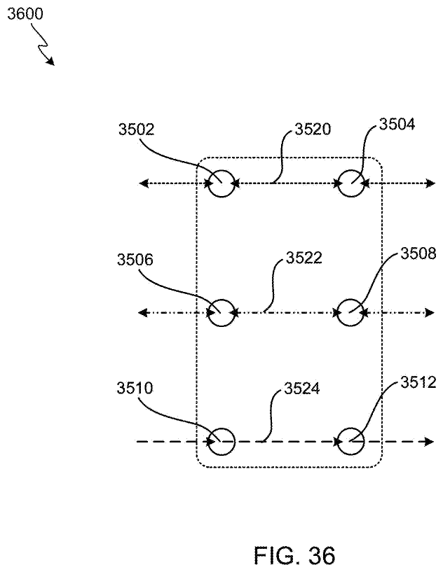

FIG. 36 is a schematic 3600 of flow paths within connector 3500. In at least one embodiment, schematic 3600 illustrates three independent parallel fluid paths created by internal structure 3500B shown in FIG. 35B. A parallel path 3520, corresponding to region 3514, connects the top pair of ports, or port 3502 and port 3504. A parallel path 3522, corresponding to region 3516, connects the middle pair of ports, or port 3506 and port 3508. A parallel path 3524, corresponding to region 3518, connects the bottom pair of ports, or port 3510 and port 3512. As shown by the bi-directional arrows along path 3522, flow can be in either direction. In at least one embodiment, schematic 3600 visually confirms that the three paths are not interconnected, allowing connector 3500 to simultaneously manage three separate fluid streams. This is particularly advantageous for creating parallel configurations with multi-bypass manifolds, such as connecting the feed, filtrate, and reject streams of adjacent RO units.

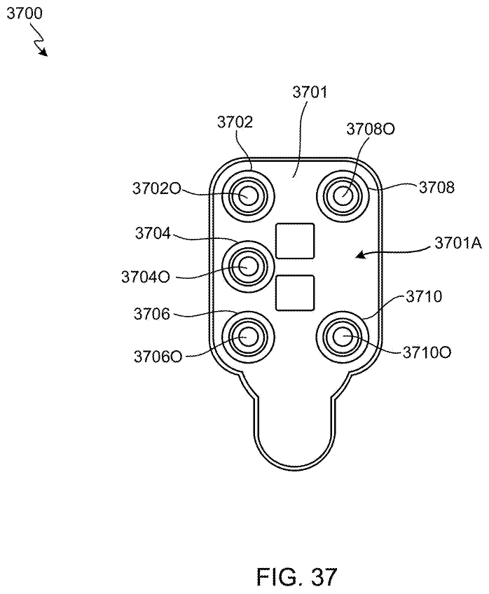

FIG. 37 is a back view of a connector 3700, in accordance with at least one embodiment. In at least one embodiment, connector 3700 is designed to provide a transition from a pre-RO filtration section to an RO section within a filtration train. In at least one embodiment, connector 3700 is an example of an RO PRE inlet connector.

In at least one embodiment, connector 3700 comprises a main body or backplate 3701, which includes a surface 3701A and a plurality of ports that protrude from one or more surfaces. In at least one embodiment, five ports protrude from surface 3701A. In at least one embodiment, the five ports are laid out in an asymmetric pattern. A first column includes a port 3702, a port 3704, and a port 3706. An opposite, second column includes a port 3708 and a port 3710. The first column and second column are laterally separated to account for lateral separation between collections of ports in adjacent manifolds (FIG. 19A). Each port includes a respective port opening: 3702O, 3704O, 3706O, 3708O, and 3710O.

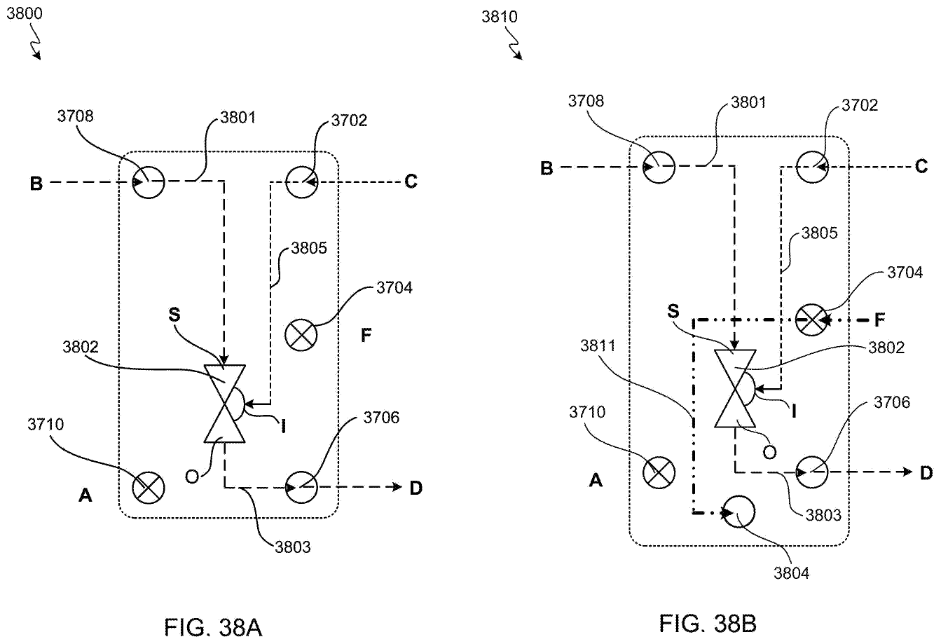

FIG. 38A is a schematic 3800 of fluid logic within RO PRE inlet connector or connector 3700. In at least one embodiment, this schematic illustrates the integration of an Automatic Shutoff Valve (ASOV) 3802. Annotations A, B, C, D, and F indicate the corresponding fluid streams from adjacent manifolds that interface with these ports. In at least one embodiment, the connector represented by schematic 3800 may be implemented to control the flow of feed fluid to a subsequent RO manifold, such as manifold 1200, or a block of parallel RO manifolds. In at least one embodiment, this flow control can be implemented as a function of fluid pressure of filtrate produced by subsequent RO manifolds. In at least one embodiment, the main flow path for fluid to be treated begins at a first source B. This feed fluid enters connector 3700 via port 3708, and is directed along path 3801 to the inlet of ASOV 3802. When ASOV 3802 is open, the feed fluid passes through the valve, is directed along path 3803, and exits the connector via port 3706 to supply subsequent filters.

In at least one embodiment, the operation of ASOV 3802 is controlled by a pressure differential between the pressure of feed water entering RO PRE connector and the pressure of product water produced by RO components downstream from connector 3700. In at least one embodiment, a separate control stream from a second source C, which comprises purified RO water (permeate) from the system's output (e.g., a storage tank or a second filter), can enter connector 3700 via port 3702. Port 3702 is in fluid communication with control port I of the ASOV through pilot channel 3805. The permeate is directed along pilot channel 3805 to control port I of the ASOV's internal diaphragm. When the pressure differential between the feed and product is reduced to a predetermined threshold level, the ASOV 3802 switches to a closed state. In at least one embodiment, this shuts off the flow of feed fluid from source B to port 3706. This action stops the RO system from producing more water, thereby preventing continuous water flow to a drain and conserving water. In at least one embodiment, ASOV will switch to a closed state before a magnitude of differential is zero. The threshold may be controlled by the geometry of the valve. In this specific configuration, ports 3704 and 3710 are unused.

FIG. 38B is a schematic 3810 representative of a hybrid RO PRE inlet connector, in accordance with at least one embodiment. In at least one embodiment, the primary ASOV circuit operates similarly to the one described in FIG. 38A. In at least one embodiment, the connector represented by schematic 3810 integrates the functionality of an Automatic Shutoff Valve (ASOV) 3802 with a separate, independent bypass fluid path 3811 within a single component.

In at least one embodiment, a fluid from a source F enters port 3704. This fluid completely bypasses ASOV 3802 and is directed straight to a tap port 3804, where it exits the represented connector. This creates a dedicated drain or bypass fluid path 3811 that is fluidly isolated from the main ASOV-controlled feed line.

This hybrid design is advantageous as it integrates two distinct functions into a single component. It provides the critical water-saving ASOV functionality for the RO system while simultaneously offering a dedicated drain tap port for the RO reject stream. In this specific configuration, port 3710 remains unused.

FIG. 39A is a back view of a connector 3900, in accordance with at least one embodiment. In at least one embodiment, connector 3900 comprises features of connector 3700 described in association with FIG. 37. In at least one embodiment, connector 3900 comprises a main body or backplate 3901, which includes a surface 3901A and an asymmetric five-port layout on surface 3901A. In at least one embodiment, five ports protrude from surface 3901A. A first column includes a port 3902, a port 3904, and a port 3906. An opposite, second column includes a port 3908 and a port 3910. Each port includes a respective port opening: 3902O, 3904O, 3906O, 3908O, and 3910O. In at least one embodiment, connector 3900 is distinguished from connector 3700 by the inclusion of two additional tap ports indicated by dashed circles 3909.

FIG. 39B is a front view of connector 3900, illustrating its external connection interface. Here, the front view is referred to as a view from a front side of connector 3900 in FIG. 39A, and is shown with biasing agent 2204. In at least one embodiment, connector 3900 includes two external ports on its front face: a port 3912 and a port 3914 that protrude from surface 3901B. In the illustrative embodiment, port 3912 is positioned below port 3914. In at least one embodiment, port 3912 has a smaller diameter compared to the diameter of port 3914. In an alternative embodiment, ports 3910 and 3912 can be placed facing a different side, such as the top, bottom, or a left or right side.

In operation, ports 3912 and 3914 may be examples of external facing ports and provide connection points for external fluid lines. In at least one embodiment, ports 3912 and 3914 are in fluid communication with a corresponding selective subset of ports 3902, 3904, 3906, 3908, 3910 on surface 3901A via internal passages within the main body of the connector 3900. This configuration allows the connector 3900 to function as an interface or adapter, transferring specific fluids between external sources (e.g., a tank or pump) and a manifold. For example, port 3914 can serve as an RO product outlet/inlet to and from an external RO expansion tank, while port 3912 can serve as a RO reject drain port.

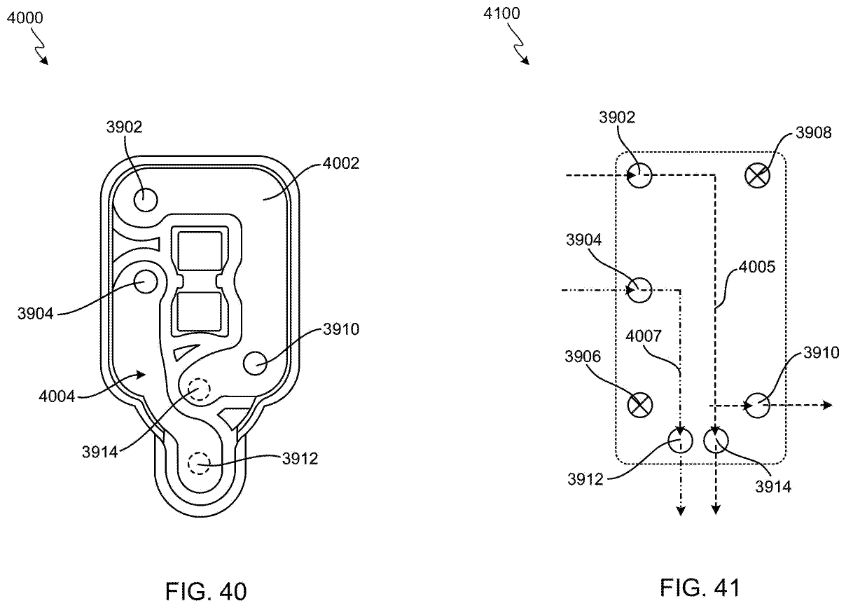

FIG. 40 is a front cross-sectional view of the internal structure 4000 of connector 3900 illustrated in FIGS. 39A and 39B, taken parallel to the plane of surface 3901A, in accordance with at least one embodiment. In at least one embodiment, this cross-sectional view reveals internal fluid regions. The view shows a region 4002 and a region 4004. In at least one embodiment, region 4002 establishes a U-shaped fluid path that provides fluid communication between ports 3902, 3910, and 3914. In at least one embodiment, region 4004 establishes a separate, isolated fluid path that connects port 3904 to port 3912. In at least one embodiment, these regions define internal paths and form the physical basis for fluid logic schematically illustrated in FIG. 41.

FIG. 41 is a schematic 4100 of fluid logic within connector 3900 (FIGS. 39A and 39B), which serves as an RO POST (Reverse Osmosis Post-stage) outlet connector. In at least one embodiment, the connector represented by schematic 4100 may be implemented to manage fluid flow in the post-RO section of a water filtration system, providing the transition from the section that includes an RO membrane and containing external connections for both the RO reject and the purified water storage tank.

Referring collectively to FIGS. 39A-39B, 40, and 41, schematic 4100 illustrates the implementation of connector 3900 with the internal fluid routing shown in FIG. 40. In at least one embodiment, a first fluid stream, such as RO reject water, enters the connector via port 3904. The fluid travels along path 4007 and exits the connector via port 3912, which serves as the RO Reject Port for connection to drain plumbing.

In at least one embodiment, a second fluid stream, such as purified RO water (permeate), enters connector 3900 through port 3902. This stream passes along path 4005 and is configured to exit ports 3910 and 3914. In at least one embodiment, port 3914 can serve as an RO Tank Port for connection to an external storage tank.

In at least one embodiment, schematic 4100 also indicates that several ports are inactive in this specific configuration, as denoted by the ‘X’ symbols. Although fluid is not flowing through these ports, they include plugs and sealing features that seal corresponding ports on adjacent manifolds. These sealing features are essential components in the functionality of a filtration train system. In the illustrative embodiment, ports 3906 and 3908 are inactive and sealed.

The descriptions provided above are examples, and the scope of connectors and manifolds described includes all possible combinations of the concepts introduced. We can also list some additional potential functionality that can be unleashed under this general scope without providing specific details. As discussed above, the configuration illustrated by schematic 4100 can allow connector 3900 to function as an interface or adapter, transferring specific fluids between external sources (e.g., a tank or pump) and a manifold. Other examples of functionality include operation as a manifold bypass connector, maintenance connector, chemical dosing connector (disinfection and other treatment), powered connector (UV, sensors), other sensor connectors, and leak detection connector.

FIG. 42A illustrates a schematic of a series filtration train 4200A, in accordance with at least one embodiment. In at least one embodiment, series filtration train 4200A may be an example of a two-stage series filtration train. In at least one embodiment, series filtration train 4200A includes a dedicated inlet and outlet, and is assembled using specialized connectors and manifolds described above. In at least one embodiment, series filtration train 4200A includes the following components: an intake connector 2900I, a manifold 4202, a series connector 3200S, a manifold 4204, and an outlet connector 2800D. In at least one embodiment, manifold 4202 and manifold 4204 are identical or substantially identical and include one or more features of manifold 900 (FIG. 9A).

In at least one embodiment, a series filtration train 4200A may be used to treat fluid. In at least one embodiment, as illustrated, a treatment process begins at an intake connector 2900I. Fluid to be treated enters intake connector 2900I through its tap port 2706. The fluid then traverses the connector's path 2904 and exits through port 2704 to supply manifold 4202. The fluid enters manifold 4202 at port 702 and is directed to the input of a filter 701A at port 710. After passing through filter 701A, the once-treated fluid exits filter 701A at port 712 and then manifold 4202 through port 708.

The once-treated fluid from port 708 then enters a series connector 3200S at port 3002. Inside the series connector, the fluid traverses the single series path or path 3302 and exits at port 3006. This port 3006 is coupled to port 702 of manifold 4204, thereby delivering the fluid to a port 710 of a filter 701B for sequential treatment. After passing through filter 701B, the twice-treated fluid exits manifold 4204 at port 708.

Finally, the twice-treated fluid from port 708 enters outlet connector 2800D at port 2702. Inside the outlet connector, the fluid traverses the path 2804 and is directed to exit the system through the tap port 2706. In at least one embodiment, unused ports 704 and 706 of manifold 4202, and manifold 4204, respectively, are effectively capped or isolated by specific internal structures of intake connector 2900I, series connector 3200S, and outlet connector 2800D.

FIG. 42B illustrates a schematic of a parallel filtration train 4200B, in accordance with at least one embodiment. In at least one embodiment, parallel filtration train 4200B may be an example of a single-stage parallel filtration train. In at least one embodiment, parallel filtration train 4200B includes a dedicated inlet and outlet for a combined output from respective filters and may be assembled using specialized connectors and manifolds described above. In at least one embodiment, parallel filtration train 4200B includes the following components: an intake connector 2900I, a manifold 4202, a parallel connector 3100P, a manifold 4204, and an outlet connector 2800D. In at least one embodiment, manifold 4202 and manifold 4204 are identical or substantially identical and include one or more features of manifold 900 (FIG. 9A). In at least one embodiment, parallel connector 3100P comprises features described by schematic 3100B (FIG. 31B).

In at least one embodiment, a parallel filtration train 4200B may be used to treat fluid. In at least one embodiment, as illustrated, the process begins at an intake connector 2900I. Fluid which is to be treated enters intake connector 2900I through tap port 2706. The fluid then traverses the connector's internal path or path 2904 and exits through port 2704 to supply manifold 4202. The fluid enters the manifold 4202 at port 702 and is directed to port 710 of a filter 701A. After passing through filter 701A, the once-treated fluid exits filter 701A at port 712 and ultimately manifold 4202 at port 708.

The once-treated fluid from port 708 then enters a parallel connector 3100P at port 3002. Inside the parallel connector 3100P, the fluid traverses path 3106 and exits at port 3004. In at least one embodiment, port 3004 is coupled to port 704 of manifold 4204, where the once-treated fluid continues along the upper bypass path or path 718 of manifold 4204, where it combines with treated fluid from filter 701B (described below). The combined flow exits manifold 4204 at port 708.

In at least one embodiment, within manifold 4202, fluid to be treated also continues along fluid pathway 716A, exits through port 706, and enters connector 3100P through its port 3008. This fluid exits through port 3006 of connector 3100P and continues along fluid pathway 716B and is delivered to port 710 of filter 701B within manifold 4204 to be treated. A portion of this feed fluid continues and terminates at port 706.

After passing through filter 701B, the treated fluid exits the filter at port 712 and merges with once-treated fluid that entered manifold 4204 through port 704, along the upper bypass path or path 718. This combined fluid traverses fluid pathway 718 and enters outlet connector 2800D at port 2702. Inside outlet connector 2800D, the fluid traverses path 2804 and is directed to exit the system through tap port 2706.

In at least one embodiment, the unused ports on the manifolds and connectors (e.g., port 704 in manifold 4202, port 706 of manifold 4204) are effectively capped or isolated by specific internal structures of the chosen connectors.

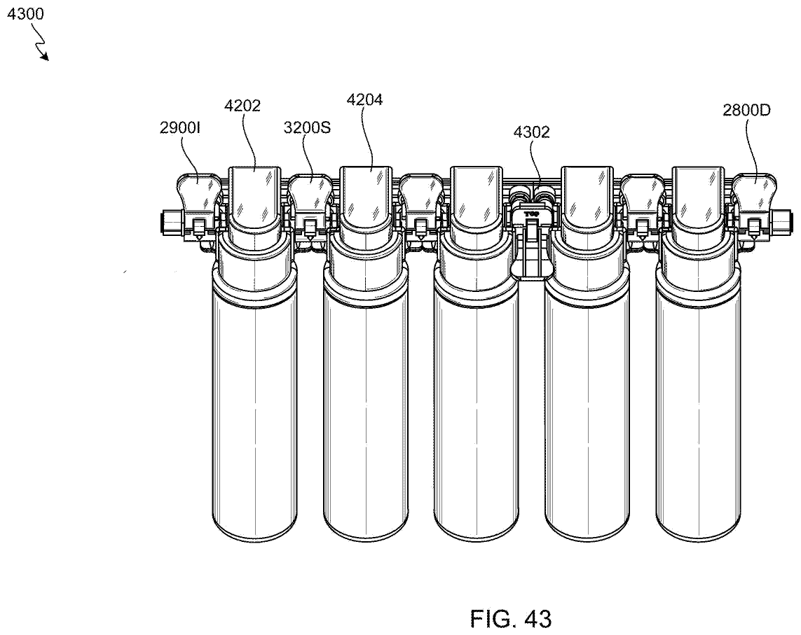

FIG. 43 illustrates an isometric illustration of a filtration train 4300 comprising one or more features of filtration train 1900 in FIG. 19A, manifolds 4202, 4204, etc., described in FIGS. 42A and 42B. In at least one embodiment, filtration train 4300 also comprises connector 2900I, and connector 2800D at terminal ends of filtration train 4300. In at least one embodiment, filtration train 4300 comprises one or more features described by 4200A or 4200B. In the illustrative embodiment, connector 4302 is positioned within a region in front of two adjacent port collections, but not inserted.

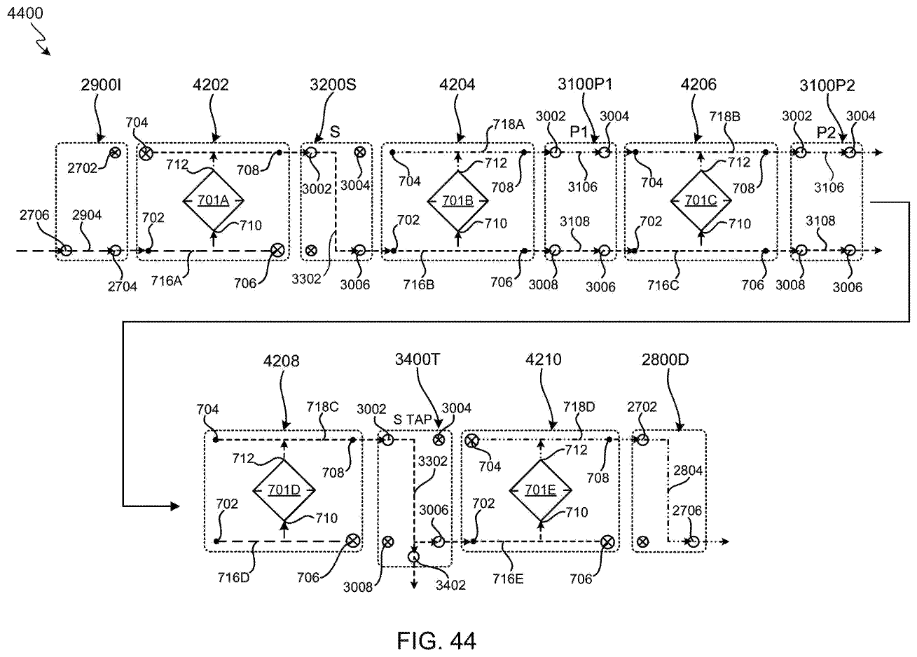

FIG. 44 illustrates a schematic of a complex fluid treatment process, in accordance with at least one embodiment. In an embodiment, this process demonstrates a five-stage, mixed-mode filtration train 4400 assembled using a combination of specialized connectors and manifolds. In at least one embodiment, the schematic for mixed-mode filtration train 4400 represents the following components: an intake connector 2900I, a manifold 4202, a series connector 3200S, a manifold 4204, a parallel connector 3100P1, a manifold 4206, a parallel connector 3100P2, a manifold 4208, a series tap connector 3400T, a manifold 4210, and an outlet connector 2800D. In at least one embodiment, manifolds 4202, 4204, 4206, 4208, and 4210 are identical or substantially identical and include one or more features of a non-RO manifold such as manifold 900 (FIG. 9A). In at least one embodiment, series connector 3200S includes features described in association with FIGS. 32 and 33. In at least one embodiment, parallel connectors 3100P1 and 3100P2 include features described by schematic 3100B (FIG. 31B). In at least one embodiment, a series tap connector 3400T comprises features of a tap connector described by schematic 3400 (FIG. 34).

In an embodiment, the filtration process begins at an intake connector such as connector 2900I. In an embodiment, fluid enters connector 2900I through port 2706, travels along path 2904, and exits through port 2704 to supply manifold 4202. In an embodiment, fluid enters manifold 4202 at port 702, is directed to port 710 of filter 701A along path 716A. In at least one embodiment, once-treated fluid exits filter 701A from port 712 and manifold 4202 from port 708.

In an embodiment, this once-treated fluid enters series connector 3200S via port 3002. In an embodiment, the once-treated fluid traverses path 3302 and exits connector 3200S through port 3006. In an embodiment, port 3006 supplies manifold 4204 at its port 702, and filter 701B at port 710 via path 716B. In an embodiment, after treatment by filter 701B, a twice-treated fluid traverses along path 718A and exits manifold 4204 at port 708. In an embodiment, the twice-treated fluid then enters parallel connector 3100P1 at port 3002. In an embodiment, the twice-treated fluid travels along path 3106 and exits through port 3004, which is coupled to port 704 of manifold 4206. In an embodiment, this action directs fluid into the filtrate bypass line or path 718B.

In an embodiment, simultaneously, a portion of the once-treated fluid stream traversing the lower bypass line or path 716B (within manifold 4204) enters parallel connector 3100P1 at port 3008. In at least one embodiment, the once-treated fluid stream traverses path 3108 within parallel connector 3100P1 and exits through port 3006. Port 3006 is coupled with port 702 of the adjacent manifold 4206, which in turn directs the fluid to the input (port 710) of filter 701C. After passing through filter 701C, the fluid becomes twice-treated and exits the filter via port 712. This twice-treated fluid merges with the already present twice-treated fluid within path 718B, having arrived through port 704 of manifold 4206. The combined twice-treated flow exits manifold 4206 via port 708, passes through pathway 3106 of connector 3100P2, and enters manifold 4208 from port 704.

In an embodiment, fluid treatment through schematic 4400 continues with manifold 4208, where once-treated fluid traversing along path 716C and path 3106 of 3100P2 is treated by filter 701D. After passing through filter 701D, the fluid becomes twice-treated and exits the filter via the filter's port 712 into path 718C. In path 718C, this twice-treated fluid from filter 701D merges with already present twice-treated fluid from filters 701B and 701C. In an embodiment, the combined fluid exits at port 708 of manifold 4208 and enters series tap connector 3400T from port 3002. In an embodiment, the combined twice-treated fluid flows along path 3302, exits through port 3006, and enters through port 702 to supply manifold 4210 for final treatment by filter 701E through path 716E. The fully treated liquid exits filter 701E through port 712 and exits manifold 4210 through port 708. The fully treated fluid or product fluid enters outlet connector 2800D through port 2704. Inside outlet connector 2800D, the product fluid traverses path 2804 and exits the system through port 2706 of connector 2800D.

In an embodiment, series tap connector 3400T also includes an external tap port 3402 connected via path 3302 for intermediate fluid access to the twice-treated fluid. In at least one embodiment, the product fluid from outlet connector 2800D is fully treated, while the fluid from the series tap connector 3400T is partially treated. This configuration can be useful in applications where different levels of filtration are required for different uses. For example, the partially treated fluid from the series tap connector 3400T may be used by a dishwasher, while the fully treated product fluid from outlet connector 2800D may be used for consumption purposes. Alternatively, the external port of the series tap connector 3400T may be connected to an external expansion storage tank.

FIG. 45 illustrates a schematic of a combined Non-RO and RO filtration train 4500, in accordance with at least one embodiment. In an embodiment, this process demonstrates how different specialized manifold modules and connectors can be assembled to create a complete water treatment system with pre-filtration, reverse osmosis, and post-filtration stages. While a total of four manifolds are illustrated, the filtration train can include many more.

In an embodiment, this process demonstrates a multi-stage combined filtration train 4500 assembled using a combination of specialized connectors and manifolds. In at least one embodiment, the schematic for multi-stage combined filtration train 4500 represents the following components, as represented by their schematics: an intake connector 2900I, a manifold 4502, connector 3700R, a manifold 4504, a RO parallel connector 3600P, a manifold 4506, connector 4100R, a manifold 4508, and an outlet connector 2800D. In at least one embodiment, manifolds 4502 and 4508 are identical or substantially identical and include one or more features of a non-RO manifold such as manifold 900 (FIG. 9A). In at least one embodiment, manifolds 4504 and 4506 are identical or substantially identical and include one or more features of a RO manifold such as manifold 1200 (FIG. 12A). In at least one embodiment, connector 3700R includes features of a RO PRE inlet connector as described in FIGS. 37 and 38A. In at least one embodiment, RO parallel connector 3600P comprises features of a RO parallel connector described in FIGS. 35A, 35B, and 36. In at least one embodiment, connector 4100R comprises features of a RO POST (Reverse Osmosis Post-stage) connector described in FIGS. 39A, 39B, 40, and 41.

In an embodiment, the filtration process begins at an intake connector such as intake connector 2900I. In an embodiment, fluid enters intake connector 2900I through port 2706, travels along path 2904, and exits through port 2704 to supply manifold 4502.

In an embodiment, NR Module 1 is a prefilter stage, comprising manifold 4502 and filter 701A. In an embodiment, NR Module 1 may be configured as a prefilter that reduces sediment and chlorine to protect RO membranes. In an embodiment, the prefilter may also reduce multiple additional contaminants. In an embodiment, while shown as a single filter, many systems may use more than one prefilter. In an embodiment, fluid enters manifold 4502 at port 702 and is directed along the lower bypass path or path 716A to an input (port 710) of filter 701A. In an embodiment, pre-filtered fluid exits filter 701A from its outlet (port 712) and is directed along the upper bypass path or path 718A to exit manifold 4502 through port 708.

In an embodiment, fluid enters an RO PRE or RO inlet connector, such as connector 3700R, at port 3708. In an embodiment, connector 3700R provides a transition from the pre-RO section to the RO module. In an embodiment, connector 3700R includes an Automatic Shutoff Valve (ASOV) 3802. In an embodiment, fluid travels along path 3801 to an inlet of ASOV 3802, and upon exiting ASOV 3802, flows along path 3803 to exit connector 3700R at port 3706. In an embodiment, a single RO PRE connector can support multiple RO modules connected in parallel.

In an embodiment, RO Modules 1 & 2 are RO modules in parallel. In an embodiment, the RO section can include any number of modules connected in parallel. In an embodiment, each additional parallel module reduces overall pressure losses, increasing the system flow rate. In an embodiment, fluid from RO PRE connector 3700R enters RO Module 1, which comprises manifold 4504 and filter 701B. In an embodiment, fluid enters manifold 4504 via port 702 and is directed along the lower bypass path or path 716B to an input (port 710) of filter 701B. In an embodiment, purified fluid, or filtrate, exits filter 701B through port 712 and is directed along the upper bypass path or path 718B to exit through port 708.

In at least one embodiment, the operation of ASOV 3802 is controlled by a pressure differential between port S and port I of ASOV 3802. A separate control branch of fluid, which comprises purified RO fluid (permeate) from port 704 of manifold 4504, enters connector 3700R via port 3702. This permeate is directed along pilot channel 3805 to port I on the control side of ASOV 3802. When the pressure differential between ports S and I of ASOV 3802 decreases to a predetermined threshold, ASOV 3802 shuts off the flow of RO supply water between its ports S and O.

In an embodiment, RO parallel connectors connect each subsequent RO module in a parallel configuration relative to the previous module. In an embodiment, parallel connector 3600P connects RO Module 1 to RO Module 2 in parallel and facilitates multiple fluid transfers through a parallel transfer scheme. In an embodiment, filtrate traversing the upper bypass path or path 718B enters parallel connector 3600P at port 3502, traverses path 3520, and exits at port 3504. In an embodiment, reject fluid from filter 701B (manifold 4504) exits through port 806, after entering the manifold from filter 701B through reject port 808. In at least one embodiment, reject fluid enters port 3506, traverses path 3522, and exits at port 3508 and enters port 804, which is an intake for RO reject water in manifold 4506. In an embodiment, a feed stream (pre-filtered fluid) exits manifold 4504 through port 706, enters parallel connector 3600P at port 3510, traverses path 3524, and exits at port 3512.

In an embodiment, these parallel streams (filtrate, feed, and reject streams, for example) supply RO Module 2, which comprises manifold 4506 and filter 701C. In an embodiment, the feed stream from parallel connector 3600P (port 3512) enters manifold 4506 (port 702) and is directed along the lower bypass path or path 716C to an input (port 710) of filter 701C. In an embodiment, after treatment, filtrate exits filter 701C at port 712 and is directed along the upper bypass path or path 718C, where it is combined with the filtrate from RO Module 1. The combined filtrate exits manifold 4506 at port 708. In an embodiment, the reject fluid exits filter 701C at port 808 into bypass line or path 802 between ports 804 and 806 of manifold 4506. In at least one embodiment, reject streams from both RO filters 701B and 701C are combined in path 802.

In an embodiment, the RO POST/RO connector or connector 4100R provides the transition from the RO part of the system to the post-RO part of the system and includes interfaces for connection to an external drain and RO expansion tank. In an embodiment, connector 4100R includes the RO Reject Port or port 3912 for connection to drain plumbing. In an embodiment, connector 4100R includes the RO Tank Port or port 3914 for connection to an external RO storage tank. In an embodiment, multiple fluid streams enter connector 4100R. In an embodiment, the combined reject stream from port 806 of manifold 4506 enters connector 4100R at port 3904, travels along path 4007, and exits via port 3912 to a drain. In at least one such embodiment, port 3912 is an external connector. In at least one embodiment, this reject fluid also includes reject fluid from port 806 of manifold 4504. In an embodiment, purified filtrate from the upper bypass path or path 718C enters connector 4100R at port 3902 and is directed to port 3910 to supply a subsequent post-filter stage. In an embodiment, a portion of this purified water may also be directed along path 4005 to port 3914 for connection to an RO expansion tank.

In an embodiment, NR Module 2 or manifold 4508 is a post-filter. In an embodiment, typical RO systems include one or more post-filters. In an embodiment, filter 701D can be configured to remove phenolic odors from the RO tank. In an embodiment, filter 701D can often be configured to remove multiple additional contaminants. In an embodiment, the post-RO part of the system can include multiple modules, some of which can be configured as remineralization modules. In an embodiment, purified water from connector 4100R enters NR Module 2, a post-filter stage, comprising manifold 4508 and filter 701D. In an embodiment, fluid enters manifold 4508 at port 702 and is directed along the lower bypass path or path 716D to an input (port 710) of filter 701D. In an embodiment, post-treated fluid exits filter 701D at port 712 and is directed along the upper bypass path or path 718D to exit manifold 4508 at port 708.

In an embodiment, outlet connector 2800D connects the system outflow to external treated-water plumbing. In an embodiment, finally, fully-treated water enters the system outlet connector, such as outlet connector 2800D, at port 2702. In an embodiment, fluid traverses path 2804 and exits outlet connector 2800D through port 2706.

In at least one embodiment, a number of ports are capped or blocked by design within the respective connectors. In at least one embodiment, port 2702 in intake connector 2900I and port 704 in manifold 4502 are capped by a capping feature within intake connector 2900I. In at least one embodiment, port 706 in manifold 4502 and port 3710 in connector 3700R are capped by a capping feature within connector 3700R. In at least one embodiment, port 706 in manifold 4506 and port 3906 in connector 4100R are capped by a capping feature within connector 4100R.

In at least one embodiment, the lower bypass path is not limited to feed fluid. Certain segments of the lower bypass path after connector 3700R are paths to transfer once-treated fluid. Similarly, upper bypass fluid paths are not limited to once-treated fluid and, depending on the manifold, can include filtrate that is treated once or more than once.

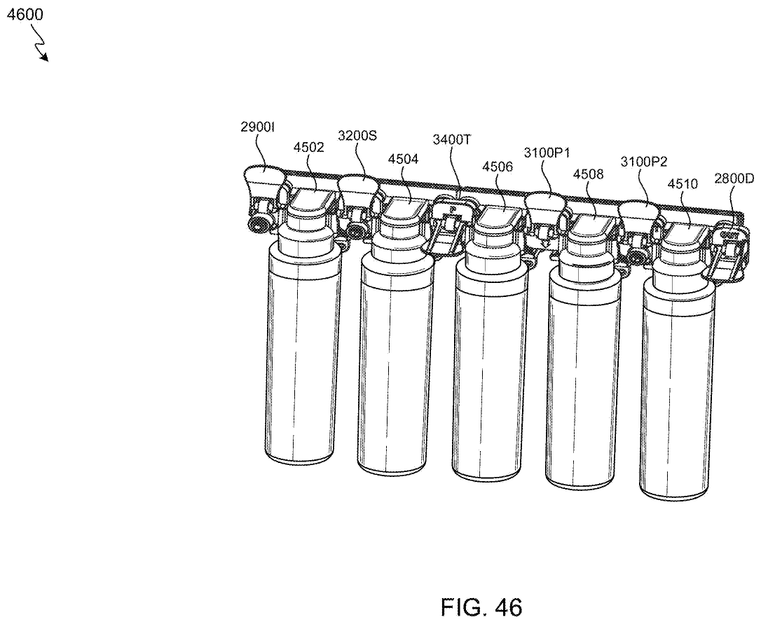

FIG. 46 illustrates an isometric illustration of a filtration train 4600 comprising one or more features of filtration train 2000 in FIG. 20A, manifolds 4502, 4504, 4506, 4508, described in FIGS. 44 and 45. In at least one embodiment, filtration train 4600 comprises an additional manifold 4510. In at least one embodiment, filtration train 4600 also comprises connector 2900I and connector 2800D at the terminal ends of filtration train 4600. In at least one embodiment, other connectors featured in filtration train 4600 include series connector 3200S, parallel connector 3100P1, parallel connector 3100P2, and series tap connector 3400T. In at least one embodiment, filtration train 4600 comprises one or more features described by schematic 4500. In the illustrative embodiment, series tap connectors 3400T and 2800D are positioned with a region in front of two adjacent port collections but not inserted.

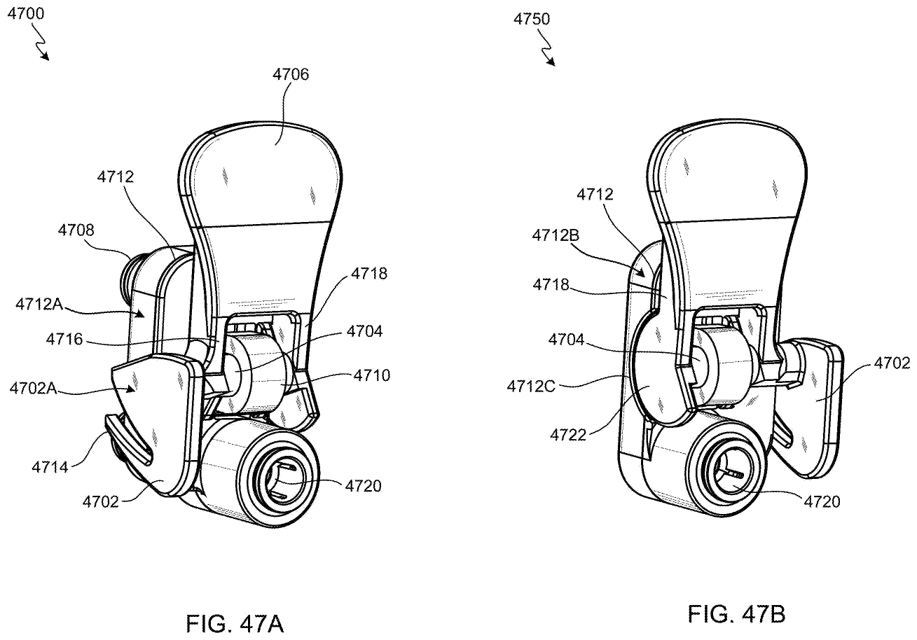

FIG. 47A illustrates an alternative embodiment of a connector 4700, in accordance with at least one embodiment. Connector 4700 is designed to fluidly and mechanically couple with one or more ports of a single manifold and includes an actuation mechanism. In at least one embodiment, connector 4700 may be an example of a terminal connector, such as an intake or outlet connector for a filtration train.

A component of the actuation mechanism within connector 4700 is cam 4702, which is configured to engage/disengage connector 4700 from a manifold. Connector 4700 further comprises an axle 4704 attached to cam 4702, and a lever 4706 attached to axle 4704. In at least one embodiment, lever 4706 serves as a biasing agent, where movement of lever 4706 rotates cam 4702 about axle 4704 and exerts a force that biases a port 4708 on connector 4700. In at least one embodiment, connector 4700 also includes an axle housing 4710 that is configured to rotatably receive axle 4704, providing a pivot point for the actuation mechanism. In at least one embodiment, axle 4704 extends through an opening in axle housing 4710, which is mechanically attached to body 4712 of connector 4700.

In at least one embodiment, a surface 4702A of cam 4702 comprises straight and curved portions designed to act as points of contact when inserted into a manifold bracket. In at least one embodiment, surface 4702A has a normal that is parallel to the axis of axle 4704. As shown, cam 4702 is attached to an end portion of axle 4704. In at least one such embodiment, cam 4702 extends laterally beyond the sidewall 4712A of body 4712 to enable unimpeded rotation.

In at least one embodiment, cam 4702 further comprises a hook-shaped protrusion or protrusion 4714 extending from its main body. In at least one embodiment, protrusion 4714 includes a curved actuation surface and can be configured as a cantilevered arm extending from a peripheral portion of cam 4702. In at least one embodiment, the cantilevered arm is configured to flex during engagement with a manifold. In at least one embodiment, the cantilevered arm is configured to be elastically deformable to provide a compliant biasing force. In at least one embodiment, the combination of the curved surface and the cantilevered arm allows cam 4702 to provide both installation and removal forces.

In at least one embodiment, lever 4706 comprises a pair of opposing arms, such as arm 4716 and arm 4718, coupled to axle 4704 on opposite sides of axle housing 4710, effectively straddling the main body. In at least one embodiment, axle 4704 extends through arm 4716 of lever 4706 to create the rotational coupling. In at least one embodiment, lever 4706 can have a single arm or an odd number of arms analogous to arms 4716 and 4718. In at least one embodiment, axle housing 4710 can comprise two or more discrete elements. In at least one embodiment, one or more arms can be located between two or more discrete elements of housing 4710. In at least one embodiment, axle housing 4710 can include one or several slots. In at least one embodiment, one or more arms can be located in the one or several slots. In at least one embodiment, connector 4700 may not include lever 4706 but only arms 4716 and 4718. In at least one such embodiment, arms 4716 and 4718 may include a coupling mechanism to connect with a connectable lever or a similar biasing agent. In at least one embodiment, a removable lever can help to prevent accidental opening or unlocking of connector 4700. In at least one embodiment, connector 4700 may not include lever 4706 and arms 4716 and 4718. In at least one such embodiment, axle 4704 may include a coupling interface to connect a connectable lever or an alternative biasing agent. In at least one embodiment, a removable biasing agent can help to prevent accidental opening or unlocking of connector 4700.

In at least one embodiment, connector 4700 further includes a tap port 4720. This tap port provides a fluid access point that is independent of the primary flow paths established when connector 4700 is installed in a manifold.

FIG. 47B illustrates an isometric view of connector 4750 in accordance with at least one embodiment. In at least one embodiment, connector 4750 includes all features of connector 4700 in FIG. 47A but represents a mirrored version. This view shows arm 4718 of lever 4706, which is attached to an opposite end of axle 4704. In at least one embodiment, arm 4718 includes an extension 4722. In at least one embodiment, extension 4722 comprises a semicircular shape. In at least one embodiment, main body 4712 features a corresponding groove 4712C, which can be semicircular, on its sidewall to match the shape of extension 4722. This design can help ensure that extension 4722 is confined within groove 4712C during rotation, providing rotational stability while maintaining a compact lateral profile for the connector.

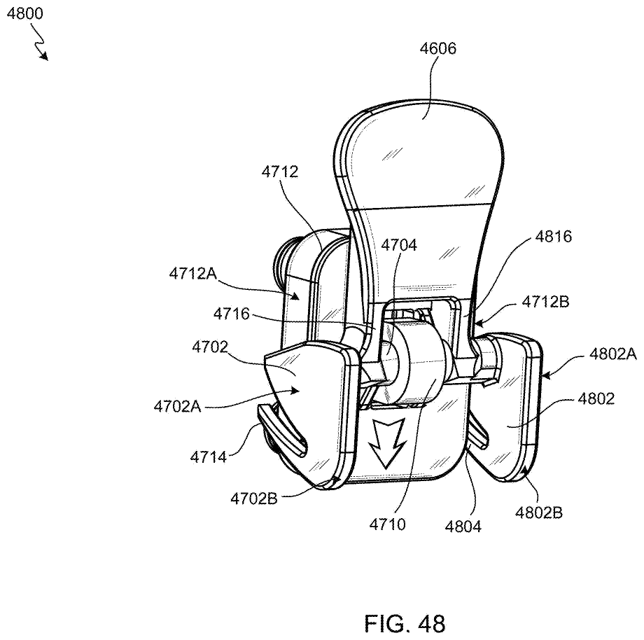

FIG. 48 illustrates an embodiment of a connector 4800, in accordance with at least one embodiment. In at least one embodiment, connector 4800 is designed to fluidly and mechanically bridge two adjacent manifolds in a filtration train. The main body of connector 4800 comprises a plurality of ports, such as at least four ports, configured to align with corresponding port collections on the two adjacent manifolds. In at least one embodiment, connector 4800 includes properties of connector 3000 (FIG. 30). In at least one embodiment, connector 4800 further includes an integrated, symmetric, dual-cam actuation mechanism.

A distinguishing feature of this embodiment is the symmetric arrangement of two cams. In at least one embodiment, cam 4702 is attached to a first end of axle 4704, and a cam 4802 is attached to an opposite, second end of axle 4704. In at least one embodiment, cam 4702 extends laterally beyond a first sidewall 4712A of main body 4712, and cam 4802 extends laterally beyond a second sidewall 4712B of main body 4712. This allows both cams to engage with features on the adjacent manifolds. In at least one embodiment, axle 4704 extends beyond surface 4702A of cam 4702 and beyond sidewall 4802A of cam 4802.

In at least one embodiment, each cam is multi-functional. In at least one embodiment, cam 4702 includes protrusion 4714, and cam 4802 includes a corresponding hook-shaped or protrusion 4804. In at least one embodiment, protrusions 4714 and 4804 are mirror images of each other and protrude in the same direction. These protrusions are configured to establish a mechanical detent to retain the cam assembly in a closed position, and to provide tactile and acoustic feedback during connector installation and removal. Herein, the term “detent” refers to a catch in a machine that prevents motion until released. Additionally, each cam includes an actuation surface that varies in curvature, such as surface 4702B on cam 4702, and surface 4802B on cam 4802. In at least one embodiment, surfaces 4702B and 4802B are designed to exert a pushing force for installation. In at least one embodiment, surfaces 4702B and 4802B are flat or substantially flat. In other embodiments, surfaces 4702B and 4802B can have curvature in the periphery or be gradually curved (C-shaped). In operation, movement of lever 4606 rotates axle 4704, causing both cams 4702 and 4802 to actuate simultaneously. This symmetric, dual-cam arrangement provides a balanced application of force, ensuring a smooth means of engaging and disengaging connector 4800 within the interface gap between two manifolds.

In at least one embodiment, the actuation mechanism comprises lever 4606 that serves as a biasing agent and is rotatably coupled to a main body 4712 of the connector via an axle 4704 received within an axle housing 4710. In at least one embodiment, lever 4606 features a pair of opposing arms, such as arm 4716 and arm 4816, that straddle axle housing 4710. In at least one such embodiment, unlike connector 4700 of FIG. 47A, which features dissimilar arms, arm 4716 and arm 4816 can be identical or substantially identical. In at least one embodiment, arms 4716 and 4816 are symmetrically or substantially symmetrically arranged about axle housing 4710. In an alternative embodiment, arm 4716 can have a different shape or features compared to arm 4816.

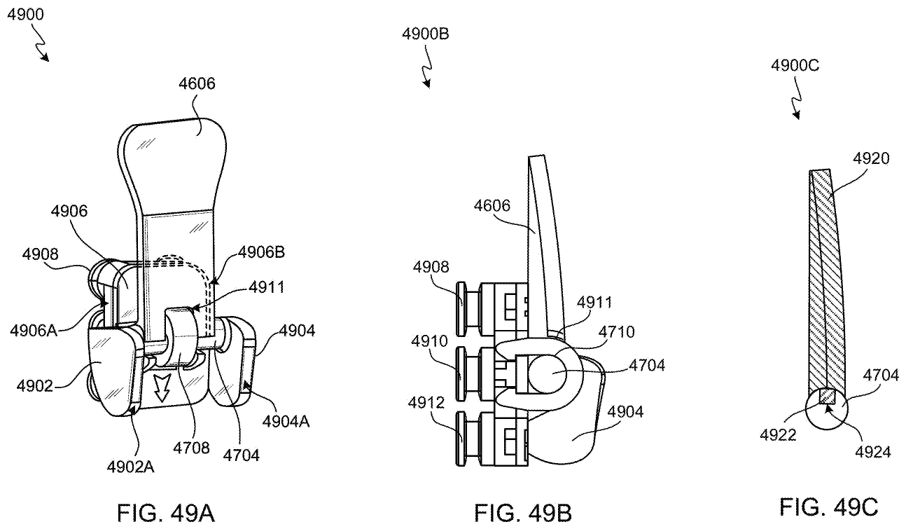

FIG. 49A illustrates an embodiment of a connector 4900, in accordance with at least one embodiment. In at least one embodiment, connector 4900 includes features of connector 3500 described in FIG. 35A. In at least one embodiment, connector 4900 is designed to fluidly and mechanically bridge two adjacent manifolds and features a symmetric, dual-cam actuation mechanism. The actuation mechanism comprises a lever 4606 rotatably coupled to a main body 4906 via an axle 4704. Main body 4906 includes an axle housing 4710 that rotatably receives axle 4704.

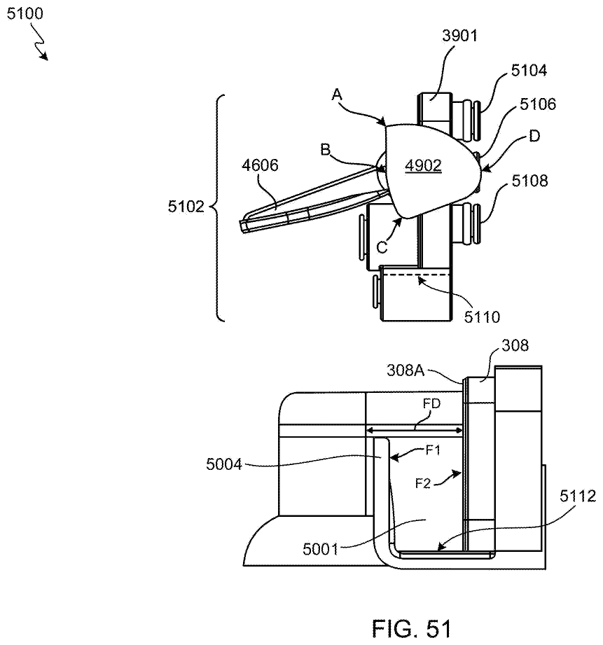

A distinguishing feature of this embodiment is the design of its two cams. In at least one embodiment, cam 4902 is attached to a first end of axle 4704, and a cam 4904 is attached to the opposite, second end. Unlike the previous embodiment, cams 4902 and 4904 are designed as single solid surfaces and do not include hook-shaped protrusions. Each cam includes actuation surfaces, such as surface 4902A on cam 4902, and surface 4904A on cam 4904, which are configured to exert a pushing force for both installation and removal. The specific curvature of these surfaces will be described in relation to FIG. 51. In at least one embodiment, cam 4902 extends laterally beyond a first sidewall 4906A of main body 4906, and cam 4904 extends laterally beyond a second sidewall 4906B (FIG. 49B).

FIG. 49B illustrates a cross-sectional view 4900B of connector 4900, with lever 4606 shown in an up, or installed position, in accordance with at least one embodiment. This view illustrates the connection between axle housing 4710 within main body 4906. In at least one embodiment, axle housing 4710 is mounted within opening 4911, providing a secure housing through which axle 4704 passes. This assembly creates a robust pivot point for lever 4606 and cam 4904. The main body 4906 also features a plurality of ports, such as ports 4908, 4910, and 4912, for establishing fluid communication.

FIG. 49C illustrates a cross-sectional view 4900C of lever 4920 positioned within axle 4704. In at least one embodiment, lever 4920 is an example of a removal lever. In at least one such embodiment, lever 4920 comprises a protrusion 4922 that can be inserted within an opening 4924 in axle 4704. In at least one embodiment, lever 4920 can include a pair of protrusions for stability. In at least one alternate embodiment, axle 4704 comprises a protrusion, and lever 4920 includes a recess.

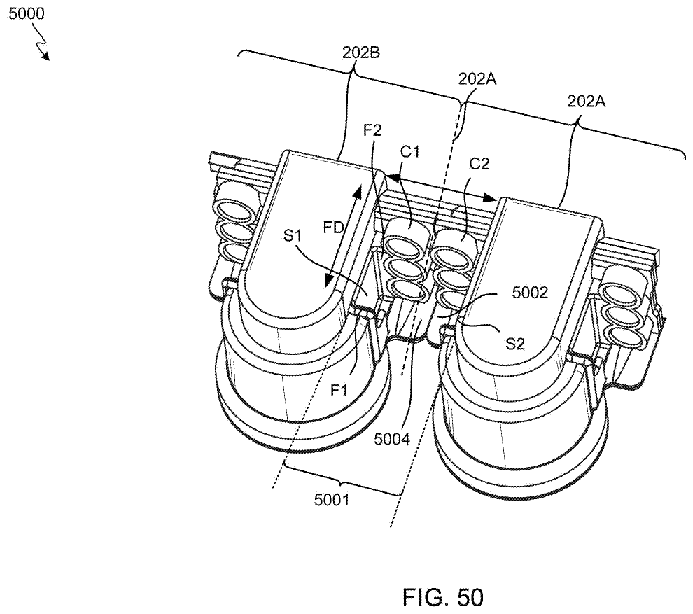

FIG. 50 is an enhanced isometric illustration of a structure 5000, which shows a portion of the filtration train first illustrated in FIG. 19A, in accordance with at least one embodiment.

In at least one embodiment, two adjacent manifolds, manifold 200A and manifold 202B, are shown connected at a region 5001. Each manifold 200A and 200B comprises a mounting frame, for example, frame 5004 adjacent to a holder of manifold 200A and frame 5002 adjacent to a holder of manifold 200B. In at least one embodiment, the space spanned by region 5001 is designed to receive and implement a connector, such as the connectors described above. The view also illustrates how port collection C2 of manifold 200A and port collection C1 of manifold 200B are brought into a side-by-side, facing relationship across region 5001. Side surfaces S1 and S2 of the respective filter holders are also visible.

In at least one embodiment, frames 5002 and 5004 each include a front surface F1 and a back surface, such as back surface F2. The distance between the front surface F1 and back surface F2 defines a frame depth. This frame depth is a useful parameter in the design of the actuation mechanism for a corresponding connector. In at least one embodiment, the frame depth is substantially equal to the spacing required between two actuation points on a cam that are responsible for engaging and disengaging the connector within the frame.

FIGS. 51, 52A, 53, and 54A illustrate a sequence of operation for the insertion of a connector within region 5001 between adjacent manifolds 200A and 200B in FIG. 50, and show an actuation mechanism in operation.

FIG. 51 provides a cross-sectional view of a structure 5100, illustrating the initial alignment phase of the installation sequence. In this pre-installation stage, a connector 5102 is positioned above region 5001 and precisely aligned with a frame 5004. In at least one embodiment, frame 5004 may be an example of a manifold mounting frame implemented to securely house a connector. In at least one embodiment, this alignment positions the front surfaces of ports on connector 5102, including ports 5104, 5106, and 5108, to interface with a corresponding housing surface 308A.

In at least one embodiment, connector 5102 comprises properties of connector 3900 (FIGS. 39A and 39B), such as ports, a lever, a cam, and a backplate. In at least one embodiment, connector 5102 includes a lever 4606, a cam 4902, and backplate 3901.

An outer profile of cam 4902 is defined by several distinct segments, with points A, B, C, and D representing key transition points between these segments. In at least one embodiment, cam segments AB and CD are planar or substantially planar, while segments BC and AD are substantially curved, and segment CD is a combination of planar and curved portions. In at least one embodiment, the curved portions are designed to result in a desired motion profile. In at least one embodiment, the curved portions are present to prevent the cam from being fixed in one position during rotation or to prevent uneven motion. In at least one embodiment, the planar or substantially planar segments can enable detent in static positions. In other embodiments, both segments AB and BC can be curved, but to different extents. Furthermore, transitions in the shape of cam 4902 near points C and D are substantially rounded or curved to facilitate smooth rotation during actuation.

In at least one embodiment, frame 5004 comprises a front surface F1 and a back surface F2, which are separated by a defined frame depth FD. In at least one embodiment, surface F1 and surface F2 are static relative to the connector. During operation, different segments of cam 4902 are configured to contact surfaces F1 and F2. In at least one embodiment, frame depth FD is an important design parameter, as it dictates operational clearance and corresponds to the spacing between the engagement surfaces on cam 4902. In at least one embodiment, dashed line 5110 can limit a vertical depth of insertion of connector 5102 and represents a bottom alignment feature of connector 5102. In at least one embodiment, surface 5112 of frame 5004 is static. During the initial installation, once dashed line 5110 is in contact with surface 5112 of frame 5004, the connector's downward motion is limited and can translate from F1 to F2 or move up. This precise geometric relationship enables different surfaces within cam 4902 to exert both pushing and pulling forces on frame 5004, providing the mechanical advantage needed to install or remove connector 5102.

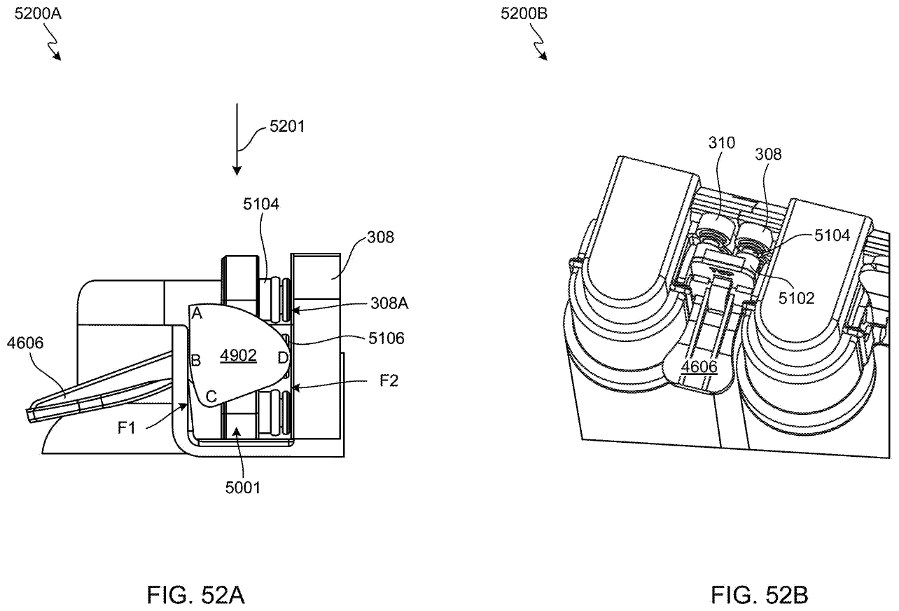

FIG. 52A is a cross-sectional view of a structure 5200A, which illustrates a subsequent phase in the installation sequence. Following an initial alignment, a connector 5102 is positioned into region 5001, as indicated by arrow 5201. In at least one embodiment, in this seated but unactuated position, front surfaces of ports on connector 5102, such as port 5104, remain aligned with a housing surface 308A of the manifold. In at least one embodiment, as connector 5102 slides into region 5001, a segment AB on cam 4902 contacts a front surface F1 of the mounting frame. At this stage, the ports 5104, 5106, etc. of connector 5102 are not yet inserted into housing 308.

FIG. 52B is an isometric illustration of a structure 5200B, which illustrates an isometric view of structure 5200A, in accordance with at least one embodiment. Referring collectively to FIGS. 52A and 52B, following an initial alignment, a connector 5102 is positioned into region 5001. In at least one embodiment, in this seated but unactuated position, front surfaces of ports on connector 5102, such as port 5104, remain aligned with housing 308 of the manifold. At this stage, the ports 5104, etc. of connector 5102 are not yet inserted into housing 308.

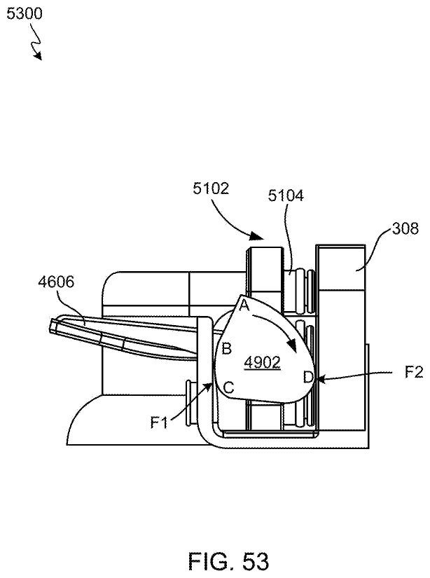

FIG. 53 is a cross-sectional view of a structure 5300, illustrating the partial actuation of the connector's biasing mechanism. In at least one embodiment, as lever 4606 is rotated, rotational torque is transmitted to cam 4902 via an attached axle 4704 (indicated by dashed lines), causing partial rotation of cam 4902 in a first direction of rotation (clockwise). As cam 4902 rotates, a first curved surface, corresponding to segment BC, engages with and pushes against surface F1 of the mounting frame, where surface F1 acts as a manifold installation surface. Simultaneously, this rotation brings point D on cam 4902 into contact with a back surface F2. In at least one embodiment, this interaction between the first curved surface (segment BC) of cam 4902 and the manifold installation surface (surface F1) generates a mechanical advantage, resulting in a force that biases connector 5102 horizontally. In at least one embodiment, because lever 4606 is attached to axle 4704, which in turn is attached to cam 4902 and to connector 5102, rotation of lever 4606 results in rotation of the axle 4704. In at least one embodiment, rotation of the axle 4704 results in rotation of cam 4902. In at least one embodiment, rotation of cam 4902 results in an increase of the horizontal distance between axle 4704 and the point of contact on the edge of cam, where the horizontal distance is a distance between surface F1 and axle 4704. The increase of this horizontal distance forces axle 4704 to displace to the right by the same amount. The displacement of the axle 4704 results in displacement of connector 5102. This linear force pushes ports 5104, 5106, and 5108 into their corresponding receptacles in housing 308, overcoming the initially opposing resisting force from the sealing elements.

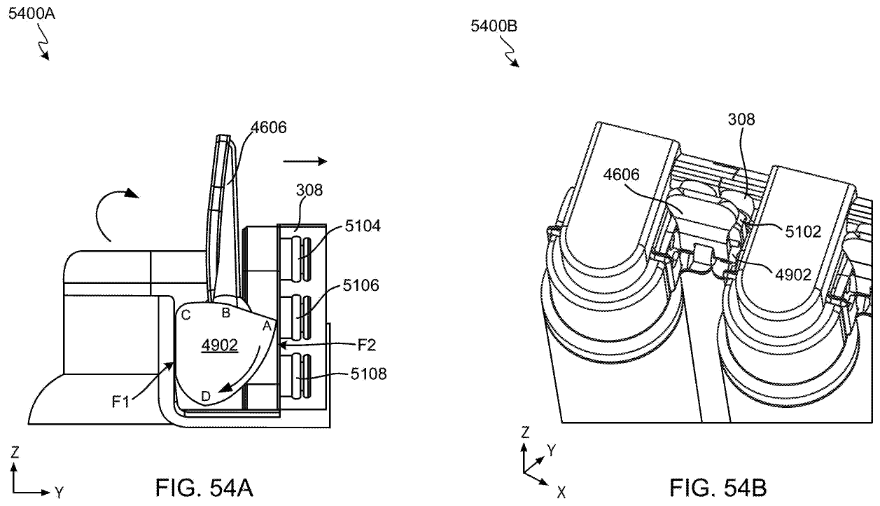

FIG. 54A is a cross-sectional view of a structure 5400A, which illustrates a fully engaged state of the installation sequence. Following the partial rotation described in FIG. 53, lever 4606 is rotated completely into a locked position (vertical alignment in the figure). In at least one embodiment, a full rotation of lever 4606 and its corresponding cam 4902 completes the activation of the biasing mechanism, fully installing connector 5102.

In at least one embodiment, in this fully rotated state, a portion of a segment CD on cam 4902 is now in firm contact with a front surface F1 of the mounting frame. In at least one embodiment, to provide for effective contact and a stable locked position, a portion of segment CD may be planar or substantially planar. The contact between CD and F1 prevents the connector from backing up due to internal pressure. Simultaneously, a point A on cam 4902 is now brought into contact with a back surface F2 of the mounting frame.

In at least one embodiment, the spacing between points on cam 4902, for example, the distance between points A and C, is specifically designed to permit this full rotation while ensuring that at least two points on cam 4902 are simultaneously in contact with surfaces F1 and F2. In at least one embodiment, this can create a mechanically locked position, which ensures that fluid pressure present within the system during operation does not dislodge cam 4902 or the connector. In at least one embodiment, simultaneous contact of cam 4902 with surfaces F1 and F2 may lead to jamming. In at least one embodiment, cam 4902 is designed to contact surface F1 during the installation and surface F2 during removal. In some embodiments, simultaneous contact of cam 4902 with surfaces F1 and F2 may be performed without jamming by adjusting the curvature of cam segments. Referring again to the mounting frames shown in FIG. 50, features such as flaps on the frames may provide an additional mechanism to physically secure cam 4902 within region 5001 when lever 4606 is in this locked position, preventing unintentional rotation.

In at least one embodiment, other features can be implemented into cam 4902 to provide robust locking features. In at least one embodiment, cam 4902 can include a hook-shaped protrusion 4714 configured as a flexible, cantilevered arm within segment AD. This cantilevered arm is designed to create a mechanical interference with the manifold's mounting frame during the final stage of actuation. To fully engage connector 5102, an additional torque may need to be applied to the lever 4606 to elastically deform or “bend” the cantilevered arm as it snaps into its final, locked position. Once locked, the stored potential energy in the bent cantilevered arm generates a continuous restoring force. This “spring-back” force acts as a constant bias, securely holding the connector in place and preventing it from loosening due to vibration or changes in fluid pressure.

In at least one embodiment, cam 4902 is a compound cam that also includes curved actuation surfaces, which are utilized to remove the connector, by reversing the operation described above. In at least one such embodiment, changing the direction of rotation (counter-clockwise) can bring into contact points along segment AD and surface F2. This rotation is configured to engage the segment AD, which effectively pushes surface F2 of the manifold to pull ports 5104, 5106, and 5108 out of the installed position. (negative X-axis direction in the Figure).

FIG. 54B is an isometric illustration of a structure 5400B, which illustrates an isometric view of structure 5400A, in accordance with at least one embodiment. Referring collectively to FIGS. 54A and 54B, in at least one embodiment, following the partial rotation described in FIG. 53, lever 4606 is rotated completely into a locked position (vertical alignment in the figure). In at least one embodiment, a full rotation of lever 4606 and its corresponding cam 4902 completes the activation of the biasing mechanism, fully installing connector 5102 by engaging port 5104, not visible, into housing 308.

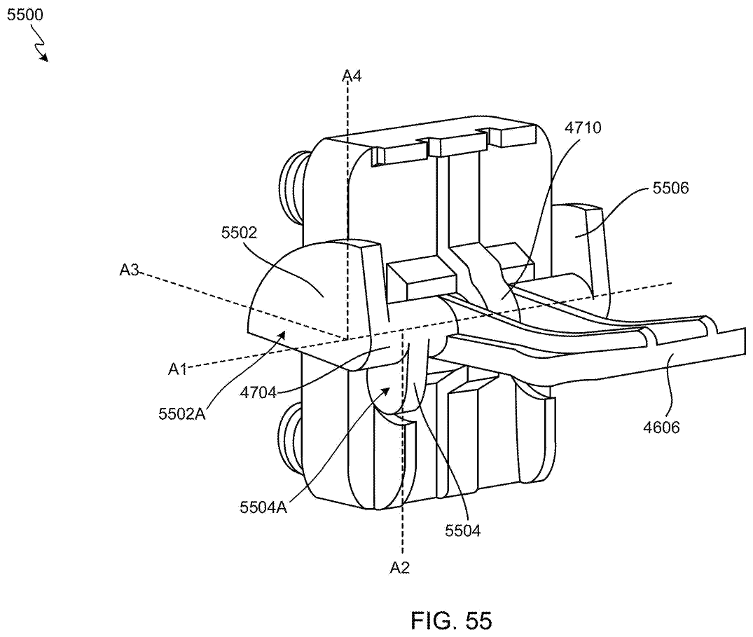

FIG. 55 illustrates an embodiment of a connector 5500, in accordance with at least one embodiment. In at least one embodiment, connector 5500 features a unique dual-cam actuation mechanism where the dual-cams have different geometric profiles. In at least one embodiment, connector 5500 comprises a main body, a lever 4606, and an axle 4704. The actuation mechanism includes a cam 5504 and a cam 5502, both attached to axle 4704. In at least one embodiment, cam 5506 is laterally between lever 4606 and cam 5502. In at least one embodiment, cam 5504 may be referred to as an installation cam, and cam 5502 may be referred to as a removal cam, defining their functionalities based on their specific geometry.

In at least one embodiment, the specific orientation and size of cams 5502 and 5504 are a function of spacing FD (FIG. 50). An axle 4704 defines a rotational axis extending along a first direction (A1). In at least one embodiment, cam 5504 comprises a structure extending from axle 4704 in a second direction (along axis A2), where the second direction is substantially orthogonal to the first direction. This cam 5504 is primarily configured for installation.

In at least one embodiment, cam 5502 comprises a structure, designed for removal. A main body portion of this structure extends from axle 4704 in a fourth direction (along axis A4), which is substantially opposite to the second direction. Furthermore, a portion of cam 5502 extends from its main body in a third direction (along axis A3), which is substantially orthogonal to both the first direction (the axle's axis) and the second direction. This complex, multi-directional geometry ensures that cam 5502 and cam 5504 perform distinct, non-interfering functions during actuation.

In at least one embodiment, a distinguishing feature of the dual-cam design is that removal cam 5502 and installation cam 5504 can be of unequal sizes and have different geometric profiles. In at least one embodiment, removal cam 5502 comprises a lateral surface 5502A, and installation cam 5504 comprises a corresponding lateral surface 5504A. In at least one embodiment, both lateral surface 5502A and lateral surface 5504A are oriented substantially orthogonal to the rotational axis (A1) of axle 4704. As shown in the illustrative embodiment, the surface area of lateral surface 5502A on removal cam 5502 is greater than the surface area of lateral surface 5504A on installation cam 5504, reflecting the different functional requirements of the two cams during actuation.

In at least one embodiment, for a symmetric and balanced application of force, this entire arrangement of cam 5504 and cam 5502 is duplicated on the opposite side of lever 4606. The different geometric profiles ensure that neither cam alone is capable of both engaging and disengaging the connector; cam 5504 and cam 5502 are designed to work in concert through the rotation of lever 4606.

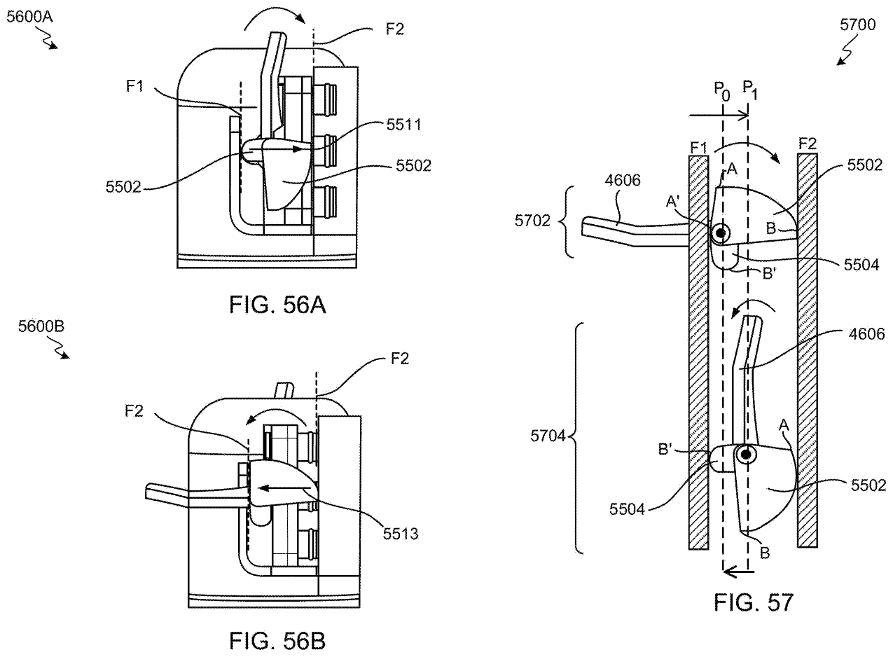

FIG. 56A illustrates a structure 5600A showing an installation sequence, in accordance with at least one embodiment. In at least one embodiment, installation cam 5504 is configured to exert a first force to bias connector 5500 toward a manifold surface F2 (as directed by arrow 5511). During installation, rotation of the lever causes an installation surface on cam 5504 to push against a first manifold surface F1, resulting in a force that pushes the connector into an engaged position. In this state, cam 5504 may be in contact with surface F1, while cam 5502 may not yet be in contact with surface F2 (until the lever reaches a vertical position).

FIG. 56B illustrates a structure 5600B showing a removal sequence, in accordance with at least one embodiment. In at least one embodiment, during a counter-clockwise rotation, cam 5502 is configured to exert a force to bias connector 5500 away from manifold surface F2. During removal, rotation of the lever in the opposite direction causes a removal surface on cam 5502 to push against manifold surface F2, resulting in a force that pushes the connector out of the engaged position towards surface F1 (as directed by arrow 5513). These actions are collectively illustrated in FIG. 57, which highlights movement of the axle (from which motion of ports on the connector can be inferred), in accordance with at least one embodiment.

FIG. 57 illustrates a schematic 5700 showing two configurations of the actuation mechanism, in accordance with at least one embodiment. The manifold and connectors are not illustrated for clarity. In a first configuration, herein referred to as configuration 5702, with lever 4606 in a down position, the connector is in a preinstalled position. In this position, cam 5504 is in contact with surface F1 along a segment A′B′. A clockwise rotation of lever 4606 causes point B′ to move toward surface F1, generating a resulting force that translates the axle and the entire connector assembly linearly to the right (in the Figure). Meanwhile, point B on cam 5502 is not in contact with surface F2. In at least one embodiment, linear translation of the axle, combined with the continued clockwise rotation of lever 4606, brings point A on cam 5502 into contact with surface F2. During this rotation, the axle moves from a plane P0 to plane P₁.

In a second configuration, herein referred to as configuration 5704, lever 4606 is in a vertical, or locked, position. In at least one embodiment, the connector's ports are fully inserted into a housing, as denoted by the position of the axle at plane P1. To reverse the operation, a counter-clockwise rotation from configuration 5704 causes point B on cam 5502, which has a greater radial distance from the axle than point A, to gradually come into contact with and engage surface F2. This pushes the axle assembly to the left back towards plane P₀, disengaging the ports. In at least one embodiment, during installation, cam 5504 is primarily responsible for moving the ports into the housing, while during removal, cam 5502 is responsible for pushing the ports out of the housing.

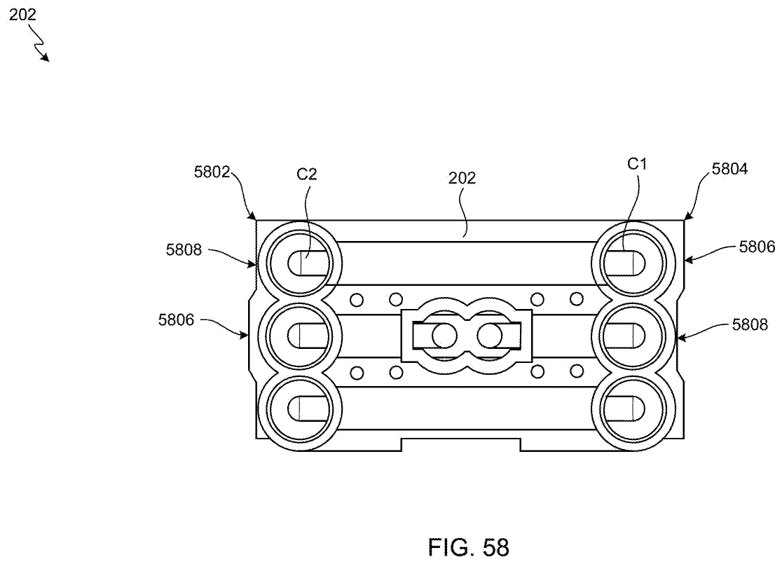

FIG. 58 illustrates a front view of an embodiment of a backplate 202, in accordance with at least one embodiment. In addition to the features of backplate 202 described in FIG. 3, further features of backplate 202 include a side edge 5802 adjacent to port collection C2 and an opposite side edge 5804 adjacent to port collection C1. In the illustrative embodiment, both side edges 5802 and 5804 feature a complementary patterned interface designed for interlocking. In at least one such embodiment, side edge 5802 comprises a central extended section, or protrusion 5806, positioned between two recessed sections, or indentations 5808. In at least one embodiment, side edge 5804 features a complementary pattern to side edge 5802, comprising an indentation 5808 positioned between two protrusions 5806. This complementary arrangement is configured such that when two identical backplates 202 are placed side-by-side, protrusion 5806 of one backplate interlocks with the indentations 5808 of the adjacent backplate. This creates a secure, physically aligned connection within a filtration train to be formed. While the embodiment shows a symmetrical pattern, the number, size, lengths along the edge, and arrangement of protrusions 5806 and indentations 5808 can be varied, provided that the pattern on side edge 5802 remains complementary to the pattern on side edge 5804 to facilitate this interlocking function. In at least one embodiment, indentations 5808 and protrusions 5806 extend across a full thickness of backplate 202, creating a robust, structurally integral keying pattern, as shown in FIG. 3.

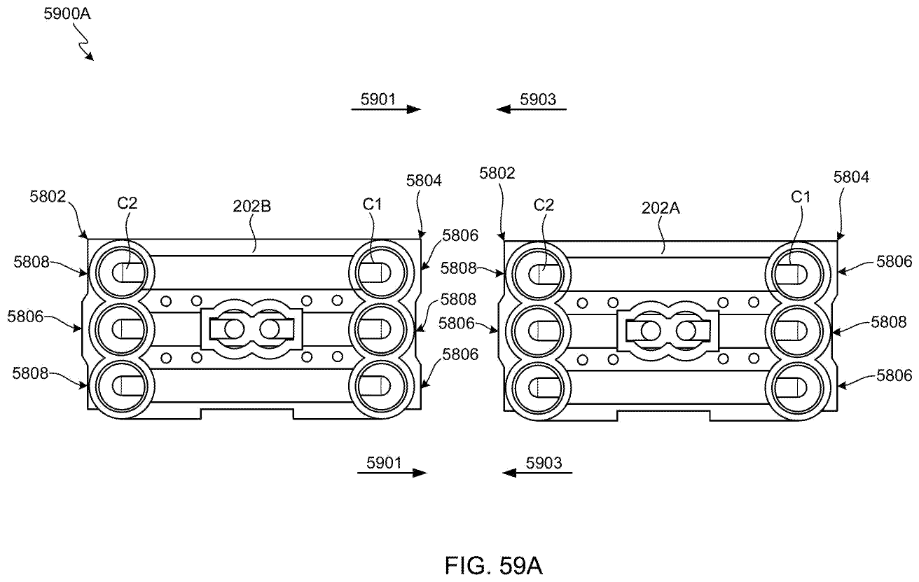

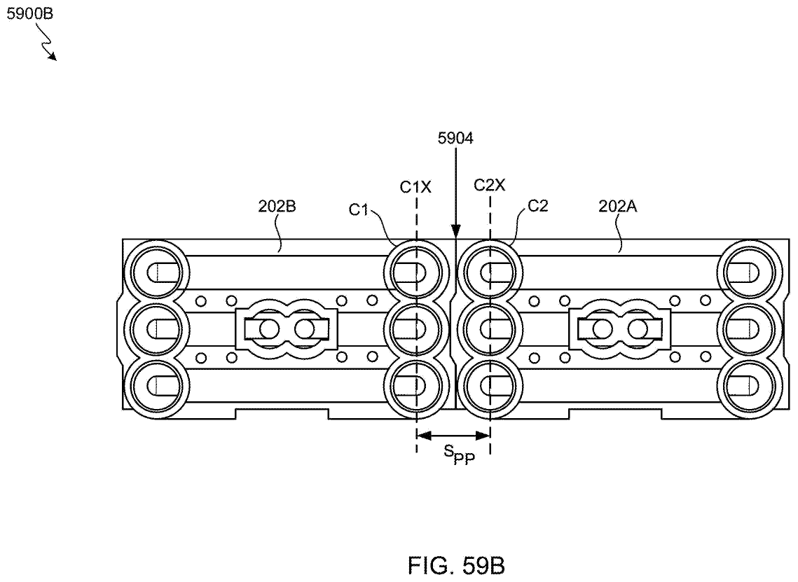

FIG. 59A provides a front view 5900A illustrating an assembly of two adjacent and identical backplates 202A and 202B. This view depicts the initial alignment stage before backplates 202A and 202B are brought into contact. Specifically, side edge 5802 of backplate 202A is shown being aligned with a complementary side edge 5804 of backplate 202B. Side edges 5802 and 5804 feature a patterned interface comprising a series of protrusions 5806 and indentations 5808. The design ensures that a pattern on side edge 5802 is the mirror-image or complement of a pattern on side edge 5804.

During assembly, this complementary geometry facilitates a precise and guided interlocking of the two backplates. As shown, protrusion 5806 on the edge of one backplate aligns perfectly with the corresponding indentation 5808 on the edge of the adjacent backplate. This physical engagement serves multiple functions: it ensures correct side-by-side orientation, prevents lateral misalignment between the units, and provides a mechanically stable connection even before an inter-backplate connector is installed. This interlocking feature simplifies the assembly process for an end-user, providing clear tactile and visual feedback that the backplates are correctly positioned relative to one another, which is a useful prerequisite for the subsequent insertion of a fluid connector. In at least one embodiment, the next phase after alignment is indicated by arrows 5901 and 5903, representing a process to bring backplate 202A and 202B into contact.

In at least one embodiment, side edge 5802 and side edge 5804 in backplate 202A, or side edge 5802 and side edge 5804 in backplate 202B may not be complimentary. In at least one such embodiment, when backplate 202A and backplate 202B are placed side by side, as shown in FIG. 59A, side edge 5802 from backplate 202A and side edge 5804 from backplate 202B are complimentary.

In at least one embodiment, side edge 5802 from backplate 202B and side edge 5804 from backplate 202A may not have a patterned edge. In at least one such embodiment, when backplate 202A and backplate 202B are placed side by side, as shown in FIG. 59A, side edge 5802 from backplate 202A and side edge 5804 from backplate 202B are complimentary.

In at least one embodiment, side edge 5802 from backplate 202B and side edge 5804 from backplate 202A are not complimentary. In at least one such embodiment, when backplate 202A and backplate 202B are placed side by side, as shown in FIG. 59A, side edge 5802 from backplate 202A and side edge 5804 from backplate 202B are complimentary.

In at least one embodiment, side edge 5802 from backplate 202B or side edge 5804 from 202A may not have a patterned edge. In at least one such embodiment, when backplate 202A and backplate 202B are placed side by side, as shown in FIG. 59A, side edge 5802 from backplate 202A and side edge 5804 from backplate 202B are complimentary.

FIG. 59B is a front view 5900B illustrating two backplates 202A and 202B after they have been brought into full contact and are interlocked. In this assembled state, port collection C2 of backplate 202A is positioned in a direct, side-by-side relationship with port collection C1 of adjacent backplate 202B. A minimal interface gap 5904 may exist between the two backplates as a function of standard manufacturing tolerances. This precise physical alignment, enforced by the interlocking keyed edges, establishes a defined and consistent port-to-port spacing, or separation designated as SPP, between a central axis C2X of ports in port collection C2 and a central axis C1X of ports in port collection C1. This predetermined spacing is a design parameter, as it creates a standardized interface gap that is specifically dimensioned to receive an inter-backplate connector, ensuring that the connector can reliably bridge the two backplates and form secure, leak-proof fluidic seals with the respective ports.

FIG. 60 provides an isometric view of a structure 6000 illustrating an interface 6001 between two different types of backplates, such as backplates 900 and 1200 within a modular filtration train, in accordance with at least one embodiment. In at least one embodiment, structure 6000 is an enhanced isometric view of a portion of filtration train 2000 in FIG. 20A. This view demonstrates the system's ability to integrate heterogeneous components. A manifold 1400 comprising a backplate 1200, which may be a specialized Reverse Osmosis (RO) manifold, is shown adjacent to manifold 1100 comprising a backplate 900, which may be a standard non-RO manifold. A key distinction is the number of ports in their respective interfacing collections; manifold 1400 features a three-port collection C1, while manifold 1100 features a two-port collection C2. Despite this difference, complementary keyed patterns on their lateral side edges ensure that the manifolds align correctly when brought into contact at interface 6001.

In at least one embodiment, an additional layer of mechanical keying may be implemented to ensure functional compatibility between these dissimilar manifold types. While the lateral edges may be complementary for basic physical alignment, the region immediately surrounding the port housings is uniquely configured. In at least one embodiment, as indicated by a dashed box 6003, the front surface of backplate 900 includes one or more protrusions or recess located in the immediate vicinity of its port housing 720. In at least one embodiment, backplate 900 includes a protrusion or a recess 6004 within housing 720. In at least one embodiment, the protrusions extend forward from the main surface of the backplate and act as a physical block, creating a unique geometric profile at the interface. In at least one embodiment, the recess extends into housing 720, creating a unique geometric profile at the interface. This design serves as an error-proofing mechanism, ensuring that only a specifically designed connector with corresponding recesses can be used to bridge this particular interface between manifold 1400 and manifold 1100, thereby preventing the accidental connection of incompatible components.

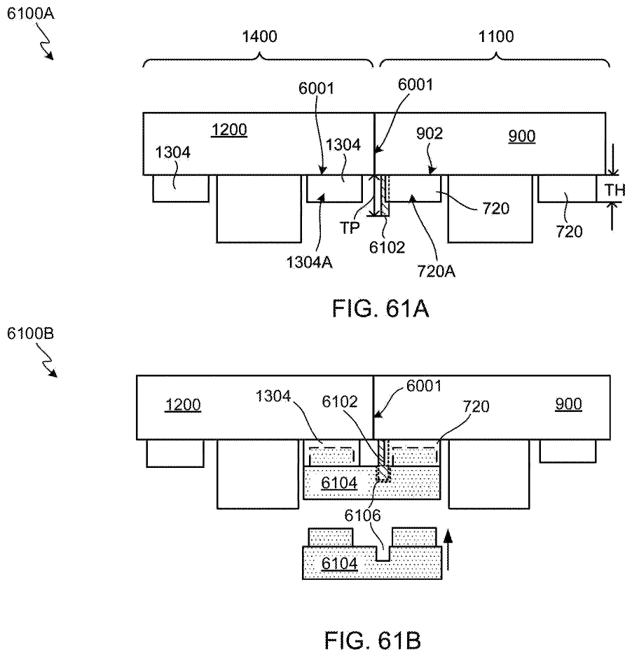

FIG. 61A presents a top-down plan view of a structure 6100A that further clarifies the mechanical keying feature at interface 6001 shown in FIG. 60. This view details the geometric relationship between housing 1304 of manifold 1400 and housing 720 of manifold 1100. The front surfaces 1304A and 720A of the respective housings extend from the main front surface of their respective backplates, 1200 and 900, by a nominal housing thickness, TH. In at least one embodiment, backplate 900 includes a dedicated keying protrusion, such as protrusion 6102, that extends forward from a front section 902. This protrusion 6102 has a thickness TP, which is significantly greater than housing thickness TH (TP>TH), causing it to extend further out than the standard mating surface 720A of housing 720. This extended protrusion acts as a robust physical lock, designed to interfere with and block any standard or incompatible connector that lacks a feature to accommodate it.

FIG. 61B provides a top-down plan view 6100B which illustrates a successful engagement of a specialized connector 6104 at this keyed interface. Connector 6104 is specifically designed to bridge the ports within housing 1304 of manifold 1400 and housing 720 of manifold 1100. To overcome the physical block presented by protrusion 6102, the body of connector 6104 features a precisely engineered recess, or recess 6106 (as shown, in the plan view cross section, or cross section through recess 6106, in the inset). As connector 6104 is inserted into housing 720 and housing 1304 as indicated by arrow 6107, protrusion 6102 is received within recess 6106.

In the plan view illustration, protrusion 6102 extends partially under housing 720. In at least one embodiment, the placement of protrusion 6102 may be based on available space for indentation in connector 6104 based on the design of internal components. In at least one embodiment, recess 6106 is dimensioned and spatially positioned to accommodate keying protrusion 6102 on manifold 1100, allowing connector 6104 to fully seat against housing 720 and 1304 and establish a secure fluidic connection when inserted. This lock-and-key design creates an advanced level of error-proofing. A generic connector lacking a recess, such as recess 6106 would be physically obstructed by protrusion 6102, preventing installation and ensuring that only the correct, specialized connector, or connector 6104, can be used to link these two specific manifold types. This guarantees that the intended fluid logic is maintained across a heterogeneous filtration train, such as filtration train 2000 (FIG. 20A).

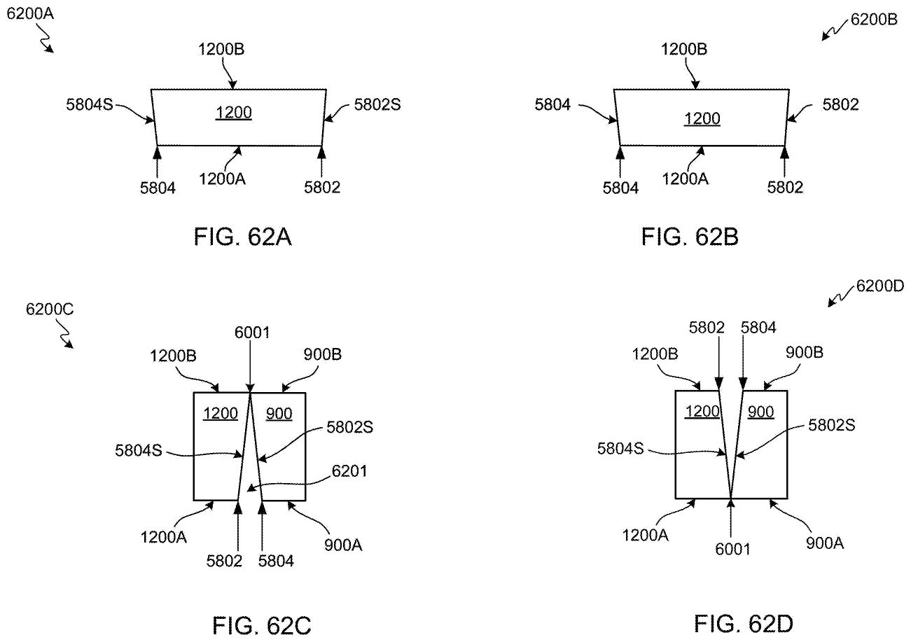

FIG. 62A provides a top-down plan view depicting an embodiment 6200A of a manifold backplate 1200. In accordance with at least one embodiment, the width of backplate 1200 measured at a front surface 1200A is different from the width of backplate 1200 measured at a rear surface 1200B. In at least one such embodiment, sidewall surface 5804S corresponding to edge 5804 and sidewall surface 5802S corresponding to edge 5802 may not be parallel. In the illustrative embodiment, the plan view geometric profile of backplate 1200 is characterized by a width of backplate 1200 being less at a front surface 1200A than at a rear surface 1200B. In at least one embodiment, surface 5802S and surface 5804S are angled relative to a normal to a front surface 1200A. In at least one embodiment, surfaces 5802S and 5804S are angled by less than two degrees.

FIG. 62B provides a top-down plan view depicting an alternative embodiment 6200B of a manifold backplate 1200. In the illustrative embodiment, the plan view geometric profile of backplate 1200 is characterized by a width of backplate 1200 being greater at a front surface 1200A than at a rear surface 1200B. In at least one embodiment, surface 5802S and surface 5804S are angled relative to a normal to front surface 1200A. In at least one embodiment, surfaces 5802S and 5804S are angled relative to a normal to front surface 1200A by less than two degrees. While FIGS. 62A and 62B describe features of backplate 1200, backplate 900 also comprises features of backplate 1200 described herein.

FIGS. 62C and 62D illustrate profiles of interfaces, when edge surfaces that are oppositely angled in two manifolds are brought into contact with each other.

FIG. 62C provides an enhanced plan view 6200C of a portion of structure 6100A in FIG. 61A, illustrating a specific type of mechanical keying at an interface 6001 between two adjacent manifold backplates, such as backplate 1200 and backplate 900. In this embodiment, the respective lateral side surfaces 5802S and 5804S of backplate 900 and backplate 1200 are not orthogonal to their respective front surfaces 900A and 1200A, or parallel to each other. Instead, the side edges are angled, creating an interface 6001 comprising a gap 6201 with a non-uniform width that varies with depth. Specifically, gap 6201 is widest at the front surfaces 900A and 1200A of the respective backplates 900 and 1200 and progressively narrows with the depth of backplates 900 and 1200, visually disappearing near a back surface 900B and a back surface 1200B. This configuration results in an inverted V-shaped or wedge-shaped gap 6201 that tapers from the front of the assembly to the back. This specific wedge-shaped geometry of interface 6001 is useful during installation or removal. In at least one embodiment, the edges of backplates 900 and 1200 may be physically in contact, but they do not need to be for the connector to be functional. The placement of ports on connectors relative to ports within housings of backplates may have tolerances to accommodate the separation distance between edges of backplates.

FIG. 62D provides an enhanced plan view 6200D of a portion of structure 6100A in FIG. 61A, illustrating a specific type of mechanical keying at an interface 6001 between two adjacent manifold backplates, such as a backplate 1200 and a backplate 900. In this embodiment, the lateral side surfaces 5802S and 5804S of backplate 900 and backplate 1200 are oriented in the opposite manner to that shown in FIG. 62A. In at least one such embodiment, gap 6201 at interface 6001 is narrowest between backplates 900 and 1200 at respective front surfaces 900A and 1200A. In at least one such embodiment, gap 6201 progressively increases in width with depth of backplate 900 and backplate 1200, becoming widest near a back surface 900B and a back surface 1200B, respectively. This configuration results in a V-shaped or wedge-shaped gap 6201 that extends from the front to the back of assembled backplates 900 and 1200.

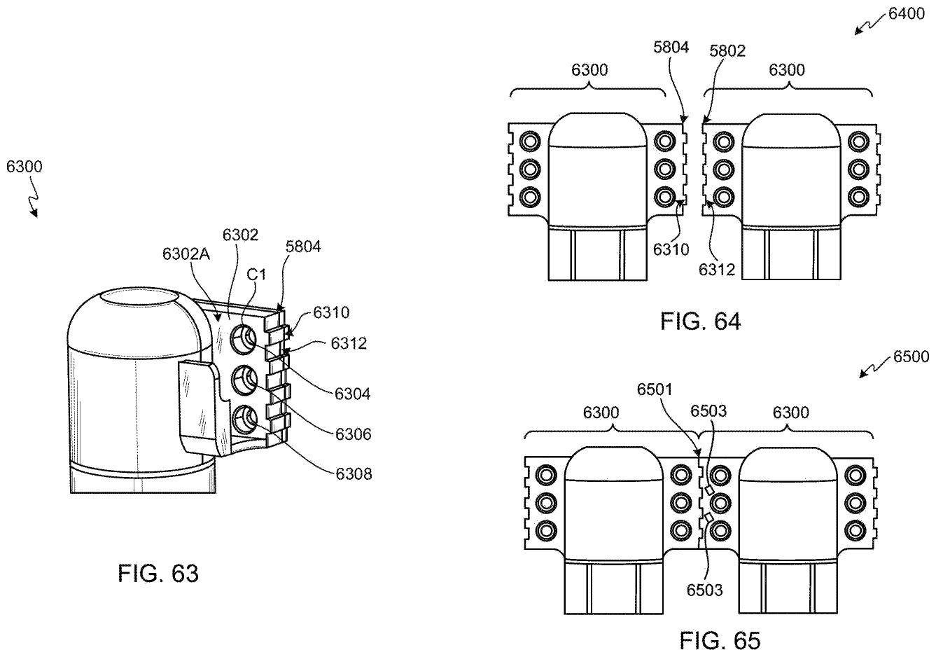

FIG. 63 provides an isometric view of a manifold 6300, which represents an alternative embodiment of a water filtration manifold. In accordance with at least one embodiment, manifold 6300 includes features similar to manifold 200 (FIG. 2), such as a backplate 6302 and a collection of ports C1. However, this embodiment features a distinct design where ports 6304, 6306, and 6308 are recessed directly into a front surface 6302A of backplate 6302. Unlike previous embodiments, this configuration omits a protruding port housing, resulting in a planar or substantially planar front surface 6302A. This flush-mount port design offers a more compact profile and is advantageous for creating a different type of keyed interface that relies on features integrated directly into the backplate itself.

A key feature of manifold 6300 is a side edge 5804 that is patterned, which is configured for interlocking with an adjacent, complementary manifold. This patterned interface comprises a series of alternating protrusions 6310 and recessed sections, or indentations 6312. In at least one embodiment, protrusions 6310 and indentations 6312 have a different design compared to protrusions 5806 and indentations 5808 (FIG. 58). In at least one embodiment, protrusions 6310 and indentations 6312 have a sharp transition (90-degree turns) between them, compared to transitions that are angled between protrusions 5806 and indentations 5808. In the illustrative embodiment, these geometric features extend across the full thickness of backplate 6302, creating a robust, structurally integral keying pattern. This design ensures a strong and precise mechanical interlock when two such manifolds are placed side-by-side, providing stability and maintaining alignment within a filtration train assembly.

FIG. 64 illustrates a structure 6400 showing two identical or substantially identical manifolds 6300 being aligned for assembly. This view depicts the interaction between a complementary side edge 5802 of one manifold and a side edge 5804 of an adjacent manifold. The pattern of protrusions 6310 and indentations 6312 on side edges 5802 and 5804 are designed to be complementary. As two manifolds 6300 are brought into physical contact, this complementary geometry guides them into a precise, interlocked position. This feature simplifies user assembly by ensuring proper orientation and preventing lateral shifting between the units, establishing the correct spatial relationship required for a subsequent connector installation.

FIG. 65 illustrates a structure 6500 showing two manifolds 6300 in their fully assembled and interlocked state. At an interface 6501, the complementary keyed edges form a tight, continuous seam with virtually no visible gap, demonstrating the high precision of the interlocking design. In addition to lateral edge keying, this embodiment introduces another layer of mechanical error-proofing. As shown, one or more keying protrusions 6503 extend forward from a front surface of a backplate. These protrusions are positioned within interface 6501 and serve as a physical block, ensuring that only a specialized connector with corresponding recesses can be used to bridge the two manifolds. This prevents the use of an incompatible connector, thereby guaranteeing the correct fluidic configuration and enhancing the safety and reliability of the modular system.

We claim:

1. A fluid manifold to maintain a plurality of configurations, wherein the fluid manifold comprises:
a backplate and a holder;
a plurality of first ports;
a plurality of second ports, wherein the plurality of first ports are in fluid communication with the plurality of second ports; and
a plurality of holder ports, wherein the plurality of holder ports are in fluid communication with the plurality of first ports and the plurality of second ports, wherein the plurality of first ports are aligned in a first direction, wherein the plurality of second ports are aligned in a second direction, and wherein the first direction is substantially the same as the second direction.

2. The fluid manifold of claim 1, further comprising a first housing protruding from the backplate and enclosing the plurality of first ports, and a second housing protruding from the backplate and enclosing the plurality of second ports.

3. The fluid manifold of claim 2, wherein the first housing has a first frontal surface and the second housing has a second frontal surface.

4. The fluid manifold of claim 3, wherein the first frontal surface and the second frontal surface are co-planar.

5. The fluid manifold of claim 2, wherein the backplate defines a backplate plane comprising a normal vector, and wherein the first direction and the second direction are parallel to the normal vector.

6. The fluid manifold of claim 2, wherein the first housing and the second housing are positioned on opposite sides of the holder.

7. The fluid manifold of claim 1, further comprising a first housing protruding from the backplate and enclosing the plurality of first ports, and a second housing protruding from the backplate and enclosing the plurality of second ports.

8. The fluid manifold of claim 7, wherein the first housing has a first frontal surface defining a first plane, and the second housing has a second frontal surface defining a second plane.

9. The fluid manifold of claim 8, wherein the first plane and the second plane are distinct and substantially parallel to each other.

10. The fluid manifold of claim 8, wherein the first housing protrudes from the backplate by a first distance and the second housing protrudes from the backplate by a second distance, the first distance being different from the second distance.

11. The fluid manifold of claim 7, wherein the backplate defines a backplate plane having a normal vector, and wherein the first direction and the second direction are substantially parallel to the normal vector.

12. The fluid manifold of claim 8, wherein the backplate comprises a third plane, and wherein the first plane and the second plane are distinct and substantially parallel to each other, but at an angle relative to the third plane.

13. The fluid manifold of claim 1, wherein the plurality of first ports are enclosed within a first housing that is segmented into a plurality of housing portions.

14. The fluid manifold of claim 13, wherein individual ones of the plurality of housing portions comprises a unique protrusion depth relative to the backplate.

15. The fluid manifold of claim 13, wherein the plurality of housing portions comprises a first portion having a first protrusion depth, a second portion having a second protrusion depth, and a third portion having a third protrusion depth, wherein the first portion is above the second portion and the second portion is above the third portion.

16. A fluid manifold to maintain a plurality of configurations, the fluid manifold comprising:
a backplate;
a holder coupled to the backplate, the holder comprising a first holder port and a second holder port, the second holder port fluidically discontinuous from the first holder port;
a first housing protruding from the backplate and enclosing a plurality of first ports aligned in a first direction;
a second housing protruding from the backplate and enclosing a plurality of second ports aligned in a second direction, wherein the first direction is substantially parallel to the second direction; and
at least one integrated bypass line within the backplate establishing fluid communication between at least one of the plurality of first ports and at least one of the plurality of second ports.

17. The fluid manifold of claim 16, wherein the backplate defines a backplate plane having a normal vector, wherein the first direction and the second direction are non-parallel to the normal vector.

18. A fluid manifold to maintain a plurality of configurations, the fluid manifold comprising:
a backplate;
a holder coupled to the backplate, the holder comprising a first holder port and a second holder port, the second holder port fluidically discontinuous from the first holder port;
a first housing protruding from the backplate by a first distance and enclosing a plurality of first ports, wherein at least one of the plurality of first ports is in fluid communication with the first holder port; and
a second housing protruding from the backplate by a second distance and enclosing a plurality of second ports, wherein at least one of the plurality of second ports is in fluid communication with the second holder port.

19. The fluid manifold of claim 18, wherein the first housing and the second housing comprise a plurality of housing portions wherein the plurality of housing portions comprises: a first portion having a first protrusion depth a second portion having a second protrusion depth; and a third portion having a third protrusion depth, wherein the first portion is above the second portion and the second portion is above the third portion, wherein the first protrusion depth, the second protrusion depth, and the third protrusion depth are different from one another.

20. The fluid manifold of claim 19, wherein a first frontal surface of the first portion and the third portion are co-planar and define a first plane, and wherein a second frontal surface of the second portion defines a second, distinct plane parallel to the first plane.
